(19) United States
(12) Patent Application Publication
(10) Pub. No.: US 2023/0363043 A1
(43) Pub. Date: Nov. 9, 2023

(54) METHOD AND APPARATUS FOR HANDLING DRX CONFIGURATION FOR EXTENDED REALITY IN A WIRELESS COMMUNICATION SYSTEM

(71) Applicant: ASUS Technology Licensing Inc., Taipei City (TW)

(72) Inventors: Yi-Hsuan Huang, Taipei City (TW); Meng-Hui Ou, Taipei City (TW); Yu-Hsuan Guo, Taipei City (TW)

(21) Appl. No.: 18/141,126

(22) Filed: Apr. 28, 2023

Related U.S. Application Data
(60) Provisional application No. 63/339,274, filed on May 6, 2022.
(60) Provisional application No. 63/339,310, filed on May 6, 2022.
(60) Provisional application No. 63/339,339, filed on May 6, 2022.
(60) Provisional application No. 63/339,354, filed on May 6, 2022.

(51) Int. Cl. H04W 76/28; H04W 72/23

(52) U.S. Cl. CPC H04W 76/28; H04W 72/23

(57) ABSTRACT

Methods, systems, and apparatuses are provided for a UE in a wireless communication system comprising receiving a first signaling to configure at least one value of a Discontinuous Reception (DRX) parameter, receiving, in a serving cell, a second signaling indicating a first value of the DRX parameter or a second value of the at least one value of the DRX parameter, and performing at least one of the following: adjusting the DRX parameter for a first DRX group or a second DRX group of the UE based on a target DRX group indicated in the second signaling or based on whether the serving cell is assigned to the first DRX group or the second DRX group, restarting a drx-onDurationTimer, in response to receiving the second signaling, at a timing calculated based on the first value or the second value of the DRX parameter indicated in the second signaling, stopping the drx-onDurationTimer in response to receiving the second signaling and starting the drx-onDurationTimer at the timing, or stopping the drx-onDurationTimer upon or after transmitting a confirmation in response to reception of the second signaling and starting the drx-onDurationTimer at the timing.

### CROSS-REFERENCE TO RELATED APPLICATIONS

The present application claims priority to and the benefit of U.S. Provisional Patent Application Ser. No. 63/339,274, filed May 6, 2022, U.S. Provisional Patent Application Ser. No. 63/339,310, filed May 6, 2022, U.S. Provisional Patent Application Ser. No. 63/339,339, filed May 6, 2022, and U.S. Provisional Patent Application Ser. No. 63/339,354, filed May 6, 2022; with each of the referenced applications and disclosures fully incorporated herein by reference.

### FIELD

This disclosure generally relates to wireless communication networks and, more particularly, to a method and apparatus for handling DRX configuration for extended reality in a wireless communication system.

### BACKGROUND

With the rapid rise in demand for communication of large amounts of data to and from mobile communication devices, traditional mobile voice communication networks are evolving into networks that communicate with Internet Protocol (IP) data packets. Such IP data packet communication can provide users of mobile communication devices with voice over IP, multimedia, multicast and on-demand communication services.

An exemplary network structure is an Evolved Universal Terrestrial Radio Access Network (E-UTRAN). The E-UTRAN system can provide high data throughput in order to realize the above-noted voice over IP and multimedia services. A new radio technology for the next generation (e.g., 5G) is currently being discussed by the 3GPP standards organization. Accordingly, changes to the current body of 3GPP standard are currently being submitted and considered to evolve and finalize the 3GPP standard.

### SUMMARY

Methods, systems, and apparatuses are provided for handling Discontinuous Reception (DRX) configuration for Extended Reality (XR) in a wireless communication system, wherein a User Equipment (UE) could reduce Physical Downlink Control Channel (PDCCH) monitoring for XR Downlink (DL) traffic in Radio Resource Control (RRC) connected mode, the UE could be configured with various DRX configurations to satisfy the XR service, the UE could be indicated to use appropriate DRX configuration from various DRX configurations to satisfy the XR service, and/or the UE could report or transmit Sounding Reference Signal (SRS) and/or Channel State Information (CSI) appropriately when applying dynamic DRX configuration for XR service.

In various embodiments, a method for a UE in a wireless communication system comprises receiving a first signaling to configure at least one value of a DRX parameter, receiving, in a serving cell, a second signaling indicating a first value of the DRX parameter or a second value of the at least one value of the DRX parameter, and performing at least one of the following: adjusting the DRX parameter for a first DRX group or a second DRX group of the UE based on a target DRX group indicated in the second signaling or based on whether the serving cell is assigned to the first DRX group or the second DRX group, restarting a drx-onDurationTimer, in response to receiving the second signaling, at a timing calculated based on the first value or the second value of the DRX parameter indicated in the second signaling, stopping the drx-onDurationTimer in response to receiving the second signaling and starting the drx-onDurationTimer at the timing, or stopping the drx-onDurationTimer upon or after transmitting a confirmation in response to reception of the second signaling and starting the drx-onDurationTimer at the timing.

### BRIEF DESCRIPTION OF THE DRAWINGS

FIG. 1 shows a diagram of a wireless communication system, in accordance with embodiments of the present invention.

FIG. 2 is a block diagram of a transmitter system (also known as access network) and a receiver system (also known as user equipment or UE), in accordance with embodiments of the present invention.

FIG. 3 is a functional block diagram of a communication system, in accordance with embodiments of the present invention.

FIG. 4 is a functional block diagram of the program code of FIG. 3, in accordance with embodiments of the present invention.

FIG. 5 is a reproduction of FIG. 5.1.1-1: Single stream DL traffic model, from 3GPP TR 38.838 V17.0.0, “Study on XR (Extended Reality) Evaluations for NR.

FIG. 6 is an example diagram for DRX operation of on duration time, in accordance with embodiments of the present invention.

FIG. 7 is an example diagram showing that on duration time may shift due to modifications of the start offset to on duration (e.g., drx-SlotOffset), in accordance with embodiments of the present invention.

FIG. 8 is an example diagram showing that on duration time may shift due to modifications of the start offset to on duration (e.g., drx-SlotOffset), in accordance with embodiments of the present invention.

FIG. 9 is an example diagram showing that on duration time may shift due to modification of the length of on duration (e.g., drx-onDurationTimer), in accordance with embodiments of the present invention.

FIG. 10 is an example diagram showing that on duration time may shift due to modification of the length of on duration (e.g., drx-onDurationTimer), in accordance with embodiments of the present invention.

FIG. 11 is an example diagram showing that on duration time may shift due to modification of the length of DRX cycle (e.g., drx-ShortCycle, drx-LongCycle), in accordance with embodiments of the present invention.

FIG. 12 is an example diagram showing that on duration time may shift due to modification of the length of DRX cycle (e.g., drx-ShortCycle, drx-LongCycle), in accordance with embodiments of the present invention.

FIG. 13 is a flow diagram of a UE receiving a RRC message comprising a DRX configuration, receiving a first indication and/or a second indication, and adjusting the DRX configuration based on the first indication and/or the second indication, in accordance with embodiments of the present invention.

FIG. 14 is a flow diagram of a UE receiving a first signaling configuring at least one value of a DRX parameter for a first DRX group, receiving, in a serving cell, a second signaling indicating a first value of the DRX parameter or a second value, and adjusting the DRX parameter for the first DRX group or the second DRX group, in accordance with embodiments of the present invention.

FIG. 15 is a flow diagram of a UE receiving a first signaling configuring at least one value of a DRX parameter for a first DRX group, in accordance with embodiments of the present invention.

FIG. 16 is an example diagram showing that a UE may start drx-onDurationTimer at a timing indicated by the L1/L2 indication, in accordance with embodiments of the present invention.

FIG. 17 is an example diagram showing that a UE may receive a L1/L2 indication to adjust a DRX parameter (e.g., drx-StartOffset, drx-SlotOffset), in accordance with embodiments of the present invention.

FIG. 18 is a flow diagram of a UE receiving a RRC message comprising multiple DRX configurations, receiving an indication of one or more DRX configurations, and using the one or more DRX configurations to perform PDCCH monitoring, in accordance with embodiments of the present invention.

FIG. 19 is an example diagram showing that a UE may not transmit SRS and/or CSI when the indication is received before the specific timing (e.g., the time interval from the UE receives the indication to the symbol n is longer than the time duration), in accordance with embodiments of the present invention.

FIG. 20 is an example diagram showing that a UE may transmit SRS and/or CSI when the indication is received after the specific timing (e.g., the time interval from the UE receives the indication to the symbol n is shorter than the time duration), in accordance with embodiments of the present invention.

FIG. 21 is a flow diagram of a UE receiving a RRC message comprising DRX configuration(s), receiving an indication of one or more DRX configurations, applying the indication to the one or more DRX configurations to perform PDCCH monitoring, and determining whether to transmit SRS and/or CSI, in a symbol n, or not based on the indication, in accordance with embodiments of the present invention.

FIG. 22 is a flow diagram of a UE receiving a first signaling to configure at least one value of a DRX parameter, receiving, in a serving cell, a second signaling indicating a first value of the DRX parameter or a second value of the at least one value of the DRX parameter, and performing at least one of: adjusting the DRX parameter for a first DRX group or a second DRX group, restarting or starting a drx-onDurationTimer at a timing, stopping the drx-onDurationTimer in response to receiving the second signaling, or stopping the drx-onDurationTimer upon or after transmitting a confirmation, in accordance with embodiments of the present invention.

### DETAILED DESCRIPTION

The invention described herein can be applied to or implemented in exemplary wireless communication systems and devices described below. In addition, the invention is described mainly in the context of the 3GPP architecture reference model. However, it is understood that with the disclosed information, one skilled in the art could easily adapt for use and implement aspects of the invention in a 3GPP2 network architecture as well as in other network architectures.

The exemplary wireless communication systems and devices described below employ a wireless communication system, supporting a broadcast service. Wireless communication systems are widely deployed to provide various types of communication such as voice, data, and so on. These systems may be based on code division multiple access (CDMA), time division multiple access (TDMA), orthogonal frequency division multiple access (OFDMA), 3GPP LTE (Long Term Evolution) wireless access, 3GPP LTE-A (Long Term Evolution Advanced) wireless access, 3GPP2 UMB (Ultra Mobile Broadband), WiMax, 3GPP NR (New Radio), or some other modulation techniques.

In particular, the exemplary wireless communication systems and devices described below may be designed to support one or more standards such as the standard offered by a consortium named “3rd Generation Partnership Project” referred to herein as 3GPP, including: [1] RP-213587, “Study on XR Enhancements for NR”; [2] 3GPP TR 38.838 V17.0.0, “Study on XR (Extended Reality) Evaluations for NR”; [3] 3GPP TS 38.321 V17.0.0, “NR, Medium Access Control (MAC) protocol specification”; and [4] 3GPP TS 38.331 V17.0.0, “NR, Radio Resource Control (RRC) protocol specification”. The standards and documents listed above are hereby expressly and fully incorporated herein by reference in their entirety.

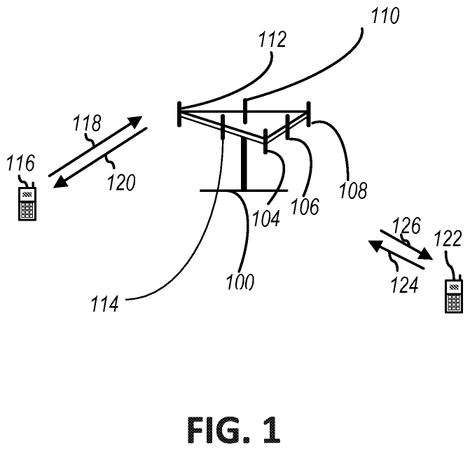

FIG. 1 shows a multiple access wireless communication system according to one embodiment of the invention. An access network 100 (AN) includes multiple antenna groups, one including 104 and 106, another including 108 and 110, and an additional including 112 and 114. In FIG. 1, only two antennas are shown for each antenna group, however, more or fewer antennas may be utilized for each antenna group. Access terminal (AT) 116 is in communication with antennas 112 and 114, where antennas 112 and 114 transmit information to access terminal 116 over forward link 120 and receive information from AT 116 over reverse link 118. AT 122 is in communication with antennas 106 and 108, where antennas 106 and 108 transmit information to AT 122 over forward link 126 and receive information from AT 122 over reverse link 124. In a FDD system, communication links 118, 120, 124 and 126 may use different frequency for communication. For example, forward link 120 may use a different frequency than that used by reverse link 118.

Each group of antennas and/or the area in which they are designed to communicate is often referred to as a sector of the access network. In the embodiment, antenna groups each are designed to communicate to access terminals in a sector of the areas covered by access network 100.

In communication over forward links 120 and 126, the transmitting antennas of access network 100 may utilize beamforming in order to improve the signal-to-noise ratio of forward links for the different access terminals 116 and 122. Also, an access network using beamforming to transmit to access terminals scattered randomly through its coverage normally causes less interference to access terminals in neighboring cells than an access network transmitting through a single antenna to all its access terminals.

The AN may be a fixed station or base station used for communicating with the terminals and may also be referred to as an access point, a Node B, a base station, an enhanced base station, an eNodeB, or some other terminology. The AT may also be called User Equipment (UE), a wireless communication device, terminal, access terminal or some other terminology.

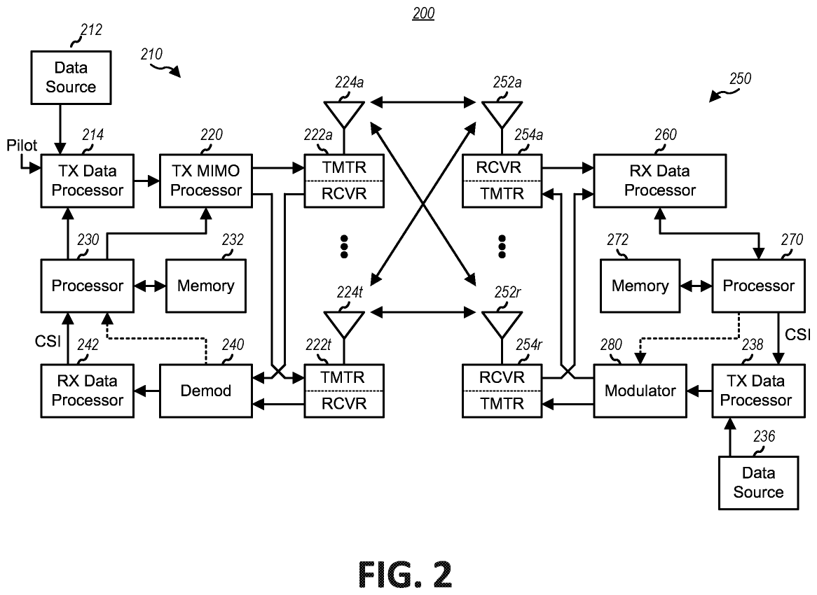

FIG. 2 is a simplified block diagram of an embodiment of a transmitter system 210 (also known as the access network) and a receiver system 250 (also known as access terminal (AT) or user equipment (UE)) in a MIMO system 200. At the transmitter system 210, traffic data for a number of data streams is provided from a data source 212 to a transmit (TX) data processor 214.

In one embodiment, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., BPSK, QPSK, M-PSK, or M-QAM) selected for that data stream to provide modulation symbols. The data rate, coding, and modulation for each data stream may be determined by instructions performed by processor 230. A memory 232 is coupled to processor 230.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain embodiments, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves, and decodes each detected symbol stream to recover the traffic data for the data stream. The processing by RX data processor 260 is complementary to that performed by TX MIMO processor 220 and TX data processor 214 at transmitter system 210.

A processor 270 periodically determines which pre-coding matrix to use (discussed below). Processor 270 formulates a reverse link message comprising a matrix index portion and a rank value portion.

The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

At transmitter system 210, the modulated signals from receiver system 250 are received by antennas 224, conditioned by receivers 222, demodulated by a demodulator 240, and processed by a RX data processor 242 to extract the reserve link message transmitted by the receiver system 250. Processor 230 then determines which pre-coding matrix to use for determining the beamforming weights then processes the extracted message.

Memory 232 may be used to temporarily store some buffered/computational data from 240 or 242 through Processor 230, store some buffed data from 212, or store some specific program codes. And Memory 272 may be used to temporarily store some buffered/computational data from 260 through Processor 270, store some buffed data from 236, or store some specific program codes.

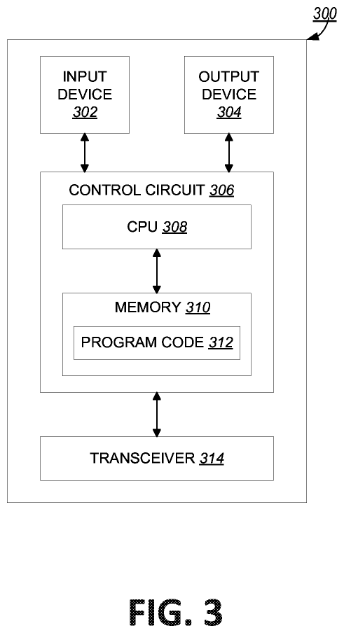

Turning to FIG. 3, this figure shows an alternative simplified functional block diagram of a communication device according to one embodiment of the invention. As shown in FIG. 3, the communication device 300 in a wireless communication system can be utilized for realizing the UEs (or ATs) 116 and 122 in FIG. 1, and the wireless communications system is preferably the N_{R} system. The communication device 300 may include an input device 302, an output device 304, a control circuit 306, a central processing unit (CPU) 308, a memory 310, a program code 312, and a transceiver 314. The control circuit 306 executes the program code 312 in the memory 310 through the CPU 308, thereby controlling an operation of the communications device 300. The communications device 300 can receive signals input by a user through the input device 302, such as a keyboard or keypad, and can output images and sounds through the output device 304, such as a monitor or speakers. The transceiver 314 is used to receive and transmit wireless signals, delivering received signals to the control circuit 306, and outputting signals generated by the control circuit 306 wirelessly.

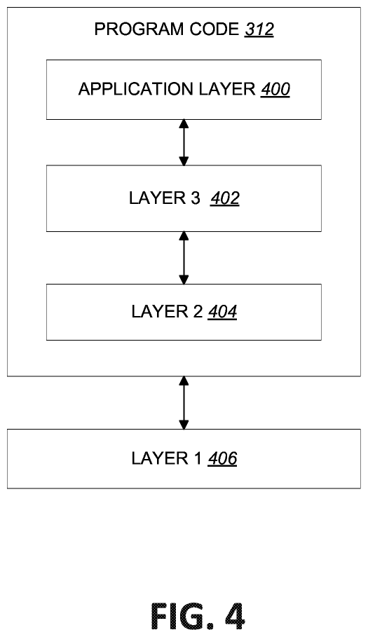

FIG. 4 is a simplified block diagram of the program code 312 shown in FIG. 3 in accordance with an embodiment of the invention. In this embodiment, the program code 312 includes an application layer 400, a Layer 3 portion 402, and a Layer 2 portion 404, and is coupled to a Layer 1 portion 406. The Layer 3 portion 402 generally performs radio resource control. The Layer 2 portion 404 generally performs link control. The Layer 1 portion 406 generally performs physical connections.

For LTE, LTE-A, or N_{R} systems, the Layer 2 portion 404 may include a Radio Link Control (RLC) layer and a Medium Access Control (MAC) layer. The Layer 3 portion 402 may include a Radio Resource Control (RRC) layer.

Any two or more than two of the following paragraphs, (sub-)bullets, points, actions, or claims described in each invention paragraph or section may be combined logically, reasonably, and properly to form a specific method.

Any sentence, paragraph, (sub-)bullet, point, action, or claim described in each of the following invention paragraphs or sections may be implemented independently and separately to form a specific method or apparatus. Dependency, e.g., “based on”, “more specifically”, “example”, etc., in the following invention disclosure is just one possible embodiment which would not restrict the specific method or apparatus.

The description of the release 18 study item of extended reality (XR) in N_{R} is specified in [1] RP-213587, “Study on XR Enhancements for N_{R}”:

### Quotation Start [1]

### 3 Justification

The RAN1 Rel-17 Study Item “Study on XR Evaluations for N_{R}” has shown that eXtended Reality (XR) and Cloud Gaming (CG) are within the use cases and services considered important for N_{R} in Rel-18 and beyond. In general, XR and CG are wide terms referring to various types of augmented, virtual, and mixed environments, where human-to-machine and human-to-human communications are performed with the assistance of handheld and wearable end user devices (UEs).
Cloud Gaming (CG) refers to the group of use cases, where the overwhelming majority of computations related to gaming (single-player or multi-player) is offloaded from the UE to edge or remote server(s).
EXtended Reality (XR) is a broad-scope umbrella for multiple heterogeneous use cases and services, that were studied and outlined in SA1, SA2, and SA4, including but not limited to TR 22.842 and TR 26.928. These XR use cases can be roughly divided into: (i) augmented reality (AR); (ii) virtual reality (VR), and (iii) mixed reality (MR).

While XR and CG present a set of attractive use cases for future mobile systems, they also impose a set of challenges for N_{R} that need to be studied and potentially addressed.

Many of the XR and CG use cases are characterised by quasi-periodic traffic (with possible jitter) with high data rate in DL (i.e., video steam) combined with the frequent UL (i.e., pose/control update) and/or UL video stream. Both DL and UL traffic are also characterized by relatively strict packet delay budget (PDB). Hence, there is a need to study and potentially specify possible solutions to better support such challenging services.

Many of the end user XR and CG devices are expected to be mobile and of small-scale, thus having limited battery power resources. Therefore, additional power enhancements may be needed to reduce the overall UE power consumption when running XR and CG services and thus extend the effective UE battery lifetime. It is understood that the current DRX configurations do not fit well for (i) the non-integer XR traffic periodicity, (ii) variable XR data rate and (iii) quasi-periodic XR periodicity, hence enhancements would be beneficial in this area.

The set of anticipated XR and CG services has a certain variety and characteristics of the data streams (i.e., video) may change “on-the-fly”, while the services are running over N_{R}. Therefore, additional information on the running services from higher layers, e.g. the QoS flow association, frame-level QoS, ADU-based QoS, XR specific QoS etc, may be beneficial to facilitate informed choices of radio parameters. It is clear that XR application awareness by UE and gNB would improve the user experience, improve the N_{R} system capacity in supporting XR services, and reduce the UE power consumption. It is expected that SA Working Groups would lead the work on identifying necessary enhancements to improve XR awareness, and that RAN will be made aware of these enhanced parameters and can potentially tailor the radio processing of XR traffic.

### 4 Objective

### 4.1 Objective of SI or Core Part WI or Testing Part WI

The study is to be based on Release 17 TR 38.838, on corresponding Release 17 work from SA4 (as per SP-210043) and on Release 18 work from SA2 (as per SP-211166).

### Objectives on XR-Awareness in RAN (RAN2):

Study and identify the XR traffic (both UL and DL) characteristics, QoS metrics, and application layer attributes beneficial for the gNB to be aware of.
Study how the above information aids XR-specific traffic handling.

### Objectives on XR-Specific Power Saving (RAN1, RAN2):

Study XR specific power saving techniques to accommodate XR service characteristics (periodicity, multiple flows, jitter, latency, reliability, etc. . . . ). Focus is on the following techniques:
   C-DRX enhancement.
   PDCCH monitoring enhancement.

### Quotation End

The single stream and multi-streams DL traffic models of XR are specified in TS 38.838 (e.g., [2] 3GPP TR 38.838 V17.0.0, “Study on XR (Extended Reality) Evaluations for N_{R}”) as below:

### Quotation Start [2]

### 5.1 Generic DL Traffic Model

### 5.1.1 Single Stream DL Traffic Model

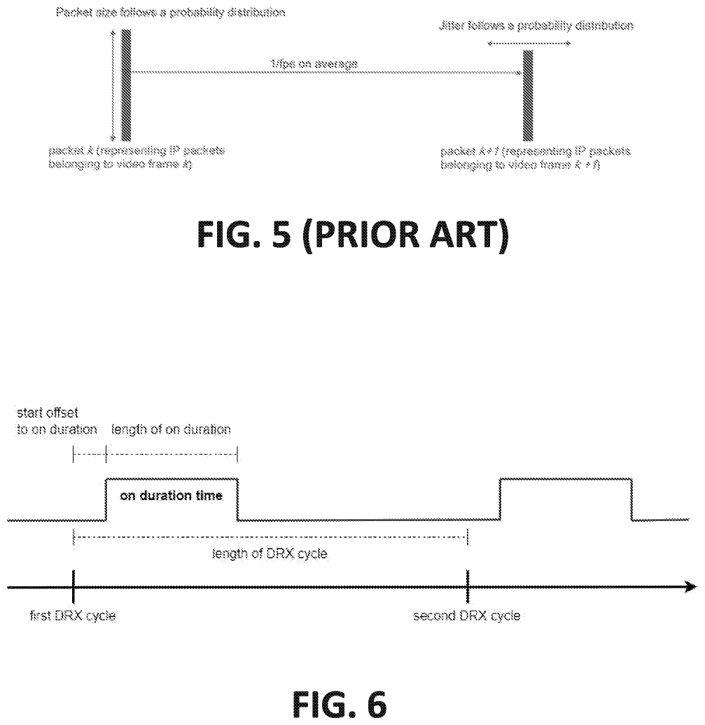

This clause provides a parameterized generic single stream DL traffic model. In this model, as shown in FIGS. 5.1-1, the XR DL traffic is modelled as a sequence of video frames arriving at gNB according to the considered video frame rates and random jitter. The size of each frame is also random according to a certain distribution.

FIG. 5 is a reproduction of FIG. 5.1.1-1: Single stream DL traffic model, from 3GPP TR 38.838 V17.0.0, “Study on XR (Extended Reality) Evaluations for N_{R}.

### 5.1.1.1 Packet Size

In this model, a packet models the set of IP packets belong to the same video frame. The video frame includes both left and right eye frame sharing the same buffer, which is referred to as ‘single stream for dual eye buffer’ or ‘single eye buffer’ throughout this document.

The size of a packet is determined by the given data rates and frame rates, which is modelled as a random variable following truncated Gaussian distribution with following statistical parameters.

TABLE 5.1.1.1-1
Statistical parameters for packet size following
truncated Gaussian distribution

| | | | Optional values for |
|---|---|---|---|
| | | Baseline values for | evaluation for |
| Parameter | unit | evaluation | single eye buffer |
| Mean: M | byte | R × 1e6/F/8 | R × 1e6/F/8 |
| STD | byte | 10.5% of M | 3% of M |
| Max | byte | 150% of M | 109% of M |
| Min | byte | 50% of M | 91% of M |

R: data rate of the flow in Mbps.
F: frame generation rate of the flow in fps.
Note that the mean and STD apply before truncation applies.
Note that the value of R, F depend on application.

### 5.1.1.2 Packet Arrival

In this model, the packet arrival rate is determined by the frame generation rate, e.g., 60 fps. Accordingly, the average packet arrival periodicity is given by the inverse of the frame rate, e.g., 16.6667 ms=1/60 fps. The periodic arrival without jitter gives the arrival time at gNB for packet with index k (=1,2,3 . . . ) as

k/F*1000 [ms],

where F is the given frame generation rates (per second).

Note that this periodic packet arrival implicitly assumes fixed delay contributed from network side including fixed video encoding time, fixed network transfer delay, etc.

However, in a real system, the varying frame encoding delay and network transfer time introduces jitter in packet arrival time at gNB which. In this model, the jitter is modelled as a random variable added on top of periodic arrivals. The jitter follows truncated Gaussian distribution with following statistical parameters shown in Table 5.1-2.

TABLE 5.1.1.2-1
Statistical parameters for jitter

| | | Baseline value for | Optional value for |
|---|---|---|---|
| Parameter | unit | evaluation | evaluation |
| Mean | ms | 0 | |
| STD | ms | 2 | |
| Truncation range | ms | [−4, 4] | [−5, 5] |

Note that the given parameter values and considered frame generation rates (60 or 120 in this model) ensure that packet arrivals are in order (i.e., arrival time of a next packet is always larger than that of the previous packet).

Thus, the periodic arrival with jitter gives the arrival time for packet with index k (=1,2,3 . . . ) as

offset+k/F*1000+J [ms],

where F is the given frame generation rates (per second) and J is a random variable capturing jitter. Note that actual traffic arrival timing of traffic for each UE could be shifted by the UE specific arbitrary offset.

### 5.1.1.3 Packet Delay Budget

The latency requirement of XR traffic in RAN side (i.e., air interface) is modelled as packet delay budget (PDB). The PDB is a limited time budget for a packet to be transmitted over the air from a gNB to a UE.

For a given packet, the delay of the packet incurred in air interface is measured from the time that the packet arrives at the gNB to the time that it is successfully transferred to the UE. If the delay is larger than a given PDB for the packet, then, the packet is said to violate PDB, otherwise the packet is said to be successfully delivered.

The value of PDB may vary for different applications and traffic types.

[ . . . ]

### 5.1.2 Multi-Streams DL Traffic Model

This clause provides optional multi-streams model for XR DL traffic.
Option 1: I-frame+P-frame
   Option 1A: slice-based traffic model
   Option 1B: Group-Of-Picture (GOP) based traffic model
Option 2: video+audio/data
Option 3: FOV+omnidirectional stream

### 5.1.2.1 Option 1 (I+P)

For Option 1, two streams (I-stream and P-stream) are modelled according to Table 5.1-5.
Stream 1: I stream
Stream 2: P stream Depending on the video encoding scheme, two additional sub models—slice based, and Group of Picture (GOP)-based models are defined.
Slice-based: In this encoding scheme, a single video frame is divided into N slices. Out of N, one slice is I slice and remaining N−1 slices are P slices. N packets (one I and N−1 P) packets corresponds to one video frame arriving at the same time.
GOP-based: In this encoding scheme, a single video frame is either I frame or P frame. I frame is transmitted every K frames, where K is the GOP size, i.e., every group of picture. One video frame arrives at a time as a packet.

TABLE 5.1.2.1-1
Statistical parameters for Option 1 multi streams DL traffic model

| | Two data streams | | | |
|---|---|---|---|---|
| | Option 1A: slice-based | | Option 1B: GOP-based | |
| | I-stream | P-stream | I-stream | P-stream |
| Packet | Slice-level | | Frame-level | |
| modelling | | | | |
| Traffic | Both streams are periodic at | | Follow the GOP structure, | |
| pattern | 60 fps with the same jitter | | where GOP size K = 8 | |
| | model as for single stream. | | with the same jitter model | |
| | | | as for single stream. | |
| Number of | 1 | N-1 | I-frame: 1 or 0 | |
| packets per | N = 8: the number of slices | | P-frame: 0 or 1 | |
| stream at a | per frame. | | At each time instant, | |
| time | | | there is either only one | |
| | | | I-stream packet or | |
| | | | only one P-stream packet | |
| Average data rate per stream | $\begin{matrix}{R}_{I} = R * \\ \frac{α}{N - 1 + α}\end{matrix}$ | $\begin{matrix}{R}_{P} = R * \\ \frac{N - 1}{N - 1 + α}\end{matrix}$ | $\begin{matrix}{R}_{I} = R * \\ \frac{α}{K - 1 + α}\end{matrix}$ | $\begin{matrix}{R}_{P} = R * \\ \frac{K - 1}{K - 1 + α}\end{matrix}$ |
| | R: average data rate of a single stream video | | | |
| | α: average size ratio between one I-frame/slice and one | | | |
| | P-frame/slice | | | |
| | α = 1.5, 2 (baseline) | | | |
| | α = 3 (optional) | | | |
| Packet size | Truncated Gaussian distribution | | | |
| distribution | | | | |
| | $\begin{matrix}Mean = \\ \frac{{R}_{I}}{FPS}\end{matrix}$ | $\begin{matrix}Mean = \\ \frac{{R}_{P}}{\begin{matrix}FPS * \\ ( N - 1 )\end{matrix}}\end{matrix}$ | $\begin{matrix}Mean = \\ {R}_{I} * \\ \frac{K}{FPS}\end{matrix}$ | $\begin{matrix}Mean = \\ {R}_{P} * \\ \frac{K}{\begin{matrix}FPS * \\ ( K - 1 )\end{matrix}}\end{matrix}$ |

| | |
|---|---|
| | [STD, Max, Min]: [10.5, 150, 50]% of Mean packet size |
| | FPS is the frame rate of the single stream video |
| | Depends on application, see 6.3.1, 6.4.1, 6.5.1 for VR, CG, |
| | AR respectively. |
| PDB | Depends on application, see 6.3.1, 6.4.1, 6.5.1 for VR, CG, |
| | AR respectively. |

### 5.1.2.2 Option 2 (Video+Audio/Data)

For Option 2, two streams (video+audio/data) are modelled.
Stream 1: video
Stream 2: audio/data

The stream 1—video stream follows the generic single stream model given in clause 5.1.1. The stream 2—audio/data a periodic traffic with following parameters.

TABLE 5.1.2.2-1
Statistical parameter values for Option 2 multi streams model

| | | Baseline values | Optional values |
|---|---|---|---|
| Parameters | unit | for evaluation | for evaluation |
| Periodicity P | ms | 10 | |
| Data rate: R | Mbps | 0.756, 1.12 | |
| Packet size | byte | R × 1e6 × P/1000/8 | |
| PDB | ms | 30 | Other values can be |
| | | | optionally evaluated |
| Packet Success Rate | % | 99 | 99.9 |

### 5.1.2.3 Option 3 (FOV+Omnidirectional View)

For Option 3, following two streams are modelled.
Stream 1: FOV
Stream 2: omnidirectional view stream

### Quotation End

The Discontinuous Reception (DRX) is specified in TS 38.321 (e.g., [3] 3GPP TS 38.321 V17.0.0, “N_{R}, Medium Access Control (MAC) protocol specification”) as below:

### Quotation Start [3]

### 5.7 Discontinuous Reception (DRX)

The MAC entity may be configured by RRC with a DRX functionality that controls the UE's PDCCH monitoring activity for the MAC entity's C-RNTI, CI-RNTI, CS-RNTI, INT-RNTI, SFI-RNTI, SP-CSI-RNTI, TPC-PUCCH-RNTI, TPC-PUSCH-RNTI, TPC-SRS-RNTI, AI-RNTI, SL-RNTI, SLCS-RNTI and SL Semi-Persistent Scheduling V-RNTI. When using DRX operation, the MAC entity shall also monitor PDCCH according to requirements found in other clauses of this specification. When in RRC_CONNECTED, if DRX is configured, for all the activated Serving Cells, the MAC entity may monitor the PDCCH discontinuously using the DRX operation specified in this clause; otherwise the MAC entity shall monitor the PDCCH as specified in TS 38.213 [6].

RRC controls DRX operation by configuring the following parameters:
drx-onDurationTimer: the duration at the beginning of a DRX cycle;
drx-SlotOffset: the delay before starting the drx-onDurationTimer;
drx-InactivityTimer: the duration after the PDCCH occasion in which a PDCCH indicates a new UL or DL transmission for the MAC entity;
drx-RetransmissionTimerDL (per DL HARQ process except for the broadcast process): the maximum duration until a DL retransmission is received;
drx-RetransmissionTimerUL (per UL HARQ process): the maximum duration until a grant for UL retransmission is received;
drx-LongCycleStartOffset: the Long DRX cycle and drx-StartOffset which defines the subframe where the Long and Short DRX cycle starts;
drx-ShortCycle (optional): the Short DRX cycle;
drx-ShortCycleTimer (optional): the duration the UE shall follow the Short DRX cycle;
drx-HARQ-RTT-TimerDL (per DL HARQ process except for the broadcast process): the minimum duration before a DL assignment for HARQ retransmission is expected by the MAC entity;
drx-HARQ-RTT-TimerUL (per UL HARQ process): the minimum duration before a UL HARQ retransmission grant is expected by the MAC entity;
drx-RetransmissionTimerSL (per SL HARQ process): the maximum duration until a grant for SL retransmission is received;
drx-HARQ-RTT-TimerSL (per SL HARQ process): the minimum duration before an SL retransmission grant is expected by the MAC entity;
ps-Wakeup (optional): the configuration to start associated drx-onDurationTimer in case DCP is monitored but not detected;
ps-TransmitOtherPeriodicCSI (optional): the configuration to report periodic CSI that is not L1-RSRP on PUCCH during the time duration indicated by drx-onDurationTimer in case DCP is configured but associated drx-onDurationTimer is not started;
ps-TransmitPeriodicL1-RSRP (optional): the configuration to transmit periodic CSI that is L1-RSRP on PUCCH during the time duration indicated by drx-onDurationTimer in case DCP is configured but associated drx-onDurationTimer is not started;
uplinkHARQ-Mode (optional): the configuration to set the HARQ mode per UL HARQ process.

Serving Cells of a MAC entity may be configured by RRC in two DRX groups with separate DRX parameters. When RRC does not configure a secondary DRX group, there is only one DRX group and all Serving Cells belong to that one DRX group. When two DRX groups are configured, each Serving Cell is uniquely assigned to either of the two groups. The DRX parameters that are separately configured for each DRX group are: drx-onDurationTimer, drx-InactivityTimer. The DRX parameters that are common to the DRX groups are: drx-Slot Offset, drx-RetransmissionTimerDL, drx-RetransmissionTimerUL, drx-LongCycleStartOffset, drx-ShortCycle (optional), drx-ShortCycleTimer (optional), drx-HARQ-RTT-TimerDL, drx-HARQ-RTT-TimerUL, and uplinkHARQ-Mode (optional).

When DRX is configured, the Active Time for Serving Cells in a DRX group includes the time while:
drx-onDurationTimer or drx-InactivityTimer configured for the DRX group is running; or
drx-RetransmissionTimerDL, drx-RetransmissionTimerUL or drx-RetransmissionTimerSL is running on any Serving Cell in the DRX group; or
ra-ContentionResolutionTimer (as described in clause 5.1.5) or msgB-Response Window (as described in clause 5.1.4a) is running; or
a Scheduling Request is sent on PUCCH and is pending (as described in clause 5.4.4 or 5.22.15). If this Serving Cell is part of a non-terrestrial network, the Active Time is started after the first Scheduling Request transmission plus the UE-gNB RTT; or
a PDCCH indicating a new transmission addressed to the C-RNTI of the MAC entity has not been received after successful reception of a Random Access Response for the Random Access Preamble not selected by the MAC entity among the contention-based Random Access Preamble (as described in clauses 5.1.4 and 5.1.4a).

When DRX is configured, the MAC entity shall:
1> if a MAC PDU is received in a configured downlink assignment:
   2> start the drx-HARQ-RTT-TimerDL for the corresponding HARQ process in the first symbol after the end of the corresponding transmission carrying the DL HARQ feedback;
[ . . . ]
   2> stop the drx-RetransmissionTimerDL for the corresponding HARQ process.
1> if a MAC PDU is transmitted in a configured uplink grant and LBT failure indication is not received from lower layers:
   2> if this Serving Cell is not configured with uplinkHARQ-Mode; or
   2> if this Serving Cell is configured with uplinkHARQ-Mode and the corresponding HARQ process is configured as HARQ Mode A:
      3> start the drx-HARQ-RTT-TimerUL for the corresponding HARQ process in the first symbol after the end of the first transmission (within a bundle) of the corresponding PUSCH transmission;
   2> stop the drx-RetransmissionTimerUL for the corresponding HARQ process at the first transmission (within a bundle) of the corresponding PUSCH transmission.
1> if a drx-HARQ-RTT-TimerDL expires:
   2> if the data of the corresponding HARQ process was not successfully decoded:
      3> start the drx-RetransmissionTimerDL for the corresponding HARQ process in the first symbol after the expiry of drx-HARQ-RTT-TimerDL.
1> if a drx-HARQ-RTT-TimerUL expires:
   2> start the drx-RetransmissionTimerUL for the corresponding HARQ process in the first symbol after the expiry of drx-HARQ-RTT-TimerUL.
1> if a drx-HARQ-RTT-TimerSL expires:
   2> if a HARQ NACK feedback for the corresponding HARQ process is transmitted on PUCCH; or
   2> if a HARQ NACK feedback for the corresponding HARQ process is not transmitted on PUCCH due to UL/SL prioritization:
      3> start the drx-RetransmissionTimerSL for the corresponding HARQ process in the first symbol after the expiry of drx-HARQ-RTT-TimerSL.
   2> else if the PUCCH resource is not configured and PSFCH is configured for the SL grant:
      3> start the drx-RetransmissionTimerSL for the corresponding HARQ process in the first symbol after the expiry of drx-HARQ-RTT-TimerSL.
NOTE: The UE handles the drx-RetransmissionTimerSL operation when sl-PUCCH-Config is configured by RRC but PUCCH resource is not scheduled same as when sl-PUCCH-Config is not configured.
1> if a DRX Command MAC CE or a Long DRX Command MAC CE is received:
   2> stop drx-onDurationTimer for each DRX group;
   2> stop drx-InactivityTimer for each DRX group.
1> if drx-InactivityTimer for a DRX group expires:
   2> if the Short DRX cycle is configured:
      3> start or restart drx-ShortCycleTimer for this DRX group in the first symbol after the expiry of drx-InactivityTimer;
      3> use the Short DRX cycle for this DRX group.
   2> else:
      3> use the Long DRX cycle for this DRX group.
1> if a DRX Command MAC CE is received:
   2> if the Short DRX cycle is configured:
      3> start or restart drx-ShortCycleTimer for each DRX group in the first symbol after the end of DRX Command MAC CE reception;
      3> use the Short DRX cycle for each DRX group.
   2> else:
      3> use the Long DRX cycle for each DRX group.
1> if drx-ShortCycleTimer for a DRX group expires:
   2> use the Long DRX cycle for this DRX group.
1> if a Long DRX Command MAC CE is received:
   2> stop drx-ShortCycleTimer for each DRX group;
   2> use the Long DRX cycle for each DRX group.
1> if the Short DRX cycle is used for a DRX group, and [(SFN×10)+subframe number] modulo (drx-ShortCycle)=(drx-StartOffset) modulo (drx-ShortCycle):
   2> start drx-onDurationTimer for this DRX group after drx-SlotOffset from the beginning of the subframe.
1> if the Long DRX cycle is used for a DRX group, and [(SFN×10)+subframe number] modulo (drx-LongCycle)=drx-StartOffset:
   2> if DCP monitoring is configured for the active DL BWP as specified in TS 38.213 [6], clause 10.3:
      3> if DCP indication associated with the current DRX cycle received from lower layer indicated to start drx-onDurationTimer, as specified in TS 38.213 [6]; or
      3> if all DCP occasion(s) in time domain, as specified in TS 38.213 [6], associated with the current DRX cycle occurred in Active Time considering grants/assignments/DRX Command MAC CE/Long DRX Command MAC CE received and Scheduling Request sent until 4 ms prior to start of the last DCP occasion, or during a measurement gap, or when the MAC entity monitors for a PDCCH transmission on the search space indicated by recoverySearchSpaceId of the SpCell identified by the C-RNTI while the ra-Response Window is running (as specified in clause 5.1.4); or
      3> if ps-Wakeup is configured with value true and DCP indication associated with the current DRX cycle has not been received from lower layers:
         4> start drx-onDurationTimer after drx-SlotOffset from the beginning of the subframe. 2> else:
      3> start drx-onDurationTimer for this DRX group after drx-SlotOffset from the beginning of the subframe.
NOTE 2: In case of unaligned SFN across carriers in a cell group, the SFN of the SpCell is used to calculate the DRX duration.
1> if a DRX group is in Active Time:
   2> monitor the PDCCH on the Serving Cells in this DRX group as specified in TS 38.213 [6];
   2> if the PDCCH indicates a DL transmission; or
   2> if the PDCCH indicates a one-shot HARQ feedback as specified in clause 9.1.4 of TS 38.213 [6]; or
   2> if the PDCCH indicates a retransmission of HARQ feedback as specified in clause 9.1.5 of TS 38.213 [6]:
      3> start or restart the drx-HARQ-RTT-TimerDL for the corresponding HARQ process(es) whose HARQ feedback is reported in the first symbol after the end of the corresponding transmission carrying the DL HARQ feedback;
   NOTE 3: When HARQ feedback is postponed by PDSCH-to-HARQ_feedback timing indicating an inapplicable kl value, as specified in TS 38.213 [6], the corresponding transmission opportunity to send the DL HARQ feedback is indicated in a later PDCCH requesting the HARQ-ACK feedback.
      3> stop the drx-RetransmissionTimerDL for the corresponding HARQ process(es) whose HARQ feedback is reported.
      3> if the PDSCH-to-HARQ_feedback timing indicate an inapplicable kl value as specified in TS 38.213 [6]:
         4> start the drx-RetransmissionTimerDL in the first symbol after the (end of the last) PDSCH transmission (within a bundle) for the corresponding HARQ process.
   2> if the PDCCH indicates a UL transmission:
      3> if this Serving Cell is not configured with uplinkHARQ-Mode; or
      3> if this Serving Cell is configured with uplinkHARQ-Mode and the corresponding HARQ process is configured as HARQ Mode A:
         4> start the drx-HARQ-RTT-TimerUL for the corresponding HARQ process in the first symbol after the end of the first transmission (within a bundle) of the corresponding PUSCH transmission;
      3> stop the drx-RetransmissionTimerUL for the corresponding HARQ process.
   2> if the PDCCH indicates an SL transmission:
      3> if the PUCCH resource is configured:
         4> start the drx-HARQ-RTT-TimerSL for the corresponding HARQ process in the first symbol after the end of the corresponding PUCCH transmission carrying the SL HARQ feedback; or
         4> start the drx-HARQ-RTT-TimerSL for the corresponding HARQ process in the first symbol after the end of the corresponding PUCCH resource for the SL HARQ feedback when the PUCCH is not transmitted due to UL/SL prioritization;
         4> stop the drx-RetransmissionTimerSL for the corresponding HARQ process.
      3> else:
         4> start the drx-HARQ-RTT-TimerSL for the corresponding HARQ process at the first symbol after end of PDCCH occasion;
         4> stop the drx-RetransmissionTimerSL for the corresponding HARQ process.
   2> if the PDCCH indicates a new transmission (DL, UL or SL) on a Serving Cell in this DRX group:
      3> start or restart drx-InactivityTimer for this DRX group in the first symbol after the end of the PDCCH reception.
NOTE 3a: A PDCCH indicating activation of SPS, configured grant type 2, or configured sidelink grant of configured grant Type 2 is considered to indicate a new transmission.
NOTE 3b: If the PDCCH reception includes two PDCCH candidates from corresponding search spaces, as described in clause 10.1 in 38.213, start or restart drx-InactivityTimer for this DRX group in the first symbol after the end of the PDCCH candidate that ends later in time.
   2> if a HARQ process receives downlink feedback information and acknowledgement is indicated:
      3> stop the drx-RetransmissionTimerUL for the corresponding HARQ process.
1> if DCP monitoring is configured for the active DL BWP as specified in TS 38.213 [6], clause 10.3; and
1> if the current symbol n occurs within drx-onDurationTimer duration; and
1> if drx-onDurationTimer associated with the current DRX cycle is not started as specified in this clause:
   2> if the MAC entity would not be in Active Time considering grants/assignments/DRX Command MAC CE/Long DRX Command MAC CE received and Scheduling Request sent until 4 ms prior to symbol n when evaluating all DRX Active Time conditions as specified in this clause:
      3> not transmit periodic SRS and semi-persistent SRS defined in TS 38.214 [7];
      3> not report semi-persistent CSI configured on PUSCH;
      3> if ps-TransmitPeriodicL1-RSRP is not configured with value true:
         4> not report periodic CSI that is L1-RSRP on PUCCH.
      3> if ps-TransmitOtherPeriodicCSI is not configured with value true:
         4> not report periodic CSI that is not L1-RSRP on PUCCH.
1> else:
   2> in current symbol n, if a DRX group would not be in Active Time considering grants/assignments scheduled on Serving Cell(s) in this DRX group and DRX Command MAC CE/Long DRX Command MAC CE received and Scheduling Request sent until 4 ms prior to symbol n when evaluating all DRX Active Time conditions as specified in this clause; and
   2> if allowCSI-SRS-Tx-MulticastDRX-Active is not configured or, in current symbol n, if all multicast DRX would not be in Active Time considering multicast assignments and DRX Command MAC CE for MBS multicast received until 4 ms prior to symbol n when evaluating all DRX Active Time conditions as specified in Clause 5.7b:
      3> not transmit periodic SRS and semi-persistent SRS defined in TS 38.214 [7] in this DRX group;
      3> not report CSI on PUCCH and semi-persistent CSI configured on PUSCH in this DRX group.
   2> if CSI masking (csi-Mask) is setup by upper layers:
      3> in current symbol n, if drx-onDurationTimer of a DRX group would not be running considering grants/assignments scheduled on Serving Cell(s) in this DRX group and DRX Command MAC CE/Long DRX Command MAC CE received until 4 ms prior to symbol n when evaluating all DRX Active Time conditions as specified in this clause; and
         4> not report CSI on PUCCH in this DRX group.
NOTE 4: If a UE multiplexes a CSI configured on PUCCH with other overlapping UCI(s) according to the procedure specified in TS 38.213 [6] clause 9.2.5 and this CSI multiplexed with other UCI(s) would be reported on a PUCCH resource either outside DRX Active Time of the DRX group in which this PUCCH is configured or outside the on-duration period of the DRX group in which this PUCCH is configured if CSI masking is setup by upper layers, it is up to UE implementation whether to report this CSI multiplexed with other UCI(s).

Regardless of whether the MAC entity is monitoring PDCCH or not on the Serving Cells in a DRX group, the MAC entity transmits HARQ feedback, aperiodic CSI on PUSCH, and aperiodic SRS defined in TS 38.214 [7] on the Serving Cells in the DRX group when such is expected.

The MAC entity needs not to monitor the PDCCH if it is not a complete PDCCH occasion (e.g. the Active Time starts or ends in the middle of a PDCCH occasion).

### Quotation End

The configurations of DRX are specified in TS 38.331 (e.g., [4] 3GPP TS 38.331 V17.0.0, “N_{R}, Radio Resource Control (RRC) protocol specification”) as below:

### Quotation Start [4]

DRX-Config

The IE DRX-Config is used to configure DRX related parameters.

DRX-Config information element

| | |
|---|---|
| DRX-Config ::= | SEQUENCE { |
| drx-onDurationTimer | CHOICE { |
| | subMilliSeconds INTEGER (1..31), |
| | milliSeconds ENUMERATED { |
| | ms1, ms2, ms3, ms4, ms5, ms6, ms8, ms10, ms20, ms30, |

ms40, ms50, ms60,

ms80, ms100, ms200, ms300, ms400, ms500, ms600,

ms800, ms1000, ms1200,

ms1600, spare8, spare7, spare5, spare4,

spare3, spare2, spare1 }

| | |
|---|---|
| | }, |
| drx-InactivityTimer | ENUMERATED { |
| | ms0, ms1, ms2, ms3, ms4, ms5, ms6, ms8, ms10, ms20, ms30, |

ms40, ms50, ms60, ms80,

ms100, ms200, ms300, ms500, ms750, ms1280, ms1920,

ms2560, spare9, spare8,

| | |
|---|---|
| | spare7, spare6, spare5, spare4, spare3, spare2, spare1}, |
| drx-HARQ-RTT-TimerDL | INTEGER (0..56), |
| drx-HARQ-RTT-TimerUL | INTEGER (0..56), |
| drx-RetransmissionTimerDL | ENUMERATED { |
| | sl0, sl1, sl2, sl4, sl6, sl8, sl16, sl24, sl33, sl40, |

sl64, sl80, sl96, sl112, sl128,

sl160, sl320, spare15, spare14, spare13, spare12,

spare11, spare10, spare9,

spare8, spare7, spare6, spare5, spare4, spare3, spare2,

spare1},

| | |
|---|---|
| drx-RetransmissionTimerUL | ENUMERATED { |
| | sl0, sl1, sl2, sl4, sl6, sl8, sl16, sl24, sl33, sl40, |

sl64, sl80, sl96, sl112, sl128,

sl160, sl320, spare15, spare14, spare13, spare12,

spare11, spare10, spare9,

spare8, spare7, spare6, spare5, spare4, spare3, spare2,

spare1},

| | |
|---|---|
| drx-RetransmissionTimerUL | ENUMERATED { |
| | sl10, sl1, sl2, sl4, sl6, sl8, sl16, sl24, sl33, sl40, |

sl64, s180, sl96, sl112, sl128,

sl160, sl320, spare15, spare14, spare13, spare12,

spare11, spare10, spare9,

| | |
|---|---|
| | spare8, spare7, spare6, spare5, spare4, spare3, spare2, |
| spare1 }, | |
| drx-LongCycleStartOffset | CHOICE { |
| ms10 | INTEGER(0..9), |
| ms20 | INTEGER(0..19), |
| ms32 | INTEGER(0..31), |
| ms40 | INTEGER(0..39), |
| ms60 | INTEGER(0..59), |
| ms64 | INTEGER(0..63), |
| ms70 | INTEGER(0..69), |
| ms80 | INTEGER(0..79), |
| ms128 | INTEGER(0..127), |
| ms160 | INTEGER(0..159), |
| ms256 | INTEGER(0..255), |
| ms320 | INTEGER(0..319), |
| ms512 | INTEGER(0..511), |
| ms640 | INTEGER(0..639), |
| ms1024 | INTEGER(0..1023), |
| ms1280 | INTEGER(0..1279), |
| ms2048 | INTEGER(0..2047), |
| ms2560 | INTEGER(0..2559), |
| ms5120 | INTEGER(0..5119), |
| ms10240 | INTEGER(0..10239) |

},

| | |
|---|---|
| shortDRX | SEQUENCE { |
| drx-ShortCycle | ENUMERATED { |
| | ms2, ms3, ms4, ms5, ms6, ms7, ms8, ms10, ms14, ms16, |

ms20, ms30, ms32,

ms35, ms40, ms64, ms80, ms128, ms160, ms256, ms320,

ms512, ms640, spare9,

spare8, spare7, spare6, spare5, spare4, spare3,

spare2, spare1 },

| | |
|---|---|
| drx-ShortCycleTimer | INTEGER (1..16) |

}
OPTIONAL, -- Need R

| | |
|---|---|
| drx-SlotOffset | INTEGER (0..31) |

}

| | |
|---|---|
| DRX-ConfigExt-v1700 ::= | SEQUENCE { |
| drx-HARQ-RTT-TimerDL-r17 | INTEGER (0..448), |
| drx-HARQ-RTT-TimerUL-r17 | INTEGER (0..448) |

}
DRX-Config field descriptions
drx-HARQ-RTT-TimerDL
Value in number of symbols of the BWP where the transport block was received. drx-HARQ-RTT-TimerDL-r17 is only
applicable for SCS 480 kHz and 960 kHz. If configured, the UE shall ignore drx-HARQ-RTT-TimerDL (without suffix).
drx-HARQ-RTT-TimerUL
Value in number of symbols of the BWP where the transport block was transmitted. drx-HARQ-RTT-TimerUL-r17 is only
applicable for SCS 480 kHz and 960 kHz. If configured, the UE shall ignore drx-HARQ-RTT-TimerUL (without suffix).
drx-InactivityTimer
Value in multiple integers of 1 ms. ms0 corresponds to 0, ms1 corresponds to 1 ms, ms2 corresponds to 2 ms, and so
on.
drx-LongCycleStartOffset
drx-LongCycle in ms and drx-StartOffset in multiples of 1 ms. If drx-ShortCycle is configured, the value of drx-LongCycle
shall be a multiple of the drx-ShortCycle value.
drx-onDurationTimer
Value in multiples of 1/32 ms (subMilliSeconds) or in ms (milliSecond). For the latter, value ms1 corresponds to 1 ms,
value ms2 corresponds to 2 ms, and so on.
drx-RetransmissionTimerDL
Value in number of slot lengths of the BWP where the transport block was received. value sl0 corresponds to 0 slots, sl1
corresponds to 1 slot, sl2 corresponds to 2 slots, and so on.
drx-RetransmissionTimerUL
Value in number of slot lengths of the BWP where the transport block was transmitted. sl0 corresponds to 0 slots, sl1
corresponds to 1 slot, sl2 corresponds to 2 slots, and so on.
drx-ShortCycleTimer
Value in multiples of drx-ShortCycle. A value of 1 corresponds to drx-ShortCycle, a value of 2 corresponds to 2 * drx-
ShortCycle and so on.
drx-ShortCycle
Value in ms. ms1 corresponds to 1 ms, ms2 corresponds to 2 ms, and so on.
drx-SlotOffset
Value in 1/32 ms. Value 0 corresponds to 0 ms, value 1 corresponds to 1/32 ms, value 2 corresponds to 2/32 ms, and so
on

DRX-ConfigSecondaryGroup

The IE DRX-ConfigSecondaryGroup is used to configure DRX related parameters for the second DRX group as specified in TS 38.321 [3].

DRX-ConfigSecondaryGroup information element

| | |
|---|---|
| DRX-ConfigSecondaryGroup ::= | SEQUENCE { |
| drx-onDurationTimer | CHOICE { |
| | subMilliseconds INTEGER (1..31), |
| | milliSeconds ENUMERATED { |
| | ms1, ms2, ms3, ms4, ms5, ms6, ms8, ms10, ms20, ms30, |

ms40, ms50, ms60,

| | |
|---|---|
| | ms80, ms100, ms200, ms300, ms400, ms500, ms600, ms800, |
| ms1000, ms1200, | ms1600, spare8, spare7, spare6, spare5, spare4, |

spare3, spare2, spare1 }

| | |
|---|---|
| | }, |
| drx-InactivityTimer | ENUMERATED { |
| | ms0, ms1, ms2, ms3, ms4, ms5, ms6, ms8, ms10, ms20, ms30, |
| ms40, ms50, ms60, ms80, | ms100, ms200, ms300, ms500, ms750, ms1280, ms1920, ms2560, |

spare9, spare8,

spare7, spare6, spare5, spare4, spare3, spare2, spare1}

}
DRX-ConfigSecondaryGroup field descriptions
drx-InactivityTimer
Value in multiple integers of 1 ms. ms0 corresponds to 0, ms1 corresponds to 1 ms, ms2 corresponds to 2 ms, and so
on, as specified in TS 38.321 [3]. The network configures a drx-InactivityTimer value for the second DRX group that is
smaller than the drx-InactivityTimer configured for the default DRX group in IE DRX-Config.
drx-onDurationTimer
Value in multiples of 1/32 ms (subMilliSeconds) or in ms (milliSecond). For the latter, value ms1 corresponds to 1 ms,
value ms2 corresponds to 2 ms, and so on, as specified in TS 38.321 [3]. The network configures a drx-onDurationTimer
value for the second DRX group that is smaller than the drx-onDurationTimer configured for the default DRX group in IE
DRX-Config.

### Next Quotation

MAC-CellGroupConfig

The IE MAC-CellGroupConfig is used to configure MAC parameters for a cell group, including DRX.

MAC-CellGroupConfig information element

| | |
|---|---|
| MAC-CellGroupConfig ::= | SEQUENCE { |
| drx-Config | SetupRelease { DRX-Config } |

OPTIONAL, -- Need M
[...]

| | |
|---|---|
| drx-ConfigSecondaryGroup-r16 | SetupRelease { DRX-ConfigSecondaryGroup } |

OPTIONAL -- Need M
[...]
}
MAC-CellGroupConfig field descriptions
drx-Config, drx-ConfigExt
Used to configure DRX as specified in TS 38.321 [3].
drx-ConfigSecondaryGroup
Used to configure DRX related parameters for the second DRX group as specified in TS 38.321 [3]. The network does
not configure secondary DRX group with DCP simultaneously nor secondary DRX group with a dormant BWP
simultaneously.

### Quotation End

The activation/deactivation of SRS and CSI report is specified in TS 38.321 (e.g., [3] 3GPP TS 38.321 V17.0.0, “N_{R}, Medium Access Control (MAC) protocol specification”) as below:

### Quotation Start [3]

### 5.18.6 Activation/Deactivation of Semi-Persistent CSI Reporting on PUCCH

The network may activate and deactivate the configured Semi-persistent CSI reporting on PUCCH of a Serving Cell by sending the SP CSI reporting on PUCCH Activation/Deactivation MAC CE described in clause 6.1.3.16. The configured Semi-persistent CSI reporting on PUCCH is initially deactivated upon (re-)configuration by upper layers and after reconfiguration with sync.

The MAC entity shall:
1> if the MAC entity receives an SP CSI reporting on PUCCH Activation/Deactivation MAC CE on a Serving Cell:
   2> indicate to lower layers the information regarding the SP CSI reporting on PUCCH Activation/Deactivation MAC CE.

### 5.18.7 Activation/Deactivation of Semi-Persistent SRS and Indication of Spatial Relation of SP/AP SRS

The network may activate and deactivate the configured Semi-persistent SRS resource sets of a Serving Cell by sending the SP SRS Activation/Deactivation MAC CE described in clause 6.1.3.17. The network may also activate and deactivate the configured Semi-persistent SRS resource sets of a Serving Cell by sending the Enhanced SP/AP SRS Spatial Relation Indication MAC CE described in clause 6.1.3.26. The configured Semi-persistent SRS resource sets are initially deactivated upon (re-)configuration by upper layers and after reconfiguration with sync. The network may indicate the spatial relation info of SP/AP SRS resource sets of a Serving Cell by sending the Enhanced SP/AP SRS spatial relation Indication MAC CE described in clause 6.1.3.26.

The MAC entity shall:
1> if the MAC entity receives an SP SRS Activation/Deactivation MAC CE on a Serving Cell:
   2> indicate to lower layers the information regarding the SP SRS Activation/Deactivation MAC CE.
1> if the MAC entity receives an Enhanced SP/AP SRS Spatial Relation Indication MAC CE on a Serving Cell:
   2> indicate to lower layers the information regarding the Enhanced SP/AP SRS Spatial Relation Indication MAC CE.

### Quotation End

Extended Reality (XR) comprises different types of realities (e.g., Augmented Reality (AR), Mixed Reality (MR), Virtual Reality (VR) and the areas interpolated among them). XR may refer to all real-and-virtual combined environments and human-machine interactions generated by computer technology and wearables. The XR service and/or technology could be applied in various aspects, such as entertainment, simulation, product design, real-estate, training, education and/or remote work. In the applications, XR would have quasi-periodic traffic (with possible jitter) with high data rate in Downlink (DL) (e.g., video steam) and frequent traffic in Uplink (UL) (e.g., pose/control update). The XR traffic would have strict packet delay budget (PDB) and variable XR data rates. To better support such XR services in New Radio (N_{R}), the study item for XR is introduced ([1] RP-213587, “Study on XR Enhancements for N_{R}”). More details regarding XR could be found in TR 38.838 ([2] 3GPP TR 38.838 V17.0.0, “Study on XR (Extended Reality) Evaluations for N_{R}”).

In addition, a User Equipment (UE) for XR is expected to be mobile and of small-scale, which may have limited battery power resources. It may be needed to reduce the overall UE power consumption when running XR services, and thus extend the battery lifetime of the UE. Based on System Information (SI) ([1] RP-213587) and TR ([2] 3GPP TR 38.838 V17.0.0), to accommodate XR service characteristics (e.g., periodicity, multiple flows, jitter, latency, reliability), enhancements on Physical Downlink Control Channel (PDCCH) monitoring and/or (C-)Discontinuous Reception (DRX) mechanism may be needed. To reduce PDCCH monitoring and thus reduce power consumption for XR services, it may be needed to appropriately align the on duration time and/or DRX cycle with XR DL traffic arrival time (e.g., with jitter).

On the other hand, based on [3] 3GPP TS 38.321 V17.0.0, a Network (NW) can configure one or two DRX group to the UE. The serving cells of a Medium Access Control (MAC) entity may be configured in the one or two DRX groups. When two DRX groups are configured, each serving cell of the MAC entity is configured/assigned to either of the two groups. The UE may receive DRX configurations related to on duration (time), DRX cycle, inactivity time and/or retransmission time. If the UE is configured with DRX functionality, the UE monitors the PDCCH discontinuously using the DRX operation in Radio Resource Control (RRC) connected mode.

The DRX configuration(s) for on duration (time) (e.g., for a DRX group) may be and/or may comprise the length/duration of on duration time (e.g., drx-onDurationTimer) and/or the start offset to on duration time (e.g., drx-SlotOffset). The length/duration of on duration time (e.g., drx-onDurationTimer) may be (represent by and/or referred to) an on duration timer. The start offset to on duration time (e.g., drx-SlotOffset) may be applied to the start of the on duration timer (e.g., drx-onDurationTimer). The UE may start the on duration timer (e.g., drx-onDurationTimer) after the start offset to on duration time (e.g., drx-SlotOffset) for each DRX cycle. The UE may start the on duration timer (e.g., drx-onDurationTimer) after the start offset to on duration time (e.g., drx-SlotOffset) from the beginning of the subframe of a DRX cycle. The UE may monitor PDCCH when the on duration timer (e.g., drx-onDurationTimer) is running. The on duration time may be the duration when the on duration timer (e.g., drx-onDurationTimer) is running. Throughout the disclosure, the “on duration” may be referred to, supplemented by, and/or replaced by “on duration time”, “DRX on-duration” and/or “on-duration period”.

The DRX configuration(s) for DRX cycle (e.g., for a DRX group) may be and/or may comprise the length/duration of DRX cycle (e.g., drx-ShortCycle, drx-LongCycle), the start offset of DRX cycle (e.g., drx-StartOffset) and/or the time duration to use short DRX cycle (e.g., drx-ShortCycleTimer). The duration to use short DRX cycle (e.g., drx-ShortCycleTimer) may be (represent by and/or referred to) a short cycle timer. The UE may use short DRX cycle when the short cycle timer (e.g., drx-ShortCycleTimer) is running. The UE may use long DRX cycle when the short cycle timer (e.g., drx-ShortCycleTimer) is not running. The UE may use long DRX cycle when the short cycle timer (e.g., drx-ShortCycleTimer) is not configured. The UE may determine a DRX cycle based on formulas using the length/duration of DRX cycle (e.g., drx-ShortCycle, drx-LongCycle) and the start offset of DRX cycle (e.g., drx-StartOffset). The start of a DRX cycle may be a subframe determined by a pre-defined formula. The drx-LongCycleStartOffset may comprise the length of long cycle (e.g., drx-LongCycle) and the start offset of (long and/or short) DRX cycle (e.g., drx-StartOffset). The length of long DRX cycle (e.g., drx-LongCycle) and/or the start offset of (long and/or short) DRX cycle (e.g., drx-StartOffset) may be or may be comprised in drx-LongCycleStartOffset. Throughout the disclosure, the “DRX cycle” may comprise and/or be referred to “short DRX cycle” and/or “long DRX cycle”.

The DRX configuration(s) for inactivity time (e.g., for a DRX group) may be and/or may comprise the length/duration of inactivity time (e.g., drx-InactivityTimer). The length/duration of inactivity time (e.g., drx-InactivityTimer) may be (represent by and/or referred to) an inactivity timer. The UE may start or restart the inactivity timer (e.g., drx-InactivityTimer) when PDCCH indicates a new transmission. The UE may monitor PDCCH when the inactivity timer (e.g., drx-InactivityTimer) is running. The inactivity time may be the duration when the inactivity timer (e.g., drx-InactivityTimer) is running.

The DRX configuration(s) for retransmission time (e.g., for a DRX group) may be and/or may comprise the length/duration of round trip time (e.g., drx-HARQ-RTT-TimerDL, drx-HARQ-RTT-TimerUL) and/or the length/duration of retransmission time (e.g., drx-RetransmissionTimerDL, drx-RetransmissionTimerUL). HARQ=Hybrid Automatic Repeat Request; RTT=Round-Trip Time. The length/duration of round trip time (e.g., drx-HARQ-RTT-TimerDL, drx-HARQ-RTT-TimerUL) may be (represent by and/or referred to) a RTT timer. The length/duration of retransmission time (e.g., drx-RetransmissionTimerDL, drx-RetransmissionTimerUL) may be (represent by and/or referred to) a retransmission timer. The UE may start the RTT timer (e.g., drx-HARQ-RTT-TimerDL, drx-HARQ-RTT-TimerUL) when a transmission is indicated (or performed). The UE may start the retransmission timer (e.g., drx-RetransmissionTimerDL, drx-RetransmissionTimerUL) upon expiry of the RTT timer (e.g., drx-HARQ-RTT-TimerDL, drx-HARQ-RTT-TimerUL). The UE may monitor PDCCH when the retransmission timer (e.g., drx-RetransmissionTimerDL, drx-RetransmissionTimerUL) is running. The retransmission time may be the duration when the retransmission timer (e.g., drx-RetransmissionTimerDL, drx-RetransmissionTimerUL) is running.

Throughout the disclosure, the DRX configuration may be, may be referred and/or may comprise the above (DRX) configurations, (DRX) parameters and/or (DRX) timers, e.g., drx-SlotOffset, drx-onDurationTimer, drx-StartOffset, drx-LongCycle, drx-ShortCycle and/or drx-ShortCycleTimer, drx-InactivityTimer, drx-HARQ-RTT-TimerDL, drx-HARQ-RTT-TimerUL, drx-RetransmissionTimerDL, and/or drx-RetransmissionTimerUL. Throughout the disclosure, the DRX configuration may be and/or be referred to (a configuration of) a DRX group, e.g., DRX-Config, DRX-ConfigSecondaryGroup and/or an information element of DRX configuration.

Based on N_{R} MAC specification (e.g., [3] 3GPP TS 38.321 V17.0.0), the UE would monitor PDCCH discontinuously based on the DRX cycle and on duration time. The UE would enter on duration time for each DRX cycle. The UE would monitor PDCCH for a period of time regularly based on the DRX configurations for on duration time and DRX cycle. The UE may determine the subframe to start a DRX cycle based on a formula using the length of DRX cycle (e.g., drx-ShortCycle, drx-LongCycle) and the start offset of DRX cycle (e.g., drx-StartOffset). As shown in FIG. 6, for each DRX cycle (e.g., the first DRX cycle, the second DRX cycle), the UE may start an on duration timer (e.g., drx-onDurationTimer) after a start offset to on duration time (e.g., drx-SlotOffset). The UE may enter on duration time when the on duration timer (e.g., drx-onDurationTimer) is running. The UE would monitor PDCCH in the on duration time for each DRX cycle. The UE would not monitor PDCCH in the time duration other than on duration time for each DRX cycle.

Throughout the disclosure, the following may be interchangeable: modify, adjust, switch, reconfigure and/or change.

An indication (e.g., L1/L2 indication) may be used to change, reconfigure and/or (de)activate a DRX parameter. The indication may be transmitted from NW to UE. The UE may change, reconfigure and/or (de)activate a DRX parameter in response to receive the indication. The UE could be (pre-)configured with multiple DRX configurations (e.g., for the DRX parameter) by a RRC message. When the UE receives the (L1/L2) indication, it has not been clear how the UE determines the DRX parameter in which DRX group to be modified, reconfigured or (de-)activated.

Moreover, it is possible that the DRX timer(s) associated with the DRX parameter is running when the UE receives the (L1/L2) indication for a DRX parameter. As shown in FIG. 16, the UE may receive an (L1/L2) indication to change an offset (e.g. drx-StartOffset or drx-SlotOffset) to delay the on duration, e.g., due to jitter (−4˜+4 ms) of XR traffic. In response to receiving the (L1/L2) indication, it has not been clear how to handle the running drx-onDurationTimer should be defined.

To solve the issue, the UE could receive a first indication to modify/adjust/reconfigure the DRX configuration(s) (e.g., for specific/indicated DRX group). The first indication is not a RRC message, e.g., RRC reconfiguration message (e.g., RRCReconfiguration). The first indication may be a L1 and/or L2 signaling/indication (e.g., Downlink Control Information (DCI), MAC CE). The UE may receive one or multiple DRX configuration(s) in a RRC message (e.g., RRCSetup, RRCResume, or RRCReconfiguration). The first indication may indicate a pre-configured DRX configuration or a value of the DRX parameter.

The first indication may be applied to one or more DRX groups. The first indication may indicate which DRX group(s) (e.g., index of a DRX group) to apply. The UE may reconfigure and/or adjust one or more DRX configurations based on the first indication (e.g., for specific/indicated DRX group). The UE may reconfigure and/or adjust some DRX configuration(s) (e.g., a first DRX configuration) but not reconfigure and/or adjust some other DRX configuration(s) (e.g., a second DRX configuration). The DRX configurations (e.g., the first DRX configuration, the second DRX configuration) may be (or include) drx-SlotOffset, drx-onDurationTimer, drx-StartOffset, drx-ShortCycle, drx-LongCycle and/or drx-ShortCycleTimer. In response to receiving the first indication, the UE may reconfigure and/or adjust the on duration and/or DRX cycle (e.g., for specific/indicated DRX group). In response to receiving the first indication, the UE may reconfigure and/or adjust the value of parameters related to on duration and/or DRX cycle (e.g., for specific/indicated DRX group). In response to receiving the first indication, the UE may reconfigure and/or adjust the start offset to on duration (e.g., drx-SlotOffset), the length of on duration (e.g., drx-onDurationTimer), the length of DRX cycle (e.g., drx-ShortCycle, drx-LongCycle (of drx-LongCycleStartOffset)), the start offset of DRX cycle (e.g., drx-StartOffset (of drx-LongCycleStartOffset)), and/or the time duration to use short DRX cycle (e.g., drx-ShortCycleTimer).

The first indication may not be allowed/used to modify/adjust/reconfigure the inactivity timer(s) (e.g., drx-InactivityTimer), the retransmission timer(s) (e.g., drx-RetransmissionTimerDL and/or drx-RetransmissionTimerUL), and/or the RTT timer(s) (e.g., drx-HARQ-RTT-TimerDL, drx-HARQ-RTT-TimerUL).

The UE could use the reconfigured/adjusted value of the DRX configuration, e.g., based on the first indication, until the DRX configuration is released and/or reconfigured/adjusted.

The UE may receive a first value for a DRX configuration in the RRC message (e.g., RRCSetup, RRCResume, RRCReconfiguration). The UE may receive a second value for the DRX configuration in the first indication, e.g., after receiving the first value for the DRX configuration. The first indication may comprise and/or indicate value(s) of one or more DRX configurations. The UE may use the received/indicated value as a DRX configuration. The UE may replace the value of a DRX configuration with the received/indicated value.

For example, the UE may receive a first value for a DRX configuration in a RRC message (e.g., RRCSetup, RRCResume, RRCReconfiguration). The UE may receive a second value for the DRX configuration in the first indication. In response to receiving the first indication, the UE may reconfigure the DRX configuration with the second value. The UE may replace the first value with the second value for the DRX configuration. The DRX configuration may be and/or be referred to drx-SlotOffset, drx-onDurationTimer, drx-StartOffset, drx-ShortCycle, drx-LongCycle and/or drx-ShortCycleTimer.

For example, the UE may receive a first value for a first DRX configuration and a second value for a second DRX configuration in a RRC message (e.g., RRCSetup, RRCResume, RRCReconfiguration). The UE may receive a third value for the first DRX configuration and a fourth value for the second DRX configuration in the first indication. In response to receiving the first indication, the UE may reconfigure the first DRX configuration with the third value and reconfigure the second DRX configuration with the fourth value. The UE may replace the first value with the third value for the first DRX configuration, and replace the second value with the fourth value for the second DRX configuration. The first DRX configuration may be and/or be referred to drx-SlotOffset, drx-onDurationTimer, drx-StartOffset, drx-ShortCycle, drx-LongCycle and/or drx-ShortCycleTimer. The second DRX configuration may be and/or be referred to drx-SlotOffset, drx-onDurationTimer, drx-StartOffset, drx-ShortCycle, drx-LongCycle, drx-ShortCycleTimer. The first DRX configuration and the second DRX configuration may be different.

The UE may receive a first value for a DRX configuration in the RRC message (e.g., RRCSetup, RRCResume, RRCReconfiguration). The UE may receive an offset (e.g., a relative value) and/or a scale for the DRX configuration in the first indication, e.g., after receiving the first value for the DRX configuration. The first indication may comprise and/or indicate relative value(s) (e.g., offset(s) and/or scale(s)) to apply to one or more DRX configurations. The UE may apply the relative value (e.g., offset) and/or scale to a DRX configuration. The UE may add the relative value (e.g., offset) to the first value of the DRX configuration. The UE may multiply the first value of the DRX configuration by the scale.

For example, the UE may receive a first value for a DRX configuration in a RRC message (e.g., RRCSetup, RRCResume, RRCReconfiguration). The UE may receive an offset for the DRX configuration in the first indication. In response to receiving the first indication, the UE may add the offset to the first value for the DRX configuration. The UE may reconfigure the DRX configuration with the first value plus the offset. The UE may replace the first value with the first value plus the offset for the DRX configuration. The UE may receive a scale for the DRX configuration in the first indication. In response to receiving the first indication, the UE may multiply the first value by the scale for the DRX configuration. The UE may reconfigure the DRX configuration with the first value multiplied by the scale. The UE may replace the first value with the first value multiplied by the scale for the DRX configuration. The DRX configuration may be and/or be referred to drx-SlotOffset, drx-onDurationTimer, drx-StartOffset, drx-ShortCycle, drx-LongCycle and/or drx-ShortCycleTimer.

For example, the UE may receive a first value for a first DRX configuration and a second value for a second DRX configuration in a RRC message (e.g., RRCSetup, RRCResume, RRCReconfiguration). The UE may receive a first offset and a second offset in the first indication. In response to receiving the first indication, the UE may add the first offset to the first value for the first DRX configuration, and add the second offset to the second value for the second RRC configuration. The UE may reconfigure the first DRX configuration with the first value plus the first offset, and reconfigure the second DRX configuration with the second value plus the second offset. The UE may replace the first value with the first value plus the first offset for the first DRX configuration, and replace the second value with the second value plus the second offset for the second DRX configuration. The UE may receive a first scale and a second scale in the first indication. In response to receiving the first indication, the UE may multiply the first value by the first scale for the first DRX configuration, and multiply the second value by the second scale for the second DRX configuration. The UE may reconfigure the first DRX configuration with the first value multiplied by the first scale, and reconfigure the second DRX configuration with the second value multiplied by the second scale. The UE may replace the first value with the first value multiplied by the first scale for the first DRX configuration, and replace the second value with the second value multiplied by the second scale for the second DRX configuration. The UE may receive an offset and a scale in the first indication. In response to receiving the first indication, the UE may add the offset to the first value for the first DRX configuration, and multiply the second value by the scale for the second DRX configuration. The UE may reconfigure the first DRX configuration with the first value add the offset, and reconfigure the second DRX configuration with the second value multiplied by the scale. The UE may replace the first value with the first value add the offset for the first DRX configuration, and replace the second value with the second value multiplied by the second scale for the second DRX configuration. The first DRX configuration may be and/or be referred to drx-SlotOffset, drx-onDurationTimer, drx-StartOffset, drx-ShortCycle, drx-LongCycle and/or drx-ShortCycleTimer. The second DRX configuration may be and/or be referred to drx-SlotOffset, drx-onDurationTimer, drx-StartOffset, drx-ShortCycle, drx-LongCycle and/or drx-ShortCycleTimer. The first DRX configuration and the second DRX configuration may be different.

To solve the issue, the UE could receive a second indication to (dynamically/temporarily) modify/shift/adjust DRX configuration(s). The second indication is not a RRC message, e.g., RRC reconfiguration message (e.g., RRCReconfiguration). The second indication may be a L1 and/or L2 signaling/indication (e.g., DCI, MAC CE). The UE may receive DRX configurations in a RRC message (e.g., RRCSetup, RRCResume, RRCReconfiguration). The UE may shift/adjust one or more DRX configurations, e.g., indicated by the second indication. In response to receiving the second indication, the UE may apply the information indicated/comprised by the second indication to a DRX configuration. In response to receiving the second indication, the UE may shift/adjust (part of) on duration and/or DRX cycle (based on the information indicated/comprised by the second indication). In response to receiving the second indication, the UE may shift/adjust the value of parameters related to on duration and/or DRX cycle (based on the information indicated/comprised by the second indication). In response to receiving the second indication, the UE may shift/adjust the start offset to on duration (e.g., drx-SlotOffset), the length of on duration (e.g., drx-onDurationTimer), the start offset of DRX cycle (e.g., drx-StartOffset), the length of DRX cycle (e.g., drx-ShortCycle, drx-LongCycle) and/or the time duration to use short DRX cycle (e.g., drx-ShortCycleTimer) (based on the information indicated/comprised by the second indication).

The second indication may not be allowed/used to modify/shift/adjust the inactivity timer(s) (e.g., drx-InactivityTimer), the retransmission timer(s) (e.g., drx-RetransmissionTimerDL and/or drx-RetransmissionTimerUL), and/or the RTT timer(s) (e.g., drx-HARQ-RTT-TimerDL, drx-HARQ-RTT-TimerUL).

The second indication may indicate an offset (e.g., a relative value) and/or a scale to (temporarily) apply. The second indication may indicate one or more offsets/scales and/or an indication to a (set of) pre-configured offset/scale. The second indication may indicate a value to use as the value of a DRX configuration (e.g., to (temporarily) replace the value of a DRX configuration). The second indication may indicate the UE to suspend and/or resume a timer, e.g., drx-onDurationTimer. The second indication may indicate which DRX configuration(s) and/or DRX group(s) (e.g., index of a DRX group) to (temporarily) apply the second indication (e.g., a DRX group number, a DRX configuration, a DRX parameter).

The second indication may indicate the time duration to apply the second indication (e.g., an amount of DRX cycles/on durations, a timer, a specific time/occasion). The second indication may be applied/used (several times) during the time duration (e.g., for on duration(s) and/or DRX cycle(s) in the time duration). The second indication may not be applied/used not during the time duration. (Each of) The second indication may be applied/used (just) once (e.g., for a single/specific on duration and/or DRX cycle). The second indication may indicate the time delay to apply the second indication (e.g., an amount of DRX cycles/on durations, a timer, a specific time/occasion). Alternatively, the time duration and/or the time delay could be configured by the network before receiving the second indication, e.g., via the RRC message (for configuring the DRX configuration(s)).

The value of the DRX configuration before receiving the second indication to adjust the DRX configuration could be resumed/used after applicable time of the second indication, e.g., after the time duration or after the single/specific on duration and/or DRX cycle.

The second indication may comprise and/or indicate (at least one of) below information (for one or more DRX configurations):
offset(s);
scale(s);
(absolute) value(s) to DRX configuration(s);
indication(s) to pre-configured configuration(s) (e.g., offset, scale, value to DRX configuration, timer value and/or time duration);
indication(s) to suspend and/or resume DRX timer(s);
indication(s) to DRX configuration(s) and/or DRX group(s); and/or
applicable time duration of the second indication (e.g., a period of time to apply the information indicated in the second indication), e.g.:
   an amount of DRX cycle(s), on duration(s), DL transmission(s) and/or PDCCH occasion(s);
   a value of a timer;
   an indicated/specific PDCCH occasion(s); and/or
   a time delay/duration (e.g., in milliseconds).

The second indication may comprise/indicate an offset (as a relative value to a DRX configuration). The UE may add the offset to a DRX configuration. The UE may use the modified DRX configuration for a period of time. The second indication may comprise/indicate several offsets (e.g., a list of offsets). The UE may add the offsets to a DRX configuration sequentially and use the modified DRX configuration for a period of time. The offset may be a value of milliseconds, slots and/or integers. The offset may be larger than zero or smaller than zero.

The second indication may comprise/indicate a scale. The UE may multiply (value of) a DRX configuration by the scale. The UE may use the modified DRX configuration for a period of time. The second indication may comprise/indicate several scales (e.g., a list/set of scales). The UE may multiply (value of) a DRX configuration by the scale sequentially and use the modified DRX configuration for a period of time. The scale may be an integer. The scale may be a value smaller than one (e.g., between zero to one), larger than one (e.g., between one to two) or zero.

The second indication may comprise/indicate a value to a DRX configuration (e.g., an absolute value to the DRX configuration). The UE may apply/use the value as (the value of) a DRX configuration. The UE may use the modified DRX configuration for a period of time. The second indication may comprise/indicate several values (e.g., a list/set of values). The UE may use the values as (the value of) a DRX configuration sequentially and use the modified DRX configuration for a period of time.

The second indication may indicate one or more offsets, scales and/or values from a pre-configured configuration. The second indication may indicate a set of offsets, scale and/or value from a pre-configured configuration. The UE may add the offset(s) to a DRX configuration (sequentially) and/or multiply (value of) a DRX configuration by the scale(s) (sequentially). The UE may use the values as a DRX configuration (sequentially). The UE may use the modified DRX configuration for a period of time. The second indication may comprise a number of a (set of) pre-configured configurations. The pre-configured configuration may be a list of offset(s), scale(s) and/or value(s) of DRX configuration.

The second indication may comprise/indicate an indication to suspend (e.g., deactivate) and/or resume (e.g., activate) a DRX timer (e.g., drx-onDurationTimer). The UE may suspend and/or stop the DRX timer (e.g., drx-onDurationTimer) in response to receiving the second indication (e.g., if the DRX timer is not suspended). The UE may resume and/or start the DRX timer (e.g., drx-onDurationTimer) in response to receiving the second indication (e.g., if the DRX timer is suspended). The UE may suspend and/or stop the DRX timer (e.g., drx-onDurationTimer) in response to receiving the second indication, if the second indication indicates suspend/deactivation (of the DRX timer). The UE may resume and/or start the DRX timer (e.g., drx-onDurationTimer) in response to receiving the second indication, if the second indication indicates resume/activation (of the DRX timer). If a DRX timer (e.g., drx-onDurationTimer) is suspended and/or is not resumed, the UE may stop the DRX timer (e.g., drx-onDurationTimer), may consider the DRX timer (e.g., drx-onDurationTimer) is not running, and/or may not start the DRX timer (e.g., drx-onDurationTimer) for DRX cycle(s). If a DRX timer (e.g., drx-onDurationTimer) is resumed and/or is not suspended, the UE may start the DRX timer (e.g., drx-onDurationTimer) for DRX cycle(s).

The second indication may comprise/indicate a DRX configuration (e.g., for DRX cycle and/or on duration). The UE may apply (the information of) the second indication to the indicated DRX configuration.

The second indication may comprise/indicate a DRX configuration (e.g., for a DRX group) and/or a DRX group (number). The UE may apply (the information of) the second indication to the indicated DRX group(s). The UE may apply (the information of) the second indication to a first DRX group. The UE may apply (the information of) the second indication to a second DRX group. The UE may not apply (the information of) the second indication to a first DRX group. The UE may not apply (the information of) the second indication to a second DRX group. The UE may apply (the information of) the second indication to a first DRX group and a second DRX group.

The second indication may comprise/indicate a value as an amount of DRX cycle(s), on duration(s), DL transmission(s) and/or PDCCH occasion(s). The UE may apply/use (the information of) the second indication to the amount of DRX cycle(s), on duration(s), DL transmission(s) and/or PDCCH occasion(s). The UE may continue applying/using (the information of) the second indication until the amount of DRX cycle(s), on duration(s), DL transmission(s) and/or PDCCH occasion(s). The UE may apply/use (the information of) the second indication to the following DRX cycle(s), on duration(s), DL transmission(s) and/or PDCCH occasion(s) indicated by the second indication. The UE may increase a counter for each DRX cycle, on duration, PDCCH occasion and/or DL reception after receiving/applying the second indication. The UE may apply/use (the information of) the second indication when the counter is smaller and/or is not larger than the indicated value. The amount of DRX cycle(s), on duration(s), DL transmission(s) and/or PDCCH occasion(s) may be the period of time for the UE to use the modified DRX configuration.

The second indication may comprise/indicate (the duration/length of) a timer value. The second indication may indicate one or more timer values from a pre-configured configuration. The second indication may indicate a set of timer values from a pre-configured configuration. The UE may start a timer set to the timer value in response to receiving the second indication. The UE may start the timer in response to applying the (the information of) the second indication. The UE may start the timer at a specific timing indicated by the second indication. The UE may apply/use (the information of) the second indication when the timer is running. The duration of the timer may be the period of time for the UE to use the modified DRX configuration. The UE may apply/use (the information of) the second indication after/upon the timer expires. The duration of the timer may be the time delay for the UE to use the modified DRX configuration.

The second indication may comprise/indicate a PDCCH occasion. The UE may apply/use (the information of) the second indication until the PDCCH occasion. The PDCCH occasion may indicate the period of time for the UE to use the modified DRX configuration. The UE may apply/use (the information of) the second indication start from (or after) the PDCCH occasion. The PDCCH occasion may indicate the time delay for the UE to use the modified DRX configuration.

The second indication may comprise/indicate a time duration (e.g., in milliseconds). The second indication may indicate one or more time durations from a pre-configured configuration. The second indication may indicate a set of time durations from a pre-configured configuration. The UE may apply/use (the information of) the second indication the time duration. The UE may apply/use (the information of) the second indication in the duration from receiving the second indication to the time duration. The UE may apply/use (the information of) the second indication in the duration from applying (the information of) the second indication to the time duration. The UE may apply/use (the information of) the second indication in the duration from a specific timing indicated by the second indication to the time duration. The time duration may be the period of time for the UE to use the modified DRX configuration. The UE may apply/use (the information of) the second indication start from (or after) the duration. The time duration may be the time delay for the UE to use the modified DRX configuration.

The second indication may comprise and/or indicate one or more of above information. The specific timing, the period of time and/or the time delay for the UE to use the modified DRX configuration may be indicated by one or more of above information. The UE may use the modified DRX configuration for the period of time. The UE may not use the modified DRX configuration after the period of time. The UE may not use the modified DRX configuration before the period of time. After the period of time, the UE may use/resume the previous (value of) DRX configuration (e.g., the DRX configuration (value) received in the RRC message, the DRX configuration (value) before receiving/applying the second indication).

For example, the UE may receive a second indication with an offset and/or a scale for the start offset to on duration (e.g., drx-SlotOffset). The UE may add the offset to the start offset to on duration (e.g., drx-SlotOffset). The UE may multiply the start offset to on duration (e.g., drx-SlotOffset) by the scale. The UE may use the modified start offset to on duration (e.g., drx-SlotOffset) for the next on duration time and/or DRX cycle (e.g., after the UE receives the second indication). The UE may use the modified start offset to on duration (e.g., drx-SlotOffset) for the next on duration times and/or DRX cycles (e.g., after the UE receives the second indication), if the second indication indicates the time duration to apply the offset/scale.

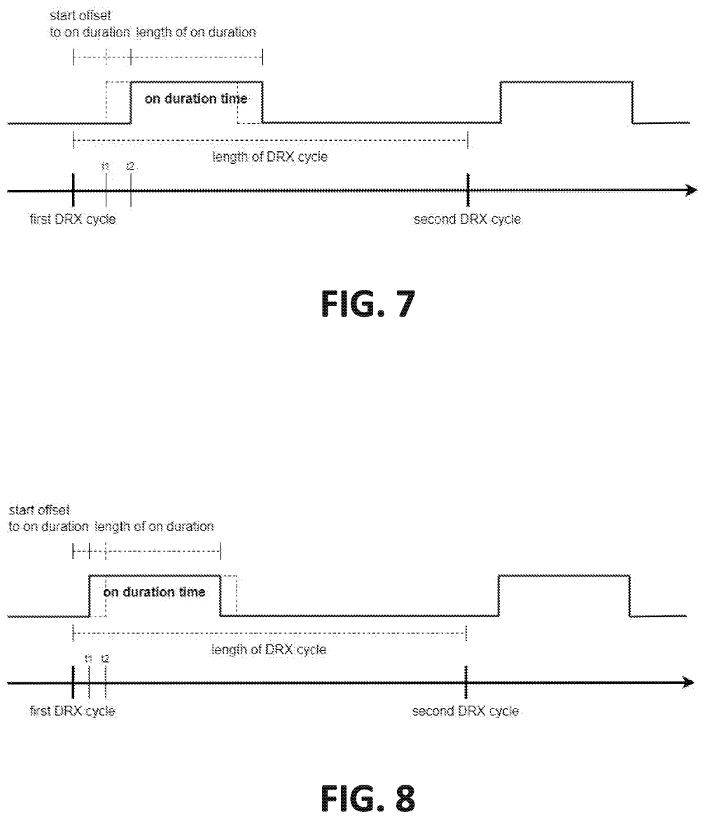

In one example, the offset may be larger than zero and/or the scale may be larger than one. As shown in FIG. 7, the UE may extend the start offset to on duration (e.g., drx-SlotOffset). The start timing of an on duration timer (e.g., drx-onDurationTimer) would shift from t1 to t2. The UE may receive the second indication before the first DRX cycle. The UE may use the modified start offset to on duration (e.g., drx-SlotOffset) for the on duration time of the first DRX cycle. The UE may use the modified start offset to on duration (e.g., drx-SlotOffset) for the on duration time of the first DRX cycle and the second DRX cycle, if the second indication indicates two DRX cycles to apply the offset and/or scale.

In one example, the offset may be smaller than zero and/or the scale may be smaller than one. As shown in FIG. 8, the UE may shrink the start offset to on duration (e.g., drx-SlotOffset). The start timing of an on duration timer (e.g., drx-onDurationTimer) would shift from t2 to t1. The UE may receive the second indication before the first DRX cycle. The UE may use the modified start offset to on duration (e.g., drx-SlotOffset) for the on duration time of the first DRX cycle. The UE may use the modified start offset to on duration (e.g., drx-SlotOffset) for the on duration time of the first DRX cycle and the second DRX cycle, if the second indication indicates two on durations to apply the offset and/or scale.

For example, the UE may receive a second indication with an offset and/or a scale for the length of on duration (e.g., drx-onDurationTimer). The UE may add the offset to the length of on duration (e.g., drx-onDurationTimer). The UE may multiply the length of on duration (e.g., drx-onDurationTimer) by the scale. The UE may use the modified length of on duration (e.g., drx-onDurationTimer) for the current on duration time and/or DRX cycle (e.g., when the UE receives the second indication). The UE may use the modified length of on duration (e.g., drx-onDurationTimer) for the next on duration time and/or DRX cycle (e.g., after the UE receives the second indication). The UE may use the modified length of on duration (e.g., drx-onDurationTimer) for the next on duration times and/or DRX cycles (e.g., after the UE receives the second indication), if the second indication indicates the time duration to apply the offset/scale.

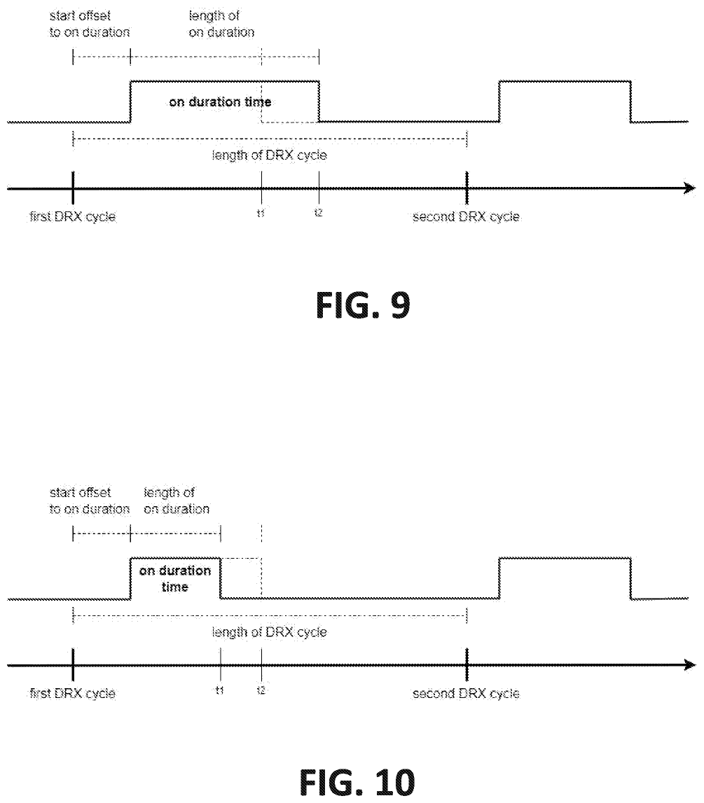

In one example, the offset may be larger than zero and/or the scale may be larger than one. As shown in FIG. 9, the UE may extend the length of on duration and/or the on duration time (e.g., drx-onDurationTimer). The end timing of the on duration timer (e.g., drx-onDurationTimer) would shift from t1 to t2. The UE may receive the second indication before the first DRX cycle and/or during the first DRX cycle. The UE may use the modified length of on duration and/or the on duration time (e.g., drx-onDurationTimer) for the on duration time of the first DRX cycle. The UE may use the modified length of on duration and/or the on duration time (e.g., drx-onDurationTimer) for the on duration time of the first DRX cycle and the second DRX cycle, if the second indication indicates a timer with a length of two DRX cycles.

In one example, the offset may be smaller than zero and/or the scale may be smaller than one. As shown in FIG. 10, the UE may shrink the length of on duration and/or the on duration time (e.g., drx-onDurationTimer). The end timing of the on duration timer (e.g., drx-onDurationTimer) would shift from t2 to t1. The UE may receive the second indication before the first DRX cycle and/or during the first DRX cycle. The UE may use the modified length of on duration and/or the on duration time (e.g., drx-onDurationTimer) for the on duration time of the first DRX cycle. The UE may use the modified length of on duration and/or the on duration time (e.g., drx-onDurationTimer) for the on duration time of the first DRX cycle and the second DRX cycle, if the second indication indicates a PDCCH occasion after the start of the second DRX cycle.

For example, the UE may receive a second indication with an offset and/or a scale for the length of DRX cycle (e.g., drx-ShortCycle, drx-LongCycle). The UE may add the offset to the length of DRX cycle (e.g., drx-ShortCycle, drx-LongCycle). The UE may multiply the length of DRX cycle (e.g., drx-ShortCycle, drx-LongCycle) by the scale. The UE may use the modified length of DRX cycle (e.g., drx-ShortCycle, drx-LongCycle) for the current DRX cycle (e.g., when the UE receives the second indication). The UE may use the modified length of DRX cycle (e.g., drx-ShortCycle, drx-LongCycle) for the next DRX cycle (e.g., after the UE receives the second indication). The UE may use the modified length of DRX cycle (e.g., drx-ShortCycle, drx-LongCycle) for the next DRX cycles (e.g., after the UE receives the second indication), if the second indication indicates the time duration to apply the offset/scale.

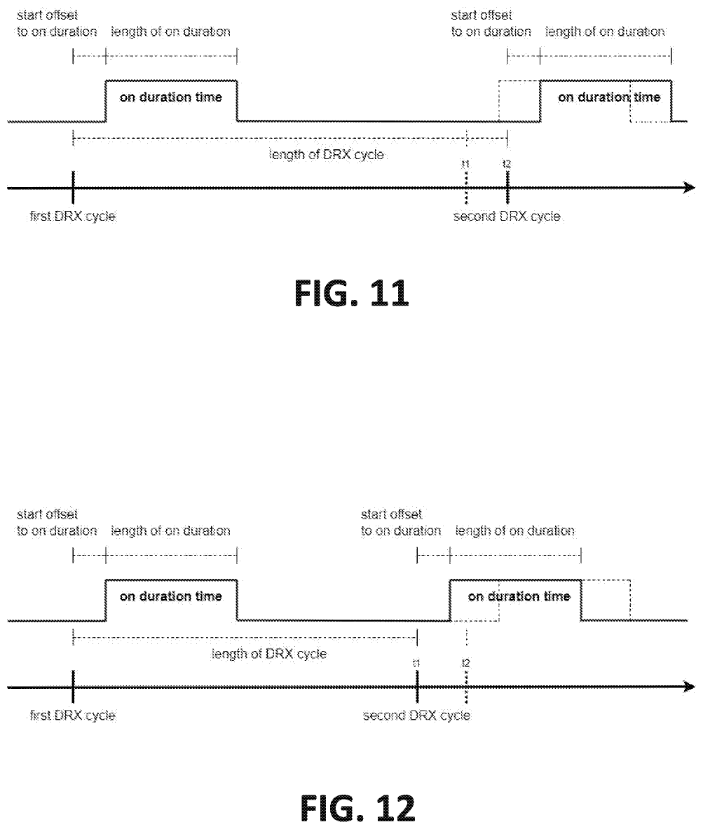

In one example, the offset may be larger than zero and/or the scale may be larger than one. As shown in FIG. 11, the UE may extend (the length of) the first DRX cycle (e.g., drx-ShortCycle, drx-LongCycle). The start timing of the second DRX cycle would shift from t1 to t2. The on duration time in the second DRX cycle would shift accordingly. The UE may receive the second indication before the first DRX cycle and/or during the first DRX cycle. The UE may use the modified (length of) DRX cycle (e.g., drx-ShortCycle, drx-LongCycle) for the first DRX cycle. The UE may use the modified (length of) DRX cycle (e.g., drx-ShortCycle, drx-LongCycle) for the first DRX cycle and the second DRX cycle, if the second indication indicates a PDCCH occasion after the end of the second DRX cycle.

In one example, the offset may be smaller than zero and/or the scale may be smaller than one. As shown in FIG. 12, the UE may shrink (the length of) the first DRX cycle (e.g., drx-ShortCycle, drx-LongCycle). The start timing of the second DRX cycle would shift from t2 to t1. The on duration time in the second DRX cycle would shift accordingly. The UE may receive the second indication before the first DRX cycle and/or during the first DRX cycle. The UE may use the modified (length of) DRX cycle (e.g., drx-ShortCycle, drx-LongCycle) for the first DRX cycle. The UE may use the modified (length of) DRX cycle (e.g., drx-ShortCycle, drx-LongCycle) for the first DRX cycle and the second DRX cycle, if the second indication indicates a time duration comprising the end of the second DRX cycle.

Combinations of the examples, embodiments, and concepts above and herein can be applied to, or possible for, the second indication.

The first/second indication may comprise/indicate and/or indicate the UE to shift/adjust value(s) of drx-SlotOffset, drx-onDurationTimer, drx-ShortCycle, drx-LongCycle, drx-LongCycleStartOffset, drx-StartOffset, drx-ShortCycleTimer, drx-HARQ-RTT-TimerDL, drx-HARQ-RTT-TimerUL, drx-RetransmissionTimerDL and/or drx-RetransmissionTimerUL. The first/second indication may not comprise/indicate and/or indicate the UE to shift/adjust value(s) of drx-SlotOffset, drx-onDurationTimer, drx-ShortCycle, drx-LongCycle, drx-LongCycleStartOffset, drx-StartOffset, drx-ShortCycleTimer, drx-HARQ-RTT-TimerDL, drx-HARQ-RTT-TimerUL, drx-RetransmissionTimerDL and/or drx-RetransmissionTimerUL.

In response to receiving the first indication and/or second indication, the UE may transmit a confirmation (e.g., acknowledgment (ACK) to NW). The confirmation may be an Uplink Control Information (UCI), MAC CE and/or UE Assistance Information (UAI).

The UE could monitor the first indication and/or the second indication during DRX Active Time of a DRX group associated with the first indication and/or the second indication. Alternatively, the UE could monitor the first indication and/or the second indication when a drx-onDurationTimer of a DRX group associated with the first indication and/or the second indication is running. The UE may not monitor the first indication and/or the second indication outside DRX Active Time of a DRX group associated with the first indication and/or the second indication. Alternatively, the UE may not monitor the first indication and/or the second indication when a drx-onDurationTimer of a DRX group associated with the first indication and/or the second indication is not running.

The UE may stop the on duration timer (e.g., drx-onDurationTimer) and/or the inactivity timer (e.g., drx-InactivityTimer) upon receiving the first indication and/or second indication. The UE may stop the on duration timer (e.g., drx-onDurationTimer) and/or the inactivity timer (e.g., drx-InactivityTimer) upon transmitting the confirmation for the first indication and/or second indication. The UE may stop the on duration timer (e.g., drx-onDurationTimer) and/or the inactivity timer (e.g., drx-InactivityTimer) upon applying the first indication and/or second indication. The UE may stop the on duration timer (e.g., drx-onDurationTimer) and/or the inactivity timer (e.g., drx-InactivityTimer) upon using the new and/or modified DRX configuration(s).

Association between DRX group and the first/second indication could be indicated by the first/second indication. The UE may determine a DRX group to apply the first/second indication based on the DRX group indicated by the first/second indication. Alternatively, association between DRX group and the first/second indication could be based on a serving cell on which the first/second indication is received. The UE may determine a DRX group to apply the first/second indication based on a serving cell where the first/second indication is received. The DRX group is the DRX group of the serving cell. Alternatively, association between DRX group and the first/second indication could be based on a time and/or frequency resource on which the first/second indication is received. Alternatively, association between DRX group and the first/second indication could be configured by network.

The UE may receive configurations related to DRX and/or DRX group. The UE may receive one or more DRX configurations for a DRX group (e.g., DRX-Config, DRX-ConfigSecondaryGroup). A DRX group may be a group of cells (e.g., one or more cells) that applies the same DRX configuration. The group of cells may belong to the same MAC entity. The DRX configuration for a DRX group (e.g., DRX-Config, DRX-ConfigSecondaryGroup) may comprises configuration for on duration, DRX cycle, inactivity time and/or retransmission time. The DRX configuration for a DRX group (e.g., DRX-Config, DRX-ConfigSecondaryGroup) may comprises (at least) drx-SlotOffset, drx-onDurationTimer, drx-ShortCycle, drx-LongCycle, drx-LongCycleStartOffset, drx-StartOffset, drx-ShortCycleTimer, drx-HARQ-RTT-TimerDL, drx-HARQ-RTT-TimerUL, drx-RetransmissionTimerDL and/or drx-RetransmissionTimerUL. The UE may receive pre-configured configuration(s) (for a DRX group) to adjust the DRX configuration(s). The pre-configuration may comprises (at least) one or more offsets, scales, values to DRX configuration(s), timer value and/or time duration. The UE may receive the DRX configurations and/or pre-configured configurations from a RRC message (e.g., RRCSetup, RRCResume, RRCReconfiguration) and/or the first/second indication.

The UE may receive the RRC message (e.g., RRCSetup, RRCResume, RRCReconfiguration) in RRC inactive mode, RRC idle mode and/or RRC connected mode. The UE may receive the RRC message (e.g., to configure DRX functionality) before the UE is configured with DRX functionality. The UE may receive the RRC message (e.g., to reconfigure DRX functionality) after the UE is configured with DRX functionality. The UE may receive the RRC message when the UE is in/during Active Time and/or on duration time. The UE may receive the RRC message when the UE is not in/during Active Time and/or on duration time.

The UE may receive the first indication and/or second indication in RRC connected mode. The UE may receive the first indication and/or second indication after the UE is configured with DRX functionality. The UE may receive the first indication and/or second indication when the UE is in/during Active Time and/or on duration time. The UE may receive the first indication and/or second indication when the UE is not in/during Active Time and/or on duration time.

Examples of the present invention are described below.

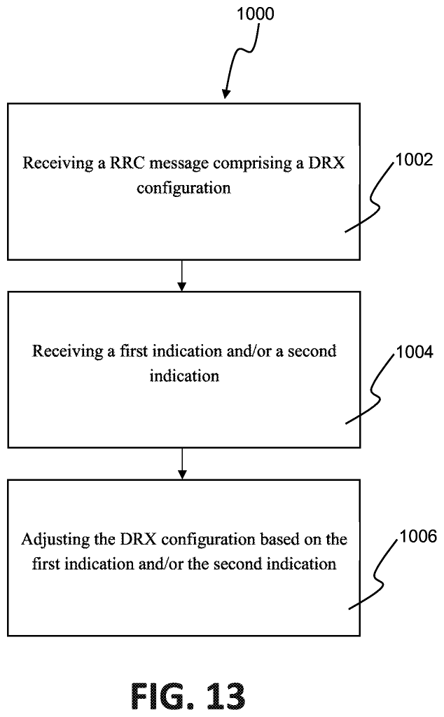

Referring to FIG. 13, with this and other concepts, systems, and methods of the present invention, a method 1000 for a UE in a wireless communication system comprises receiving a RRC message comprising a DRX configuration (step 1002), receiving a first indication and/or a second indication (step 1004), and adjusting the DRX configuration based on the first indication and/or the second indication (step 1006).

Referring back to FIGS. 3 and 4, in one or more embodiments from the perspective of a UE, the device 300 includes a program code 312 stored in memory 310 of the transmitter. The CPU 308 could execute program code 312 to: (i) receive a RRC message comprising a DRX configuration; (ii) receive a first indication and/or a second indication; and (iii) adjust the DRX configuration based on the first indication and/or the second indication. Moreover, the CPU 308 can execute the program code 312 to perform all of the described actions, steps, and methods described above, below, or otherwise herein.

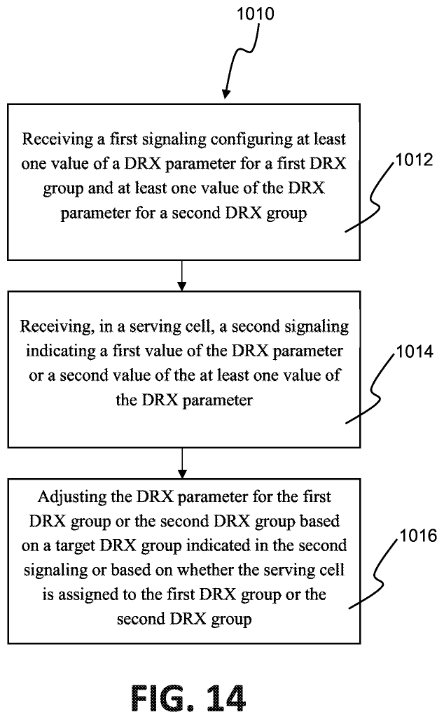

Referring to FIG. 14, with this and other concepts, systems, and methods of the present invention, a method 1010 for a UE in a wireless communication system comprises receiving a first signaling configuring at least one value of a DRX parameter for a first DRX group and at least one value of the DRX parameter for a second DRX group (step 1012), receiving, in a serving cell, a second signaling indicating a first value of the DRX parameter or a second value of the at least one value of the DRX parameter (step 1014), and adjusting the DRX parameter for the first DRX group or the second DRX group based on a target DRX group indicated in the second signaling or based on whether the serving cell is assigned to the first DRX group or the second DRX group (step 1016).

In various embodiments, the DRX parameter is drx-SlotOffset, drx-onDurationTimer, drx-StartOffset, drx-InactivityTimer, drx-ShortCycle, drx-LongCycle, and/or drx-ShortCycleTimer.

In various embodiments, the first signaling is a RRC message.

In various embodiments, the second signaling is a DCI or a MAC CE.

In various embodiments, the target DRX group is indicated in the second signaling.

In various embodiments, the UE adjusts the DRX parameter for the first DRX group if the target DRX group is the first DRX group and/or the UE adjusts the DRX parameter for the second DRX group if the target DRX group is the second DRX group.

In various embodiments, the UE adjusts the DRX parameter for the first DRX group if the serving cell is assigned to the first DRX group and/or the UE adjusts the DRX parameter for the second DRX group if the serving cell is assigned to the second DRX group.

In various embodiments, the UE adjusts the DRX parameter by applying the first value or the second value to the DRX parameter.

In various embodiments, the UE adjusts the DRX parameter by activating or deactivating the DRX parameter with the first value or the second value.

In various embodiments, whether the serving cell is assigned to the first DRX group or the second DRX group is indicated in the first signaling.

In various embodiments, the first DRX group and the second DRX group are associated with a same MAC entity.

Referring back to FIGS. 3 and 4, in one or more embodiments from the perspective of a UE, the device 300 includes a program code 312 stored in memory 310 of the transmitter. The CPU 308 could execute program code 312 to: (i) receive a first signaling configuring at least one value of a DRX parameter for a first DRX group and at least one value of the DRX parameter for a second DRX group; (ii) receive, in a serving cell, a second signaling indicating a first value of the DRX parameter or a second value of the at least one value of the DRX parameter; and (iii) adjust the DRX parameter for the first DRX group or the second DRX group based on a target DRX group indicated in the second signaling or based on whether the serving cell is assigned to the first DRX group or the second DRX group. Moreover, the CPU 308 can execute the program code 312 to perform all of the described actions, steps, and methods described above, below, or otherwise herein.

To solve the issue, the UE could receive multiple (sets of) DRX configurations, e.g., related to different (types of) on duration times and/or DRX cycles. The UE could be (pre-)configured with more than one (sets of) DRX configurations (e.g., for different on duration times and/or DRX cycles). The multiple (sets of) DRX configurations and/or the more than one (sets of) DRX configurations may comprise default (set of) DRX configuration and/or additional (set of) DRX configuration. The UE may be configured with one default (set of) DRX configuration. The UE may be configured with one or more than one additional (sets of) DRX configuration. The default (set of) DRX configuration may be used by the UE when the UE is not configured with additional (set of) DRX configuration. The additional (set of) DRX configuration may be used by the UE concurrently with the default (set of) DRX configuration. The additional (set of) DRX configuration may be the DRX configuration different from the default (set of) DRX configuration. The default (set of) DRX configuration and/or the additional (set of) DRX configuration may comprise drx-SlotOffset, drx-onDurationTimer, drx-StartOffset, drx-LongCycle, drx-ShortCycle and/or drx-ShortCycleTimer.

The default (set of) DRX configuration could include at least one parameter which is not included in the additional (set of) DRX configuration. The at least one parameter could include drx-InactivityTimer, drx-HARQ-RTT-TimerDL, drx-HARQ-RTT-TimerUL, drx-RetransmissionTimerDL, and/or drx-RetransmissionTimerUL.

For example, in DRX operation, the UE uses a first parameter, e.g., drx-StartOffset, in the additional (set of) DRX configuration and a second parameter, e.g., drx-HARQ-RTT-TimerDL, in the default (set of) DRX configuration. The UE may also or may not use the first parameter in the default (set of) DRX configuration for the DRX operation.

The UE may receive and/or be (pre-)configured with multiple (sets of) DRX parameters/configurations in (or associated with) one DRX group and/or one information element of DRX configuration (e.g., DRX-Config). The UE may receive the DRX parameters/configurations in a RRC message (e.g., RRCSetup, RRCResume, RRCReconfiguration).

The UE may receive and/or be (pre-)configured with a list of DRX parameters/configurations in (or associated with) a DRX group and/or an information element of DRX configuration (e.g., DRX-Config). The UE may receive and/or be (pre-)configured with a list of a first DRX parameters/configurations. The UE may receive and/or be (pre-)configured with a list of a second DRX parameters/configurations. The UE may receive and/or be (pre-)configured with a list of a third DRX parameters/configurations. The first, second and/or third DRX parameters/configurations may be individually configured in the DRX group and/or an information element of DRX configuration (e.g., DRX-Config). The first, second and/or third DRX parameters/configurations may be drx-SlotOffset, drx-onDurationTimer, drx-StartOffset, drx-LongCycle, drx-ShortCycle and/or drx-ShortCycleTimer. The first, second and third DRX parameters/configurations may be different DRX parameters/configurations.

For example, the UE may be configured with a drx-SlotOffset and/or a list of drx-SlotOffset in a DRX group and/or an information element (of DRX configuration) (e.g., DRX-Config). The UE may be configured with a drx-onDurationTimer and/or a list of drx-onDurationTimer in the DRX group and/or the information element (of DRX configuration) (e.g., DRX-Config). The UE may be configured with a drx-StartOffset and/or a list of drx-StartOffset in the DRX group and/or the information element (of DRX configuration) (e.g., DRX-Config). The UE may be configured with a drx-LongCycle and/or a list of drx-LongCycle in the DRX group and/or the information element (of DRX configuration) (e.g., DRX-Config). The UE may be configured with a drx-LongCycleStartOffset and/or a list of drx-LongCycleStartOffset in the DRX group and/or the information element (of DRX configuration) (e.g., DRX-Config). The UE may be configured with a drx-ShortCycle and/or a list of drx-ShortCycle in the DRX group and/or the information element (of DRX configuration) (e.g., DRX-Config). The UE may be configured with a drx-ShortCycleTimer and/or a list of drx-ShortCycleTimer in the DRX group and/or the information element (of DRX configuration) (e.g., DRX-Config).

The UE may receive and/or be (pre-)configured with a list of combinations of DRX parameters/configurations in (or associated with) a DRX group and/or an information element of DRX configuration (e.g., DRX-Config). The UE may receive and/or be (pre-)configured with a list of first set of DRX parameters/configurations. The UE may receive and/or be (pre-)configured with a list of second set of DRX parameters/configurations. The first set of DRX parameters/configurations and/or second set of DRX parameters/configurations may comprise drx-SlotOffset, drx-onDurationTimer, drx-StartOffset, drx-LongCycle, drx-ShortCycle and/or drx-ShortCycleTimer. The set of DRX parameters/configurations may referred to or may be a combination of DRX parameters/configurations. The DRX configurations may be configured in a combination in the DRX group and/or the information element of DRX configuration (e.g., DRX-Config).

For example, the UE may be configured with a drx-SlotOffset, drx-onDurationTimer, drx-StartOffset, drx-LongCycle, drx-ShortCycle and/or drx-ShortCycleTimer in a DRX group and/or in an information element (of DRX configuration) (e.g., DRX-Config). The UE may be configured with a list of sets of DRX configuration(s) related to on duration and/or DRX cycle in the DRX group and/or information element (of DRX configuration) (e.g., DRX-Config). The UE may be configured with a list of sets of drx-SlotOffset and drx-onDurationTimer in the DRX group and/or information element (of DRX configuration) (e.g., DRX-Config). The UE may be configured with a list of sets of drx-StartOffset, drx-LongCycle and/or drx-ShortCycle in the DRX group and/or information element (of DRX configuration) (e.g., DRX-Config). The UE may be configured with a list of sets of drx-ShortCycle and drx-ShortCycleTimer in the DRX group and/or information element (of DRX configuration) (e.g., DRX-Config). The UE may be configured with a list of sets of drx-onDurationTimer, drx-LongCycle and/or drx-ShortCycle in the DRX group and/or information element (of DRX configuration) (e.g., DRX-Config).

The UE may be configured with single drx-InactivityTimer (e.g., not a list) in the DRX group and/or the information element (of DRX configuration) (e.g., DRX-Config). The UE may be configured with single drx-HARQ-RTT-TimerDL (e.g., not a list) in the DRX group and/or the information element (of DRX configuration) (e.g., DRX-Config). The UE may be configured with single drx-HARQ-RTT-TimerUL (e.g., not a list) in the DRX group and/or the information element (of DRX configuration) (e.g., DRX-Config). The UE may be configured with single drx-RetransmissionTimerDL (e.g., not a list) in the DRX group and/or the information element (of DRX configuration) (e.g., DRX-Config). The UE may be configured with single drx-RetransmissionTimerUL (e.g., not a list) in the DRX group and/or the information element (of DRX configuration) (e.g., DRX-Config).

The UE may receive and/or be (pre-)configured with different DRX parameters/configurations in multiple DRX groups and/or information elements of DRX configuration. The DRX group and/or information element of DRX configuration may be DRX-Config, DRX-ConfigSecondaryGroup and/or a new information element (e.g., a third DRX group, an additional DRX group). The UE may receive the DRX configurations in a RRC message (e.g., RRCSetup, RRCResume, RRCReconfiguration).

The UE may receive and/or be (pre-)configured with multiple and/or a list of DRX groups and/or information elements (of DRX configuration). The DRX group may be and/or be referred to an information element (of DRX configuration) configured by the network. The UE may receive and/or be (pre-)configured with a first DRX group (e.g., DRX-Config). The UE may receive and/or be (pre-)configured with more than one first DRX groups (e.g., DRX-Config). The UE may receive and/or be (pre-)configured with a second DRX group (e.g., DRX-ConfigSecondaryGroup). The UE may receive and/or be (pre-)configured with more than one second DRX groups (e.g., DRX-ConfigSecondaryGroup). The UE may receive and/or be (pre-)configured with an additional DRX group (e.g., a third DRX group). The UE may receive and/or be (pre-)configured with more than one additional DRX groups (e.g., the third DRX groups). The additional DRX group may be a DRX group/configuration for XR.

The first DRX group (e.g., DRX-Config), second DRX group (e.g., DRX-ConfigSecondaryGroup) and/or additional DRX group (e.g., the third DRX group) may be used for the same serving cell, on the same Bandwidth Part (BWP) and/or in the same frequency range. A serving cell may be configured to the first DRX group (e.g., DRX-Config), the second DRX group (e.g., DRX-ConfigSecondaryGroup) and/or the additional DRX group (e.g., the third DRX group) at the same time. The serving cell may be Primary Cell (PCell), Primary Secondary Cell (PSCell) and/or Secondary Cell (SCell). The first DRX group (e.g., DRX-Config), second DRX group (e.g., DRX-ConfigSecondaryGroup) and/or additional DRX group (e.g., the third DRX group) may be used for different serving cells, on different BWPs and/or in different frequency ranges.

One or more of the first DRX groups (e.g., DRX-Config) may comprise DRX parameter(s)/configuration(s) related to on duration (e.g., drx-SlotOffset, drx-onDurationTimer) and/or DRX cycle (e.g., drx-StartOffset, drx-LongCycle, drx-ShortCycle, drx-ShortCycleTimer). The DRX parameter(s)/configuration(s) related to on duration (e.g., drx-SlotOffset, drx-onDurationTimer) and/or DRX cycle (e.g., drx-StartOffset, drx-LongCycle, drx-ShortCycle, drx-ShortCycleTimer) may be (configured as) optional in a first DRX group (e.g., DRX-Config).

One or more of the first DRX groups (e.g., DRX-Config) may not comprise DRX parameter(s)/configuration(s) related to inactivity time (e.g., drx-InactivityTimer) and/or retransmission time (e.g., drx-HARQ-RTT-TimerDL, drx-HARQ-RTT-TimerUL, drx-RetransmissionTimerDL, drx-RetransmissionTimerUL). The DRX parameter(s)/configuration(s) related to inactivity time (e.g., drx-InactivityTimer) and/or retransmission time (e.g., drx-HARQ-RTT-TimerDL, drx-HARQ-RTT-TimerUL, drx-RetransmissionTimerDL, drx-RetransmissionTimerUL) may be (configured as) optional in a first DRX group (e.g., DRX-Config).

One or more of the second DRX groups (e.g., DRX-ConfigSecondaryGroup) may comprise DRX parameter(s)/configuration(s) related to on duration (e.g., drx-SlotOffset, drx-onDurationTimer) and/or DRX cycle (e.g., drx-StartOffset, drx-LongCycle, drx-ShortCycle, drx-ShortCycleTimer). The DRX parameter(s)/configuration(s) related to on duration (e.g., drx-SlotOffset, drx-onDurationTimer) and/or DRX cycle (e.g., drx-StartOffset, drx-LongCycle, drx-ShortCycle, drx-ShortCycleTimer) may be (configured as) optional in a second DRX group (e.g., DRX-ConfigSecondaryGroup). The DRX parameter(s)/configuration(s) related to on duration (e.g., drx-SlotOffset, drx-onDurationTimer) and/or DRX cycle (e.g., drx-StartOffset, drx-LongCycle, drx-ShortCycle, drx-ShortCycleTimer) may be (configured as) mandatory in a second DRX group (e.g., DRX-ConfigSecondaryGroup).

One or more of the second DRX groups (e.g., DRX-ConfigSecondaryGroup) may not comprise DRX parameter(s)/configuration(s) related to inactivity time (e.g., drx-InactivityTimer) and/or retransmission time (e.g., drx-HARQ-RTT-TimerDL, drx-HARQ-RTT-TimerUL, drx-RetransmissionTimerDL, drx-RetransmissionTimerUL). The DRX parameter(s)/configuration(s) related to inactivity time (e.g., drx-InactivityTimer) may be (configured as) optional in a second DRX group (e.g., DRX-ConfigSecondaryGroup).

One or more of the additional DRX groups may comprise DRX parameter(s)/configuration(s) related to on duration (e.g., drx-SlotOffset, drx-onDurationTimer) and/or DRX cycle (e.g., drx-StartOffset, drx-LongCycle, drx-ShortCycle, drx-ShortCycleTimer). The DRX parameter(s)/configuration(s) related to on duration (e.g., drx-SlotOffset, drx-onDurationTimer) and/or DRX cycle (e.g., drx-StartOffset, drx-LongCycle, drx-ShortCycle, drx-ShortCycleTimer) may be (configured as) optional in an additional DRX group. The DRX parameter(s)/configuration(s) related to on duration (e.g., drx-SlotOffset, drx-onDurationTimer) and/or DRX cycle (e.g., drx-StartOffset, drx-LongCycle, drx-ShortCycle, drx-ShortCycleTimer) may be (configured as) mandatory in an additional DRX group.

One or more of the additional DRX groups may not comprise DRX parameter(s)/configuration(s) related to inactivity time (e.g., drx-InactivityTimer) and/or retransmission time (e.g., drx-HARQ-RTT-TimerDL, drx-HARQ-RTT-TimerUL, drx-RetransmissionTimerDL, drx-RetransmissionTimerUL). The DRX parameter(s)/configuration(s) related to inactivity time (e.g., drx-InactivityTimer) and/or retransmission time (e.g., drx-HARQ-RTT-TimerDL, drx-HARQ-RTT-TimerUL, drx-RetransmissionTimerDL, drx-RetransmissionTimerUL) may not be configured in an additional DRX group.

The multiple (sets of) DRX parameters/configurations (e.g., in one DRX group and/or one information element) and/or multiple DRX groups (e.g., information elements) may be applied to all serving cells of the corresponding MAC entity. The multiple (sets of) DRX parameters/configurations (e.g., in one DRX group and/or one information element) and/or multiple DRX groups (e.g., information elements) may be applied to specific serving cell(s). Plurality of the multiple (sets of) DRX parameters/configurations and/or plurality of the multiple DRX groups could be applied to a serving cell (simultaneously).

The specific serving cell(s) may be the serving cell(s) for XR service. The specific serving cell(s) may be configured and/or indicated in each (set of) DRX parameter/configuration (e.g., in one DRX group and/or one information element) and/or in each DRX group (e.g., information element). The specific serving cell(s) may be configured and/or indicated to associated with one or more (set of) DRX parameters/configurations (e.g., in one DRX group and/or one information element) and/or DRX group (e.g., information element). The serving cell may be PCell, PSCell and/or SCell. Different serving cells may be associated with different streams of a XR service or XR DL traffic with multiple streams. Different serving cells may be associated with different XR services.

Throughout the disclosure, different (sets of) DRX configurations and/or different DRX groups could correspond to (or be associated with or be used for) different streams of a XR service or XR DL traffic with multiple streams. Different (sets of) DRX configurations and/or different DRX groups could correspond to (or be associated with or be used for) different XR services.

The multiple (sets of) DRX parameters/configurations (e.g., in one DRX group and/or one information element) and/or multiple DRX groups (e.g., information elements) may be applied to XR service. The multiple (sets of) DRX parameters/configurations (e.g., in one DRX group and/or one information element) and/or multiple DRX groups (e.g., information elements) may be applied to all HARQ process of the corresponding MAC entity. The multiple (sets of) DRX parameters/configurations (e.g., in one DRX group and/or one information element) and/or multiple DRX groups (e.g., information elements) may be applied to specific HARQ process(es).

The specific HARQ process(es) may be the HARQ process(es) for XR service. The specific HARQ process(es) may be configured and/or indicated in each (set of) DRX parameter/configuration (e.g., in one DRX group and/or one information element) and/or in each DRX group (e.g., information element). The specific HARQ process(es) may be configured and/or indicated to associated with one or more (set of) DRX parameters/configurations (e.g., in one DRX group and/or one information element) and/or DRX group (e.g., information element). Different HARQ processes may be associated with different streams of a XR service or XR DL traffic with multiple streams. Different HARQ processes may be associated with different XR services.

The multiple (sets of) DRX parameters/configurations (e.g., in one DRX group and/or one information element) and/or multiple DRX groups (e.g., information elements) may be applied to all BWPs. The multiple (sets of) DRX parameters/configurations (e.g., in one DRX group and/or one information element) and/or multiple DRX groups (e.g., information elements) may be applied to specific BWP(s).

The specific BWP(s) may be the BWP(s) for XR service. The specific BWP(s) may be configured and/or indicated in each (set of) DRX parameter/configuration (e.g., in one DRX group and/or one information element) and/or in each DRX group (e.g., information element). The specific BWP(s) may be configured and/or indicated to associated with one or more (set of) DRX parameters/configurations (e.g., in one DRX group and/or one information element) and/or DRX group (e.g., information element). Different BWPs may be associated with different streams of a XR service or XR DL traffic with multiple streams. Different BWPs may be associated with different XR services.

The multiple (sets of) DRX parameters/configurations (e.g., in one DRX group and/or one information element) and/or multiple DRX groups (e.g., information elements) may be applied to all Logical Channels (LCHs) and/or Data Radio Bearers (DRBs). The multiple (sets of) DRX parameters/configurations (e.g., in one DRX group and/or one information element) and/or multiple DRX groups (e.g., information elements) may be applied to specific LCH(s) or DRB(s).

The specific LCH(s) and/or DRB(s) may be the LCH(s) and/or DRB(s) for XR service. The specific LCH(s) and/or DRB(s) may be configured and/or indicated in each (set of) DRX parameter/configuration (e.g., in one DRX group and/or one information element) and/or in each DRX group (e.g., information element). The specific LCH(s) and/or DRB(s) may be configured and/or indicated to associated with one or more (set of) DRX parameters/configurations (e.g., in one DRX group and/or one information element) and/or DRX group (e.g., information element). Different LCHs and/or DRB(s) may be associated with different streams of a XR service or XR DL traffic with multiple streams. Different LCHs and/or DRB(s) may be associated with different XR services.

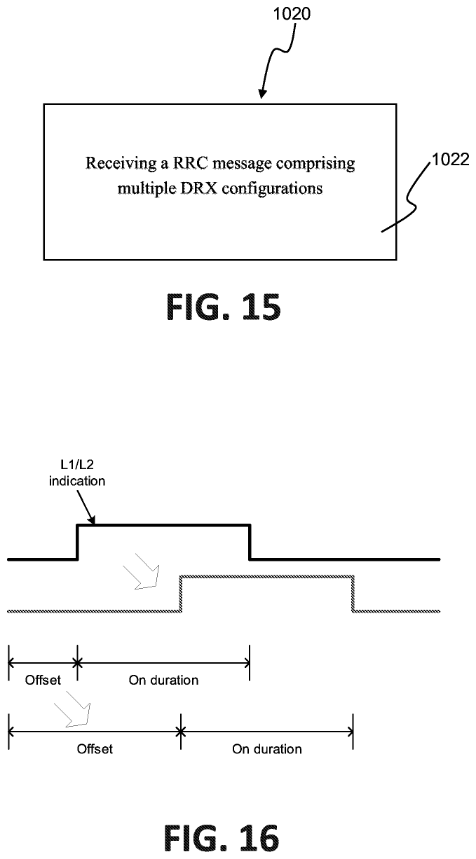

Referring to FIG. 15, with this and other concepts, systems, and methods of the present invention, a method 1020 for a UE in a wireless communication system comprises receiving a RRC message comprising multiple DRX configurations (step 1022).

In various embodiments, the multiple DRX configurations comprise one or more lists of DRX parameters in (or associated with) a DRX group and/or an information element.

In various embodiments, the multiple DRX configurations comprise one or more lists of combination of DRX parameters in (or associated with) a DRX group and/or an information element.

In various embodiments, the multiple DRX configurations comprise one or more DRX groups and/or information elements.

Referring back to FIGS. 3 and 4, in one or more embodiments from the perspective of a UE, the device 300 includes a program code 312 stored in memory 310 of the transmitter. The CPU 308 could execute program code 312 to: (i) receive a RRC message comprising multiple DRX configuration. Moreover, the CPU 308 can execute the program code 312 to perform all of the described actions, steps, and methods described above, below, or otherwise herein.

To solve the issue, the UE could use and/or switch the DRX configuration(s) by network indication. The UE may receive a (network) indication to use and/or switch the DRX configuration(s). The UE could receive multiple (sets of) DRX configurations, e.g., related to different (types of) on duration times and/or DRX cycles. The UE could be (pre-)configured with more than one (set of) DRX configuration (e.g., for different on duration times and/or DRX cycles), e.g., in a RRC message (e.g., RRCSetup, RRCResume, RRCReconfiguration). The (sets of) DRX configurations could be associated with the same serving cell, e.g., used for controlling PDCCH monitoring in the serving cell. The UE could receive an indication, activation and/or deactivation of DRX configuration(s) by L1/L2 signaling/indication (e.g., DCI, MAC CE). The indication may be a L1/L2 signaling/indication (e.g., DCI, MAC CE), e.g., for activation and/or deactivation of the DRX configuration(s). The UE could use (or switch to) the indicated (activated) DRX configuration(s), e.g., based on the indication. The UE could activate and/or deactivate the indicated DRX configuration(s), e.g., based on the indication. More than one of the multiple (sets of) DRX configuration(s) could be activated. The UE may use the indicated DRX configuration(s) for XR services. The UE may use the indicated DRX configuration(s) for specific stream of a XR service, e.g., indicated by the indication.

The multiple (sets of) DRX configurations and/or more than one (set of) DRX configuration may be and/or be referred to multiple (sets of) DRX parameters/configurations in (or associated with) one DRX group and/or one information element of DRX configuration (e.g., DRX-Config). The UE may receive and/or be (pre-)configured with a list of DRX parameter(s)/configuration(s) in (or associated with) a DRX group and/or an information element of DRX configuration (e.g., DRX-Config). The DRX parameter/configuration may be drx-SlotOffset, drx-onDurationTimer, drx-StartOffset, drx-LongCycle, drx-ShortCycle and/or drx-ShortCycleTimer. The UE may receive and/or be (pre-)configured with a list of combination(s) of DRX parameters/configurations in (or associated with) a DRX group and/or an information element of DRX configuration (e.g., DRX-Config). The DRX parameter(s)/configuration(s) may be configured in a combination in a DRX group and/or an information element of DRX configuration (e.g., DRX-Config). The combination of DRX parameters/configurations may comprise drx-SlotOffset, drx-onDurationTimer, drx-StartOffset, drx-LongCycle, drx-ShortCycle and/or drx-ShortCycleTimer.

The multiple (sets of) DRX configurations and/or more than one (set of) DRX configuration may be and/or be referred to (different DRX parameters/configurations in) multiple/different DRX groups and/or information elements of DRX configuration. The DRX group and/or information element of DRX configuration may be DRX-Config, DRX-ConfigSecondaryGroup and/or a new information element (e.g., a third DRX group, an additional DRX group). The UE may receive and/or be (pre-)configured with multiple and/or a list of DRX groups and/or information elements (of DRX configuration). The DRX group may be and/or be referred to an information element (of DRX configuration) configured by the network. The additional DRX group may be a DRX group/configuration for XR. A first DRX group (e.g., DRX-Config), second DRX group (e.g., DRX-ConfigSecondaryGroup) and/or additional DRX group (e.g., the third DRX group) may be used for the same serving cell, on the same BWP and/or in the same frequency range. A serving cell may be configured to the first DRX group (e.g., DRX-Config), the second DRX group (e.g., DRX-ConfigSecondaryGroup) and/or the additional DRX group (e.g., the third DRX group) at the same time (e.g., simultaneously). The serving cell may be PCell, PSCell and/or SCell.

The UE could use some or all of the multiple (sets of) DRX configurations simultaneously, e.g., for the serving cell. The UE could use more than one (set of) DRX configuration at the same time, e.g., for the serving cell. The more than one (set of) DRX configuration may be activated at the same time. The UE could use only one of the multiple (sets of) DRX configurations simultaneously, e.g., for the serving cell.

The multiple (sets of) DRX configurations and/or the more than one (set of) DRX configuration may comprise default (set(s) of) DRX configuration(s) and/or additional (set(s) of) DRX configuration(s). The UE may be configured with one default (set of) DRX configuration. The UE may be configured with one or more additional (set of) DRX configurations. The additional (set of) DRX configuration may be used by the UE concurrently with the default (set of) DRX configuration. The default (set of) DRX configuration may be deactivated by network. The default (set of) DRX configuration may not be (allowed to be) deactivated by network, e.g., by the indication.

The default (set of) DRX configuration may be used by the UE when the UE is not configured with additional (set of) DRX configuration. The default (set of) DRX configuration may be used by the UE when the multiple (sets of) DRX configurations are configured. The default (set of) DRX configuration may be used by the UE when the UE is indicated to use default (set of) DRX configuration. The default (set of) DRX configuration may be used by the UE when the default (set of) DRX configuration is activated by the network. The default (set of) DRX configuration may not be used by the UE when the UE is not indicated to use default (set of) DRX configuration and/or the UE is indicated not to use default (set of) DRX configuration. The default (set of) DRX configuration may not be used by the UE when the default (set of) DRX configuration is deactivated by the network. The default (set of) DRX configuration may not be used by the UE when receiving the indication to switch from the default (set of) DRX configuration to the additional (set of) DRX configuration. The default (set of) DRX configuration may be used by the UE at any time.

The additional (set of) DRX configuration may be used by the UE when the UE is indicated to use additional (set of) DRX configuration. The additional (set of) DRX configuration may be used by the UE when the additional (set of) DRX configuration is activated by the network. The additional (set of) DRX configuration may not be used by the UE when the UE is not indicated to use additional (set of) DRX configuration and/or the UE is indicated not to use additional (set of) DRX configuration. The additional (set of) DRX configuration may not be used by the UE when the additional (set of) DRX configuration is deactivated by the network. The additional (set of) DRX configuration may not be used by the UE when the multiple (sets of) DRX configurations are configured.

The default (set of) DRX configuration and/or the additional (set of) DRX configuration may comprise drx-SlotOffset, drx-onDurationTimer, drx-StartOffset, drx-LongCycle, drx-ShortCycle and/or drx-ShortCycleTimer. The additional (set of) DRX configuration may be the DRX configuration different from the default (set of) DRX configuration. The default (set of) DRX configuration could include at least one parameter which is not included in the additional (set of) DRX configuration. The at least one parameter could include drx-InactivityTimer, drx-HARQ-RTT-TimerDL, drx-HARQ-RTT-TimerUL, drx-RetransmissionTimerDL, and/or drx-RetransmissionTimerUL. For example, in DRX operation, the UE uses a first parameter, e.g., drx-StartOffset, in the additional (set of) DRX configuration and a second parameter, e.g., drx-HARQ-RTT-TimerDL, in the default (set of) DRX configuration. The UE may also or may not use the first parameter in the default (set of) DRX configuration for the DRX operation.

For example, the UE may use and/or switch to the indicated (set(s) of) DRX configuration(s) to perform DRX operation, e.g., PDCCH monitoring in a serving cell. The UE may receive and/or be (pre-)configured multiple (sets of) DRX configurations, e.g., in a RRC message (e.g., RRCSetup, RRCResume, RRCReconfiguration). The UE may use a first (set of) DRX configuration (e.g., default (set of) DRX configuration) to perform DRX operation, e.g., after receiving the DRX configuration(s).

The UE may receive an indication (e.g., by a DCI and/or MAC CE) of one of the multiple (sets of) DRX configurations. The UE may receive a first indication (e.g., by a DCI and/or MAC CE) indicating a second (set of) DRX configuration. The UE may use the second (set of) DRX configuration to perform the DRX operation, in response to receiving the first indication. The UE may use both the first (set of) DRX configuration and the second (set of) DRX configuration to perform the DRX operation. The UE may not use the first (set of) DRX configuration to perform DRX operation, in response to receiving the first indication. The UE may receive a second indication indicating a third (set of) DRX configuration. The UE may use the third (set of) DRX configuration to perform DRX operation, in response to receiving the second indication. The UE may not use the second (set of) DRX configuration to perform DRX operation, in response to receiving the second indication.

The UE may receive an indication (e.g., by a DCI and/or MAC CE) of plurality of the multiple (sets of) DRX configurations. The UE may receive a first indication indicating a second and/or third (set of) DRX configuration. The UE may use the second and/or third (set of) DRX configurations to perform DRX operation, in response to receiving the first indication. The UE may or may not use the first (set of) DRX configuration to perform DRX operation, in response to receiving the first indication. The UE may receive a second indication indicating a fourth and/or fifth (set of) DRX configuration. The UE may use the fourth and/or fifth (set of) DRX configurations to perform DRX operation, in response to receiving the second indication. The UE may not use the second and/or third (set of) DRX configuration to perform DRX operation, in response to receiving the second indication.

For example, the UE may activate the indicated (set(s) of) DRX configuration(s) to perform DRX operation (e.g., PDCCH monitoring in a serving cell), and/or deactivate the current (set(s) of) DRX configuration(s) (e.g., the (set(s) of) DRX configuration(s) used by the UE before receiving an activation). The UE may receive and/or be (pre-)configured multiple (sets of) DRX configurations, e.g., in a RRC message (e.g., RRCSetup, RRCResume, RRCReconfiguration). The UE may use a first (set of) DRX configuration (e.g., default (set of) DRX configuration) to perform DRX operation, e.g., after receiving the DRX configuration(s).

The UE may receive an (indication of) activation (e.g., by a DCI and/or MAC CE) of one of the multiple (sets of) DRX configurations. The UE may receive a first (indication of) activation indicating a second (set of) DRX configuration. The UE may activate the second (set of) DRX configuration, in response to receiving the first (indication of) activation. The UE may or may not deactivate the first (set of) DRX configuration in response to receiving the first (indication of) activation. The UE may use the second (set of) DRX configuration to perform DRX operation, in response to activating the second (set of) DRX configuration. The UE may or may not use the first (set of) DRX configuration to perform DRX operation, in response to activating the second (set of) DRX configuration. The UE may receive a second (indication of) activation indicating a third (set of) DRX configuration. The UE may activate the third (set of) DRX configuration, in response to receiving the second (indication of) activation. The UE may deactivate the second (set of) DRX configuration in response to receiving the second (indication of) activation. The UE may use the third (set of) DRX configuration to perform DRX operation, in response to activating the third (set of) DRX configuration.

The UE may receive an (indication of) activation (e.g., by a DCI and/or MAC CE) of plurality of the multiple (sets of) DRX configurations. The UE may receive a first (indication of) activation indicating a second and/or third (set of) DRX configuration. The UE may activate the second and/or third (set of) DRX configuration, in response to receiving the first (indication of) activation. The UE may or may not deactivate the first (set of) DRX configuration in response to receiving the first (indication of) activation. The UE may use the second and/or third (set of) DRX configurations to perform DRX operation, in response to activating the second and/or third (set of) DRX configuration. The UE may or may not use the first (set of) DRX configuration to perform DRX operation, in response to activating the second and/or third (set of) DRX configuration. The UE may receive a second (indication of) activation indicating a fourth and/or fifth (set of) DRX configuration. The UE may activate the fourth and/or fifth (set of) DRX configuration, in response to receiving the second (indication of) activation. The UE may deactivate the second and/or third (set of) DRX configuration in response to receiving the second (indication of) activation. The UE may use the fourth and/or fifth (set of) DRX configuration to perform DRX operation, in response to activating the fourth and/or fifth (set of) DRX configuration.

For example, the UE may activate and/or deactivate the indicated (set(s) of) DRX configuration(s) to perform DRX operation, e.g., PDCCH monitoring in a serving cell. The UE may receive and/or be (pre-)configured multiple (sets of) DRX configurations, e.g., in a RRC message (e.g., RRCSetup, RRCResume, RRCReconfiguration). The UE may use a first (set of) DRX configuration (e.g., default (set of) DRX configuration) to perform DRX operation, e.g., after receiving the DRX configuration(s).

The UE may receive an (indication of) activation (e.g., by a DCI and/or MAC CE) of one of the multiple (sets of) DRX configurations. The UE may receive a first (indication of) activation indicating a second (set of) DRX configuration. The UE may activate the second (set of) DRX configuration, in response to receiving the first (indication of) activation. The UE may use the first and/or second (set of) DRX configuration to perform DRX operation, in response to activating the second (set of) DRX configuration. The UE may receive a second (indication of) activation indicating a third (set of) DRX configuration. The UE may activate the third (set of) DRX configuration, in response to receiving the second (indication of) activation. The UE may use the first, second and/or third (set of) DRX configuration to perform DRX operation, in response to activating the third (set of) DRX configuration. The UE may receive a third (indication of) deactivation indicating the second (set of) DRX configuration. The UE may deactivate the second (set of) DRX configuration, in response to receiving the third (indication of) activation. The UE may use the first and/or third (set of) DRX configuration to perform DRX operation, in response to deactivating the second (set of) DRX configuration.

The UE may receive an (indication of) activation (e.g., by a DCI and/or MAC CE) of plurality of the multiple (sets of) DRX configurations. The UE may receive a first (indication of) activation indicating a second and/or third (set of) DRX configuration. The UE may activate the second and/or third (set of) DRX configuration, in response to receiving the first (indication of) activation. The UE may use the first, second and/or third (set of) DRX configurations to perform DRX operation, in response to activating the second and/or third (set of) DRX configuration. The UE may receive a second (indication of) activation indicating a fourth and/or fifth (set of) DRX configuration. The UE may activate the fourth and/or fifth (set of) DRX configuration, in response to receiving the second (indication of) activation. The UE may use the first, second, third, fourth and/or fifth (set of) DRX configuration to perform DRX operation, in response to activating the fourth and/or fifth (set of) DRX configuration. The UE may receive a third (indication of) deactivation indicating the second and/or fourth (set of) DRX configuration. The UE may deactivate the second and/or fourth (set of) DRX configuration, in response to receiving the third (indication of) activation. The UE may use the first, third and/or fifth (set of) DRX configuration to perform DRX operation, in response to deactivating the second and/or fourth (set of) DRX configuration.

In response to receiving the indication and/or indication of activation/deactivation, the UE may transmit a confirmation (e.g., ACK) to NW. The confirmation may be a UCI, MAC CE and/or UAI.

In response to receiving the indication and/or indication of activation/deactivation, the UE may use and/or activate the indicating/corresponding (set of) DRX configuration upon or after (at least one of) a below first timing:
(a first symbol after) reception of the indication and/or indication of activation/deactivation;
(a first symbol after) transmission of the confirmation;
a specific PDCCH occasion (e.g., indicated in the indication and/or indication of activation/deactivation, pre-defined in standard);
a time delay (e.g., indicated in the indication and/or indication of activation/deactivation, pre-defined in standard); and/or
when a timer associated with the DRX configuration is (re)started.

The (set of) DRX configuration used before receiving the indication and/or indication of activation/deactivation could be activated/used after applicable time of the indication and/or indication of activation/deactivation. The (set of) DRX configuration indicated/activated in the indication and/or indication of activation/deactivation could be deactivated after applicable time of the indication and/or indication of activation. The (set of) DRX configuration deactivated in the indication and/or indication of activation/deactivation could be activated after applicable time of the indication of deactivation. The applicable time of the indication and/or indication of activation/deactivation may be the time duration between the first timing to a second timing.

In response to receiving the indication and/or indication of activation/deactivation, the UE may stop applying the indication and/or indication of activation/deactivation, upon or after (at least one of) the below second timing:
a specific PDCCH occasion (e.g., indicated in the indication and/or indication of activation/deactivation, pre-defined in standard);
a time delay (e.g., indicated in the indication and/or indication of activation/deactivation, pre-defined in standard);
a timer expiry;
a number of DL receptions; and/or
a number of DRX cycles or on duration time.

The UE may use the indicated/corresponding (set of) DRX configuration before (at least) above timing. The UE may not use the indicated/corresponding (set of) DRX configuration after (at least) above timing. The UE may use the last used (set of) DRX configuration (e.g., the (set(s) of) DRX configuration(s) used by the UE before receiving the indication and/or indication of activation/deactivation) upon or after (at least) above timing. In response to (at least) above timing (e.g., the UE stops using the indicated/corresponding (set of) DRX configuration), the UE may use, activate and/or switch to the last used (set of) DRX configuration (e.g., the (set(s) of) DRX configuration(s) used by the UE before receiving the indication and/or indication of activation/deactivation).

The UE may increase a counter for each DRX cycle, on duration time, PDCCH occasion and/or DL reception after using/activating/deactivating the indicated/corresponding (set of) DRX configuration. The UE may use the indicated/corresponding (set of) DRX configuration when the counter is smaller and/or is not larger than the indicated value. The UE may not use the indicated/corresponding (set of) DRX configuration when the counter is smaller and/or is not larger than the indicated value.

In one example, in response to receiving a first indication indicating a second (set of) DRX configuration, the UE may use the second (set of) DRX configuration to perform DRX operation upon (a first symbol after) reception of the first indication. The UE may stop using the second (set of) DRX configuration to perform DRX operation upon/after a pre-defined number of PDCCH occasions after (the first symbol after) reception of the first indication. The UE may use a first (set of) DRX configuration to perform DRX operation upon/after the pre-defined number of PDCCH occasions after (the first symbol after) reception of the first indication.

In one example, in response to receiving a second indication indicating a third (set of) DRX configuration, the UE may use the third (set of) DRX configuration to perform DRX operation upon (a first symbol after) transmission of a confirmation. The UE may stop using the second (set of) DRX configuration to perform DRX operation upon an indicated number of PDCCH occasions after (the first symbol after) transmission of the confirmation. The UE may use a second (set of) DRX configuration to perform DRX operation upon the indicated number of PDCCH occasions after (the first symbol after) transmission of the confirmation.

In one example, in response to receiving a first indication indicating a second and/or third (set of) DRX configuration, the UE may use the second and/or third (set of) DRX configuration to perform DRX operation upon/after a pre-defined number of PDCCH occasions (e.g., after receiving the first indication). The UE may stop using the second and/or third (set of) DRX configuration to perform DRX operation upon a pre-defined time delay (e.g., in millisecond) after the UE starts to use the second and/or third (set of) DRX configuration. The UE may use a first (set of) DRX configuration to perform DRX operation upon the pre-defined time delay (e.g., in millisecond) after the UE starts to use the second and/or third (set of) DRX configuration.

In one example, in response to receiving a second indication indicating a fourth and/or fifth (set of) DRX configuration, the UE may use the fourth and/or fifth (set of) DRX configuration to perform DRX operation upon a PDCCH occasion indicated in the second indication. The UE may stop using the fourth and/or fifth (set of) DRX configuration to perform DRX operation upon an indicated time delay (e.g., in millisecond) after the UE starts to use the fourth and/or fifth (set of) DRX configuration. The UE may use a second and/or third (set of) DRX configuration to perform DRX operation upon the indicated time delay (e.g., in millisecond) after the UE starts to use the second and/or third (set of) DRX configuration.

In one example, in response to receiving a first (indication of) activation indicating a second (set of) DRX configuration, the UE may activate the second (set of) DRX configuration to perform DRX operation upon/after an indicated number of PDCCH occasions (e.g., indicated in the first (indication of) activation), e.g., after receiving the first (indication of) activation. The UE may start a timer in response to activating the second (set of) DRX configuration. Upon the timer expiry, the UE may stop using the second (set of) DRX configuration and/or deactivate the second (set of) DRX configuration. Upon the timer expiry, the UE may use a first and/or third (set of) DRX configuration to perform DRX operation.

In one example, in response to receiving a second (indication of) activation indicating a third (set of) DRX configuration, the UE may activate the third (set of) DRX configuration to perform DRX operation upon/after a pre-defined time delay (e.g., after receiving the second (indication of) activation). The UE may increase a counter for each DL reception after using/activating the third (set of) DRX configuration. The UE may stop using the third (set of) DRX configuration to perform DRX operation and/or deactivate the third (set of) DRX configuration after a number of DL receptions (e.g., the counter is larger than an indicated value/threshold). The UE may use the second (set of) DRX configuration to perform DRX operation after a number of DL receptions (e.g., the counter is larger than an indicated value/threshold).

In one example, in response to receiving a third (indication of) deactivation indicating a second (set of) DRX configuration, the UE may deactivate the second (set of) DRX configuration to perform DRX operation upon/after an indicated time delay (e.g., indicated in the first (indication of) activation), e.g., after receiving the third (indication of) deactivation. The UE may increase a counter for each DRX cycle after deactivating the second (set of) DRX configuration. The UE may activate the second (set of) DRX configuration to perform DRX operation after a number of DRX cycles (e.g., the counter is larger than an indicated value/threshold). The UE may activate and/or use the second (set of) DRX configuration to perform DRX operation after a number of DRX cycles (e.g., the counter is larger than an indicated value/threshold).

The UE could monitor the indication and/or indication of activation/deactivation during DRX Active Time of the associated DRX group(s) and/or DRX configuration(s). Alternatively, the UE could monitor the indication and/or indication of activation/deactivation when a drx-onDurationTimer of the associated DRX group(s) and/or DRX configuration(s) is running. The UE may not monitor the indication and/or indication of activation/deactivation outside DRX Active Time of the associated DRX group(s) and/or DRX configuration(s). Alternatively, the UE may not monitor the indication and/or indication of activation/deactivation when a drx-onDurationTimer of associated DRX group(s) and/or DRX configuration(s) is not running.

In response to receiving the indication and/or indication of activation/deactivation, the UE may stop one or more DRX timers of associated DRX group(s) and/or DRX configuration(s). In response to receiving the indication and/or indication of activation/deactivation, the UE may stop the on duration timer (e.g., drx-onDurationTimer). In response to receiving the indication and/or indication of activation/deactivation, the UE may not stop the on duration timer (e.g., drx-onDurationTimer), e.g., keep the timer running. In response to receiving the indication and/or indication of activation/deactivation, the UE may restart the on duration timer (e.g., drx-onDurationTimer). The UE may determine a DRX cycle based on formulas using the length/duration of DRX cycle (e.g., drx-ShortCycle, drx-LongCycle) and the start offset of DRX cycle (e.g., drx-StartOffset). In other words, the UE may restart the on duration timer at a timing calculated based on information (e.g., associated with start offset) indicated by the indication and/or indication of activation/deactivation (e.g., based on the formulas using information indicated by the indication and/or indication of activation/deactivation). In response to receiving the indication and/or indication of activation/deactivation, the UE may stop (all) the inactivity timer(s) (e.g., drx-InactivityTimer). In response to receiving the indication and/or indication of activation/deactivation, the UE may not stop (any of) the inactivity timer (e.g., drx-InactivityTimer), e.g., keep the timer running. In response to receiving the indication and/or indication of activation/deactivation, the UE may restart (all) the inactivity timer(s) (e.g., drx-InactivityTimer). In response to receiving the indication and/or indication of activation/deactivation, the UE may start the inactivity timer (e.g., drx-InactivityTimer).

In response to receiving the indication and/or indication of activation/deactivation, the UE may not stop (any of) the retransmission timer(s) (e.g., drx-RetransmissionTimerDL and/or drx-RetransmissionTimerUL), e.g., keep the timer running. In response to receiving the indication and/or indication of activation/deactivation, the UE may not stop (any of) the RTT timer(s) (e.g., drx-HARQ-RTT-TimerDL, drx-HARQ-RTT-TimerUL), e.g., keep the timer running.

The UE may not stop the on duration timer (e.g., drx-onDurationTimer) and/or the inactivity timer (e.g., drx-InactivityTimer) associated with a (set of) DRX configuration, e.g., keep the timer running, in response to receiving the indication to activate another (set of) DRX configuration.

The UE may stop the on duration timer (e.g., drx-onDurationTimer) and/or the inactivity timer (e.g., drx-InactivityTimer) associated with a (set of) DRX configuration in response to:
receiving the indication to deactivate the (set of) DRX configuration or switch from the (set of) DRX configuration to another (set of) DRX configuration; or
transmitting the confirmation for the indication.

The UE may stop the on duration timer (e.g., drx-onDurationTimer) and/or the inactivity timer (e.g., drx-InactivityTimer) upon receiving the indication and/or indication of activation/deactivation. The UE may stop the on duration timer (e.g., drx-onDurationTimer) and/or the inactivity timer (e.g., drx-InactivityTimer) upon transmitting the confirmation for the indication and/or indication of activation/deactivation. The UE may stop the on duration timer (e.g., drx-onDurationTimer) and/or the inactivity timer (e.g., drx-InactivityTimer) upon using/activating/deactivating the indicated (set of) DRX configuration.

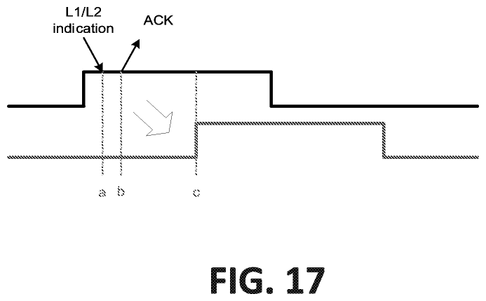

For example, as shown in FIG. 17, the UE may receive a L1/L2 indication to adjust a DRX parameter (e.g., drx-StartOffset, drx-SlotOffset), e.g., at timing a. The UE may transmit a confirmation (e.g., ACK) in response to reception of the L1/L2 indication, e.g., at timing b. The UE may stop or (re)start a DRX timer in response receiving to the L1/L2 indication or transmitting the ACK.

In one example, the UE may restart a DRX timer (e.g., drx-onDurationTimer) at a timing indicated by the L1/L2 indication (e.g., timing c in FIG. 17). The timing c is calculated based on the value of drx-StartOffset or drx-SlotOffset indicated by the L1/L2 indication.

In one example, the UE may stop a DRX timer (e.g., drx-onDurationTimer and/or drx-InactivityTimer) in response to (or upon/after) reception of the L1/L2 indication. The UE may stop the DRX timer (e.g., drx-onDurationTimer and/or drx-InactivityTimer) at timing a in FIG. 17. The UE may start drx-onDurationTimer at a timing indicated by the L1/L2 indication (e.g., timing c in FIG. 17). The timing c is calculated based on the value of drx-StartOffset or drx-SlotOffset indicated by the L1/L2 indication.

In one example, the UE may stop a DRX timer (e.g., drx-onDurationTimer and/or drx-InactivityTimer) in response to (or upon/after) transmission of the ACK. The UE may stop the DRX timer (e.g., drx-onDurationTimer and/or drx-InactivityTimer) at timing b in FIG. 17. The UE may start drx-onDurationTimer at a timing indicated by the L1/L2 indication (e.g., timing c in FIG. 17). The timing c is calculated based on the value of drx-StartOffset or drx-SlotOffset indicated by the L1/L2 indication.

All concepts, embodiments, and examples above and herein can be merged into new concepts and/or new concept combinations.

The multiple (sets of) DRX parameter(s)/configuration(s) may be used for unicast. The multiple (sets of) DRX parameter(s)/configuration(s) may not be used by multicast. The multiple (sets of) DRX parameter(s)/configuration(s) may be used for downlink. The multiple (sets of) DRX parameter(s)/configuration(s) may not be related to sidelink.

The above and herein mentioned DRX configuration(s), (multiple) set(s) of DRX configuration(s), default (set of) DRX configuration, and/or additional (set of) DRX configuration(s) could be configured to be used for a (same) (set of) serving cell(s). The above and herein mentioned DRX configuration(s), (multiple) set(s) of DRX configuration(s), default (set of) DRX configuration, and/or additional (set of) DRX configuration(s) could be configured to be used for one or multiple XR services.

The UE may receive parameters and/or configurations related to DRX, e.g., in a RRC message (e.g., RRCSetup, RRCResume, RRCReconfiguration) from the network. The UE may receive the RRC message (e.g., RRCSetup, RRCResume, RRCReconfiguration) in RRC inactive mode, RRC idle mode and/or RRC connected mode.

The UE herein may refer to the UE, a MAC entity of the UE, a HARQ entity of the UE, or a RRC entity of the UE.

The UE herein may be a N_{R} device. The UE herein may be a N_{R}-light device. The UE herein may be a reduced capability device. The UE herein may be a mobile phone. The UE herein may be a wearable device. The UE herein may be a sensor. The UE herein may be a stationary device. The UE herein may be a head mounted display (HMD).

The network herein may be a network node. The network herein may be a base station. The network herein may be an access point. The network herein may be an eNB. The network herein may be a gNB. The network herein may be a gateway.

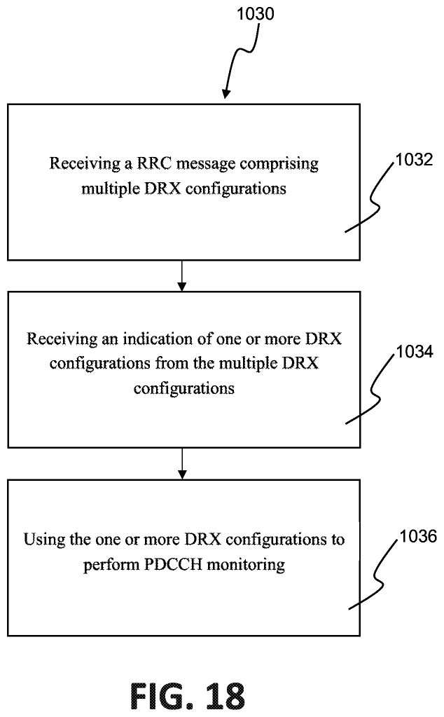

Referring to FIG. 18, with this and other concepts, systems, and methods of the present invention, a method 1030 for a UE in a wireless communication system comprises receiving a RRC message comprising multiple DRX configurations (step 1032), receiving an indication of one or more DRX configurations from the multiple DRX configurations (step 1034), using the one or more DRX configurations to perform PDCCH monitoring (step 1036).

In various embodiments, the multiple DRX configurations comprise one or more lists of DRX parameters in (or associated with) a DRX group and/or an information element.

In various embodiments, the multiple DRX configurations comprise one or more lists of combination of DRX parameters in (or associated with) a DRX group and/or an information element.

In various embodiments, the multiple DRX configurations comprise one or more DRX groups and/or information elements.

In various embodiments, the indication is a DCI and/or MAC CE.

In various embodiments, in response to receiving the indication, the UE switches to the one or more DRX configurations.

In various embodiments, in response to receiving the indication, the UE activates the one or more DRX configurations.

Referring back to FIGS. 3 and 4, in one or more embodiments from the perspective of a UE, the device 300 includes a program code 312 stored in memory 310 of the transmitter. The CPU 308 could execute program code 312 to: (i) receive a RRC message comprising multiple DRX configurations; (ii) receive an indication of one or more DRX configurations from the multiple DRX configurations; and (iii) use the one or more DRX configurations to perform PDCCH monitoring. Moreover, the CPU 308 can execute the program code 312 to perform all of the described actions, steps, and methods described above, below, or otherwise herein.

Referring back to FIGS. 3 and 4, in one or more embodiments from the perspective of a NW, the device 300 includes a program code 312 stored in memory 310 of the transmitter. The CPU 308 could execute program code 312 to: (i) transmit, to a UE, a RRC message comprising multiple DRX configurations; (ii) transmit, to the UE, an indication of one or more DRX configurations from the multiple DRX configurations; and (iii) wherein the UE uses the one or more DRX configurations to perform PDCCH monitoring. Moreover, the CPU 308 can execute the program code 312 to perform all of the described actions, steps, and methods described above, below, or otherwise herein.

The UE may be configured to transmit Sounding Reference Signal (SRS) for the network to estimate UL channel state, and be configured to report Channel State Information (CSI) for the network to adapt DL transmission. Based on [3] 3GPP TS 38.321 V17.0.0, the UE may not transmit periodic SRS and semi-persistent SRS, if the UE would not be in DRX Active Time. The UE may not report semi-persistent CSI configured on PUSCH, if the UE would not be in the DRX Active Time. When a CSI masking (e.g., csi-Mask) is set to TRUE, the UE may not report CSI on Physical Uplink Control Channel (PUCCH) if the UE would not be in on duration time. When a CSI masking (e.g., csi-Mask) is set to FLASE, the UE may not report CSI on PUCCH if the UE would not be in DRX Active Time. The DRX Active Time may comprise at least on duration time, inactivity time, retransmission time, RA contention resolution time (e.g., when ra-ContentionResolutionTimer or msgB-ResponseWindow is running), the time duration that a PDCCH indicating a new transmission addressed to Cell-Radio Network Temporary Identifier (C-RNTI) has not been received after successful reception of a Random Access Response for contention free Random Access and/or the time duration that a Scheduling Request is sent on PUCCH and is pending. The conditions for DRX Active Time may comprise at least below:
drx-onDurationTimer or drx-InactivityTimer configured for a DRX group is running;
drx-RetransmissionTimerDL, drx-RetransmissionTimerUL or drx-RetransmissionTimerSL is running on any serving cell in a DRX group;
ra-ContentionResolutionTimer or msgB-ResponseWindow is running;
a Scheduling Request is sent on PUCCH and is pending; and/or
a PDCCH indicating a new transmission addressed to the C-RNTI of the MAC entity has not been received after successful reception of a Random Access Response for the Random Access Preamble not selected by the MAC entity among the contention-based Random Access Preamble.

For a symbol n, if the UE would not be in DRX Active Time (for a DRX group) considering (received) UL grant, DL assignment, DRX Command and/or Scheduling Request (SR) transmission until 4 ms prior to the symbol n, the UE would not transmit/report periodic SRS, semi-persistent SRS, semi-persistent CSI configured on Physical Uplink Shared Channel (PUSCH) and/or CSI on PUCCH (for the DRX group).

For a symbol n, if the UE would not be in on duration time (for a DRX group) considering (received) UL grant, DL assignment, DRX Command and/or SR transmission until 4 ms prior to the symbol n, the UE would not report CSI on PUCCH (for the DRX group).

When determining to transmit SRS and/or CSI report and/or evaluating the conditions of DRX Active Time, the UE may consider DL reception (e.g., UL grant, DL assignment, DRX Command) and/or SR transmission until 4 ms prior to a symbol n to determine whether the UE is in DRX Active Time and/or on duration time. The UE may start an inactivity timer (e.g., drx-InactivityTimer) and/or RTT timer (e.g., drx-HARQ-RTT-TimerUL, drx-HARQ-RTT-TimerDL) in response to receiving UL grant and/or DL assignment. The UE may enter inactivity time and/or retransmission time after (or in response to) receiving UL grant and/or DL assignment. The UE may stop (all) the inactivity timer (e.g., drx-InactivityTimer) and/or on duration timer (e.g., drx-onDurationTimer) in response to receiving a DRX command (e.g., DRX Command MAC CE, Long DRX Command MAC CE). The UE may leave inactivity time and/or on duration time after (or in response to) receiving a DRX command (e.g., DRX Command MAC CE, Long DRX Command MAC CE).

Considering the XR service characteristics (e.g., periodicity, jitter, latency, and/or reliability), XR specific power saving techniques are beneficial. To reduce PDCCH monitoring and thus reduce power consumption for XR services, it may be needed to appropriately align the on duration time and/or DRX cycle with XR DL traffic arrival time (e.g., with jitter). The network may dynamically modify DRX configurations for XR services, which may result in unexpected on duration time for the UE to transmit SRS and/or CSI reports.

To solve the issue, the UE could determine whether to transmit (periodic and/or semi-persistent) SRS (in a DRX group) based on an indication (associated with the DRX group). The UE could determine whether to report (periodic and/or semi-persistent) CSI (in a DRX group) based on the indication (associated with the DRX group). The UE could consider the indication (e.g., first indication, second indication, third indication) received (e.g., for the serving cell) until a time duration prior to a symbol n, when evaluating DRX Active Time and/or on duration time, or when determining to transmit SRS and/or CSI report (in the symbol n). The UE may not consider the indication received (e.g., for the serving cell) within a time duration prior to a symbol n, when evaluating DRX Active Time and/or on duration time, or when determining to transmit SRS and/or CSI report (in the symbol n). The indication may be (at least) a first indication, second indication and/or third indication. The indication (e.g., first indication, second indication, third indication) may indicate the UE to adjust, modify, reconfigure, switch, activate and/or deactivate one or more (set of) DRX configurations. The indication (e.g., first indication, second indication, third indication) may indicate the UE to apply/use one or more (set of) DRX configurations different from the (set(s) of) DRX configuration(s) used by the UE before receiving the indication. The indication (e.g., first indication, second indication, third indication) may be a DCI, MAC CE and/or RRC message. The indication (e.g., first indication, second indication, third indication) may be for XR services. The indication (e.g., first indication, second indication, third indication) may be for specific stream of a XR service.

The UE may receive one or multiple (sets of) DRX configurations, e.g., in a RRC message (e.g., RRCSetup, RRCResume, RRCReconfiguration). The UE may be (pre-)configured with one or more (set of) DRX configurations (e.g., for different on duration times and/or DRX cycles). The (set(s) of) DRX configuration(s) could be associated with the same serving cell, e.g., used for controlling PDCCH monitoring in the serving cell. The UE could use some or all of the multiple (sets of) DRX configurations simultaneously, e.g., for the serving cell. The UE could use more than one (set of) DRX configuration at the same time, e.g., for the serving cell. The more than one (set of) DRX configuration may be activated at the same time. The UE could use only one (set of) DRX configuration simultaneously, e.g., for the serving cell.

The multiple (sets of) DRX configurations may be and/or be referred to multiple (sets of) DRX parameters/configurations in (or associated with) one DRX group and/or one information element of DRX configuration (e.g., DRX-Config). The UE may receive and/or be (pre-)configured with a list of DRX parameter(s)/configuration(s) in (or associated with) a DRX group and/or an information element of DRX configuration (e.g., DRX-Config). The UE may receive and/or be (pre-)configured with a list of combination(s) of DRX parameters/configurations in (or associated with) a DRX group and/or an information element of DRX configuration (e.g., DRX-Config). The DRX parameter/configuration may be drx-SlotOffset, drx-onDurationTimer, drx-StartOffset, drx-LongCycle, drx-ShortCycle and/or drx-ShortCycleTimer. The combination of DRX parameters/configurations may comprise drx-SlotOffset, drx-onDurationTimer, drx-StartOffset, drx-LongCycle, drx-ShortCycle and/or drx-ShortCycleTimer. The multiple (sets of) DRX configurations may be and/or be referred to multiple/different DRX groups and/or information elements of DRX configuration. The DRX group may be and/or be referred to an information element (of DRX configuration) (e.g., DRX-Config, DRX-ConfigSecondaryGroup and/or an additional DRX group) configured by the network.

The multiple (sets of) DRX configurations may comprise default (set(s) of) DRX configuration(s) and/or additional (set(s) of) DRX configuration(s). The additional (set of) DRX configuration may be used by the UE concurrently with the default (set of) DRX configuration. The default (set of) DRX configuration may be deactivated by the network. The default (set of) DRX configuration may not be (allowed to be) deactivated by the network, e.g., by a third indication. The default (set of) DRX configuration may be used by the UE upon configuration. The default (set of) DRX configuration could include at least one parameter (e.g., drx-InactivityTimer, drx-HARQ-RTT-TimerDL, drx-HARQ-RTT-TimerUL, drx-RetransmissionTimerDL, drx-RetransmissionTimerUL) which is not included in the additional (set of) DRX configuration. For example, in DRX operation, the UE uses a first parameter (e.g., drx-StartOffset) in an additional (set of) DRX configuration and a second parameter (e.g., drx-HARQ-RTT-TimerDL) in the default (set of) DRX configuration. The UE may also or may not use the first parameter in the default (set of) DRX configuration for the DRX operation.

The UE may receive a first indication (e.g., by DCI, MAC CE) to modify and/or reconfigure (set(s) of) DRX configuration(s) (e.g., for a DRX group). In response to receiving the first indication, the UE may reconfigure and/or adjust on duration and/or DRX cycle (e.g., for a DRX group). In response to receiving the first indication, the UE may reconfigure and/or adjust the start offset to on duration (e.g., drx-SlotOffset), the length of on duration (e.g., drx-onDurationTimer), the length of DRX cycle (e.g., drx-ShortCycle, drx-LongCycle (of drx-LongCycleStartOffset)), the start offset of DRX cycle (e.g., drx-StartOffset (of drx-LongCycleStartOffset)), and/or the time duration to use short DRX cycle (e.g., drx-ShortCycleTimer). The first indication may comprise and/or indicate value(s) of one or more (set of) DRX configurations. The UE may replace the value of a (set of) DRX configuration with the indicated value. The first indication may comprise and/or indicate relative value(s) (e.g., offset(s) and/or scale(s)) to apply to one or more (set of) DRX configurations. The UE may add an offset to the value of the one or more (set of) DRX configurations. The UE may multiply the value of the one or more (set of) DRX configurations by a scale.

The UE may receive a second indication (e.g., by DCI, MAC CE) to (dynamically/temporarily) modify, shift and/or adjust (set(s) of) DRX configuration(s). In response to receiving the second indication, the UE may apply the information indicated/comprised by the second indication to (set(s) of) DRX configuration(s). In response to receiving the second indication, the UE may shift/adjust (part of) on duration and/or DRX cycle (based on the information indicated/comprised by the second indication). In response to receiving the second indication, the UE may shift/adjust the start offset to on duration (e.g., drx-SlotOffset), the length of on duration (e.g., drx-onDurationTimer), the start offset of DRX cycle (e.g., drx-StartOffset), the length of DRX cycle (e.g., drx-ShortCycle, drx-LongCycle) and/or the time duration to use short DRX cycle (e.g., drx-ShortCycleTimer). The UE may replace the value of a (set of) DRX configuration with an indicated value in the second indication. The UE may add an offset, indicated in the second indication, to the value of a (set of) DRX configuration. The UE may multiply the value of a (set of) DRX configuration by a scale indicated in the second indication. The value of the (set of) DRX configuration before receiving the second indication could be resumed/used after applicable time of the second indication, e.g., after the time duration or after the single/specific on duration and/or DRX cycle.

The UE may receive a third indication (e.g., by DCI, MAC CE) to switch, activate and/or deactivate (set(s) of) DRX configuration(s). The UE may use (or switch to) the indicated (activated) (set(s) of) DRX configuration(s) based on the third indication. The UE may use and/or switch to the indicated (set(s) of) DRX configuration(s) to perform DRX operation, e.g., PDCCH monitoring in a serving cell. The UE may activate and/or deactivate the indicated (set(s) of) DRX configuration(s) based on the third indication. The (set(s) of) DRX configuration(s) used before receiving the third indication to switch the (set of) DRX configuration could be activated/used after applicable time of the third indication, e.g., after the time duration or after the single/specific on duration and/or DRX cycle.

In response to receiving the indication (e.g., first indication, second indication, third indication), the UE may transmit a confirmation (e.g., ACK) to NW. The confirmation may be a UCI, MAC CE and/or UAI.

The UE could monitor the indication (e.g., first indication, second indication, third indication) during DRX Active Time of the associated DRX group(s) and/or DRX configuration(s). Alternatively, the UE could monitor the indication (e.g., first indication, second indication, third indication) when a drx-onDurationTimer of the associated DRX group(s) and/or DRX configuration(s) is running. The UE may not monitor the indication (e.g., first indication, second indication, third indication) outside DRX Active Time of the associated DRX group(s) and/or DRX configuration(s). Alternatively, the UE may not monitor the indication (e.g., first indication, second indication, third indication) when a drx-onDurationTimer of associated DRX group(s) and/or DRX configuration(s) is not running.

In response to receiving the indication (e.g., first indication, second indication, third indication), the UE may stop one or more DRX timers of associated DRX group(s) and/or DRX configuration(s). In response to receiving the indication (e.g., first indication, second indication, third indication), the UE may stop the on duration timer (e.g., drx-onDurationTimer). In response to receiving the indication (e.g., first indication, second indication, third indication), the UE may not stop the on duration timer (e.g., drx-onDurationTimer), e.g., keep the timer running. In response to receiving the indication (e.g., first indication, second indication, third indication), the UE may restart the on duration timer (e.g., drx-onDurationTimer). The UE may determine a DRX cycle based on formulas using the length/duration of DRX cycle (e.g., drx-ShortCycle, drx-LongCycle) and the start offset of DRX cycle (e.g., drx-StartOffset). In other words, the UE may restart the on duration timer at a timing calculated based on information (e.g., associated with start offset) indicated by the indication (e.g., based on the formulas using information indicated by the indication). In response to receiving the indication (e.g., first indication, second indication, third indication), the UE may suspend the on duration timer (e.g., drx-onDurationTimer) (for a timer duration and then resume the timer). In response to receiving the indication (e.g., first indication, second indication, third indication), the UE may stop (all) the inactivity timer(s) (e.g., drx-InactivityTimer). In response to receiving the indication (e.g., first indication, second indication, third indication), the UE may not stop (any of) the inactivity timer (e.g., drx-InactivityTimer), e.g., keep the timer running. In response to receiving the indication (e.g., first indication, second indication, third indication), the UE may restart (all) the inactivity timer(s) (e.g., drx-InactivityTimer). In response to receiving the indication (e.g., first indication, second indication, third indication), the UE may start the inactivity timer (e.g., drx-InactivityTimer). The UE may stop the on duration timer (e.g., drx-onDurationTimer) and/or the inactivity timer (e.g., drx-InactivityTimer) upon receiving the indication (e.g., first indication, second indication, third indication). The UE may stop the on duration timer (e.g., drx-onDurationTimer) and/or the inactivity timer (e.g., drx-InactivityTimer) upon transmitting the confirmation for the indication (e.g., first indication, second indication, third indication).

In response to receiving the indication (e.g., first indication, second indication, third indication), the UE may not stop (any of) the retransmission timer(s) (e.g., drx-RetransmissionTimerDL, drx-RetransmissionTimerUL), e.g., keep the timer running. In response to receiving the indication (e.g., first indication, second indication, third indication), the UE may not stop (any of) the RTT timer(s) (e.g., drx-HARQ-RTT-TimerDL, drx-HARQ-RTT-TimerUL), e.g., keep the timer running.

When the UE determines to transmit SRS and/or CSI report or not in a symbol n, the UE may consider (at least) the indication (e.g., first indication, second indication, third indication) received and/or applied (e.g., for the serving cell) until/before a specific timing. When the UE determines to transmit SRS and/or CSI report or not in a symbol n, the UE may not consider (at least) the indication (e.g., first indication, second indication, third indication) received and/or applied (e.g., for the serving cell) within/after a specific timing. When the UE evaluates DRX Active Time and/or on duration time for determining to transmit SRS and/or CSI report or not, the UE may consider (at least) the indication (e.g., first indication, second indication, third indication) received and/or applied (e.g., for the serving cell) until/before a specific timing. When the UE evaluates DRX Active Time and/or on duration time for determining to transmit SRS and/or CSI report or not, the UE may not consider (at least) the indication (e.g., first indication, second indication, third indication) received and/or applied (e.g., for the serving cell) within/after a specific timing. The specific timing may be a time duration prior to the symbol n. The time duration may be 4 ms. The time duration may be longer than 4 ms. The time duration may be indicated in the indication (e.g., first indication, second indication, third indication). The time duration may be preconfigured by the network.

The UE may determine whether to transmit SRS and/or CSI report based on the reception of the indication (e.g., first indication, second indication, third indication). The UE may determine whether to transmit SRS and/or CSI report based on the information of the indication (e.g., first indication, second indication, third indication). The UE may determine whether to transmit SRS and/or CSI report not based on the reception of the indication (e.g., first indication, second indication, third indication). The UE may determine whether the symbol n is in DRX Active Time and/or on duration time based on the reception of the indication (e.g., first indication, second indication, third indication). The UE may determine whether the symbol n is in DRX Active Time and/or on duration time based on the information of the indication (e.g., first indication, second indication, third indication). The UE may determine whether the symbol n is in DRX Active Time and/or on duration time not based on the reception of the indication (e.g., first indication, second indication, third indication).

The UE may determine to transmit SRS and/or CSI report if the symbol n is (considered/determined as) in DRX Active Time and/or on duration time. The UE may determine not to transmit SRS and/or CSI report if the symbol n is not (considered/determined as) in DRX Active Time and/or on duration time.

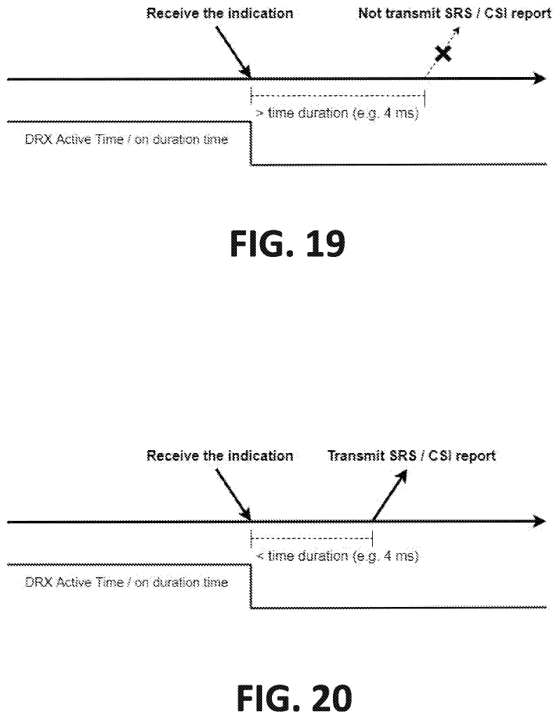

For example, the UE may determine, consider and/or evaluate the symbol n is not in DRX Active Time and/or on duration time if the indication (e.g., first indication, second indication, third indication) is received and/or applied (e.g., for the serving cell) before the specific timing. As shown in FIG. 19, the UE may receive or apply the indication before the specific timing (e.g., the time duration prior to the symbol n). The time interval from the UE receives or applies the indication to the symbol n may be longer than and/or equal to the time duration. The UE may not transmit SRS and/or CSI report in the symbol n. Alternately, the UE may determine, consider and/or evaluate the symbol n is in DRX Active Time and/or on duration time if the indication (e.g., first indication, second indication, third indication) is received and/or applied (e.g., for the serving cell) after the specific timing. As shown in FIG. 20, the UE may receive or apply the indication after the specific timing (e.g., the time duration prior to the symbol n). The time interval from the UE receives or applies the indication to the symbol n may be shorter than the time duration. The UE may transmit SRS and/or CSI report in the symbol n. The UE may stop an on duration timer (e.g., drx-onDurationTimer) and/or inactivity timer(s) (e.g., drx-InactivityTimer), e.g., associated with the DRX configuration(s), in response to receiving/applying the indication (e.g., first indication, second indication, third indication).

For example, the UE may determine, consider and/or evaluate the symbol n is in DRX Active Time and/or on duration time if the indication (e.g., first indication, second indication, third indication) is received and/or applied (e.g., for the serving cell) before the specific timing. The UE may transmit SRS and/or CSI report in the symbol n. Alternately, the UE may determine, consider and/or evaluate the symbol n is not in DRX Active Time and/or on duration time if the indication (e.g., first indication, second indication, third indication) is received and/or applied (e.g., for the serving cell) after the specific timing. The UE may not transmit SRS and/or CSI report in the symbol n. The UE may restart an on duration timer (e.g., drx-onDurationTimer) and/or inactivity timer(s) (e.g., drx-InactivityTimer), e.g., associated with the DRX configuration(s), in response to receiving/applying the indication (e.g., first indication, second indication, third indication). The UE may start an inactivity timer(s) (e.g., drx-InactivityTimer), e.g., associated with the DRX configuration(s), in response to receiving/applying the indication (e.g., first indication, second indication, third indication).

For example, the UE may determine, consider and/or evaluate the symbol n is in DRX Active Time and/or on duration time if receiving the second indication indicating the UE to activate and/or resume an on duration timer (e.g., drx-onDurationTimer), e.g., associated with the DRX configuration(s). The UE may start the on duration timer (e.g., drx-onDurationTimer) in response to receiving the second indication. The UE may transmit SRS and/or CSI report in the symbol n.

For example, the UE may determine, consider and/or evaluate the symbol n is not in DRX Active Time and/or on duration time if receiving the second indication indicating the UE to deactivate and/or suspend the on duration timer (e.g., drx-onDurationTimer). The UE may stop the on duration timer (e.g., drx-onDurationTimer) in response to receiving the second indication. The UE may transmit SRS and/or CSI report in the symbol n.

For example, the UE could be configured to transmit, in a serving cell, (periodic and/or semi-persistent) SRS in a symbol n. The UE may not transmit, in the serving cell, the SRS in the symbol n if the MAC entity associated with the serving cell would not be in Active Time in response to the indication received until the time duration prior to the symbol n. The UE could transmit, in the serving cell, the SRS in the symbol n if the indication associated with the serving cell is not received until the time duration prior to the symbol n but is received within the time duration prior to the symbol n.

For example, the UE could be configured to report, in a serving cell, (periodic and/or semi-persistent) CSI in a symbol n. The UE may not transmit, in the serving cell, the CSI in the symbol n if the MAC entity associated with the serving cell would not be in Active Time in response to the indication received until the time duration prior to the symbol n. The UE could transmit, in the serving cell, the CSI in the symbol n if the indication associated with the serving cell is not received until the time duration prior to the symbol n but is received within the time duration prior to the symbol n.

For the MAC entity, one, or multiple, or all of the following conditions could be satisfied:
DCP monitoring could be configured for the active DL BWP;
The symbol n could occur within drx-onDurationTimer duration (e.g., when drx-onDurationTimer is running);
drx-onDurationTimer associated with the current DRX cycle may not be started;
ps-TransmitPeriodicL1-RSRP may not be configured with value true; and/or
ps-TransmitOtherPeriodicCSI may not be configured with value true.

For example, the UE could be configured to transmit, in a serving cell, (periodic and/or semi-persistent) SRS in a symbol n. The UE may not transmit, in the serving cell, the SRS in the symbol n if the DRX group associated with the serving cell would not be in Active Time in response to the indication received until the time duration prior to the symbol n. The UE could transmit, in the serving cell, the SRS in the symbol n if the indication associated with the serving cell is not received until the time duration prior to the symbol n but is received within the time duration prior to the symbol n.

For example, the UE could be configured to report, in a serving cell, (periodic and/or semi-persistent) CSI in a symbol n. The UE may not transmit, in the serving cell, the CSI in the symbol n if the DRX group associated with the serving cell would not be in Active Time in response to the indication received until the time duration prior to the symbol n. The UE could transmit, in the serving cell, the CSI in the symbol n if the indication associated with the serving cell is not received until the time duration prior to the symbol n but is received within the time duration prior to the symbol n.

For example, the UE could be configured to report, in a serving cell, (periodic and/or semi-persistent) CSI in a symbol n. The UE may not transmit, in the serving cell, the CSI in the symbol n if drx-onDurationTimer of the DRX group associated with the serving cell would not be running in response to the indication received until the time duration prior to the symbol n. The UE could transmit, in the serving cell, the CSI in the symbol n if the indication associated with the serving cell is not received until the time duration prior to the symbol n but is received within the time duration prior to the symbol n.

For the DRX group, one, or multiple, or all of the following conditions may not be satisfied:
DCP monitoring could be configured for the active DL BWP;
The symbol n could occur within drx-onDurationTimer duration (e.g., when drx-onDurationTimer is running); and/or
drx-onDurationTimer associated with the current DRX cycle may not be started.

For the DRX group, one, or multiple, or all of the following conditions could be satisfied:
CSI masking (csi-Mask) could be setup;
allowCSI-SRS-Tx-MulticastDRX-Active may not be configured; and/or
All multicast DRX may not be in Active Time in the symbol n.

The UE may determine, consider and/or evaluate whether the symbol n is in DRX Active Time and/or on duration time based on the information of the indication (e.g., first indication, second indication, third indication).

The UE may apply the information of the indication (e.g., first indication, second indication, third indication), and determine/consider/evaluate whether the symbol n is in DRX Active Time and/or on duration time based on at least below:
an indicated value(s) of one or more (set of) DRX configurations in the first/second indication;
the value of one or more (set of) DRX configurations plus an offset in the first/second indication;
the value of one or more (set of) DRX configurations multiplied by a scale in the first/second indication;
the (set(s) of) DRX configuration(s) indicated/activated/deactivated by the third indication; and/or
the applicable time of the second indication and/or third indication.

For example, the UE may determine, consider and/or evaluate whether the symbol n is in DRX Active Time and/or on duration time based on the modified/reconfigured/indicated (set of) DRX configuration. The UE may modify/reconfigure/switch (set of) DRX configuration based on the information of the indication (e.g., first indication, second indication, third indication).

In response to receiving the first indication, the UE may use/apply the new configuration and/or adjust/reconfigure a DRX configuration upon or after a first timing. In response to receiving the second indication, the UE may (start to (temporarily)) apply the information of the second indication and/or shift/adjust a DRX configuration upon or after a first timing. In response to receiving the third indication, the UE may use and/or activate/deactivate the indicated/corresponding (set of) DRX configuration upon or after (at least one of) a first timing. The first timing may be (at least one of) below:
(a first symbol after) reception of the (first/second/third) indication;
(a first symbol after) transmission of the confirmation;
a specific PDCCH occasion (e.g., indicated in the (first/second/third) indication, pre-defined in standard);
(after) a time delay (e.g., indicated in the (first/second/third) indication, pre-defined in standard); and/or
when a timer associated with the DRX configuration is (re)started.

The UE may use the received/indicated value in the first indication as (the value of) a DRX configuration upon receiving the first indication, upon transmitting the confirmation for the first indication and/or from/after a specific PDCCH occasion. The UE may use the received/indicated value in the first indication as (the value of) a DRX configuration after a time delay from reception of the first indication and/or transmission of the confirmation.

The UE may apply the offset and/or scale to (the value of) a DRX configuration upon receiving the first indication, upon transmitting the confirmation for the first indication and/or from a specific PDCCH occasion. The UE may apply the offset and/or scale to (the value of) a DRX configuration after a time delay from reception of the first indication and/or transmission of the confirmation.

The UE may apply the information indicated/comprised by the second indication to a DRX configuration (e.g., shift/adjust on duration and/or DRX cycle) upon receiving the second indication, upon transmitting the confirmation for the second indication and/or from a specific timing.

In response to receiving the second indication and/or third indication, the UE may stop applying the information of the second indication and/or third indication upon or after (at least one of) the below second timing:
a specific PDCCH occasion (e.g., indicated in the indication, pre-defined in standard);
a time delay (e.g., indicated in the indication, pre-defined in standard);
a timer expiry;
a number of DL receptions; and/or
a number of DRX cycles or on duration times.

The applicable time of the second indication and/or third indication may be the time duration between the first timing and the second timing.

The UE may determine, consider and/or evaluate whether the symbol n is in DRX Active Time and/or on duration time not considering the information of the indication (e.g., first indication, second indication, third indication).

For example, the UE may determine, consider and/or evaluate whether the symbol n is in DRX Active Time and/or on duration time based on the (set of) DRX configuration before receiving the indication (e.g., first indication, second indication, third indication). The UE may determine, consider and/or evaluate whether the symbol n is in DRX Active Time and/or on duration time based on the value of the (set of) DRX configuration different from the value of the (set of) DRX configuration used in the symbol n.

For example, the UE may determine, consider and/or evaluate whether the symbol n is in DRX Active Time and/or on duration time based on the default (set of) DRX configuration. The UE may determine, consider and/or evaluate whether the symbol n is in DRX Active Time and/or on duration time based on the value of the default (set of) DRX configuration.

The UE may transmit SRS and/or CSI report for one or more (set of) DRX configurations in a DRX group, e.g., for a serving cell. The UE may transmit SRS and/or CSI report for multiple (sets of) DRX configurations in a DRX group, e.g., for a serving cell. The UE may transmit SRS and/or CSI report for the default (set of) DRX configuration in a DRX group, e.g., for a serving cell. The UE may transmit SRS and/or CSI report for (all) the activated (set of) DRX configuration in a DRX group, e.g., for a serving cell. The UE may transmit SRS and/or CSI report for the specific (set of) DRX configuration (e.g., indicated by the indication), e.g., for a serving cell.

The multiple (sets of) DRX parameter(s)/configuration(s) may be used for unicast. The multiple (sets of) DRX parameter(s)/configuration(s) may not be used by multicast. The multiple (sets of) DRX parameter(s)/configuration(s) may be used for downlink. The multiple (sets of) DRX parameter(s)/configuration(s) may not be related to sidelink. The UE may receive parameters and/or configurations related to SRS (e.g., SRS-Config) and/or CSI report (e.g., CSI-ReportConfig, csi-Mask).

Throughout the disclosure, the SRS may comprise and/or referred to periodic SRS and/or semi-persistent SRS. The periodic SRS and/or semi-persistent SRS may be configured by RRC message. The semi-persistent SRS may be activated and/or deactivated by MAC CE (e.g., SP SRS Activation/Deactivation MAC CE).

Throughout the disclosure, the “CSI report” may be, may refer to and/or may be replaced by the “CSI”. The CSI (report) may comprise the CSI (report) on PUCCH and/or the (semi-persistent) CSI (report) configured on PUSCH. the CSI (report) on PUCCH may comprise and/or referred to periodic CSI (report) on PUCCH and/or semi-persistent CSI (report) on PUCCH. The periodic CSI (report) on PUCCH and/or semi-persistent CSI (report) on PUCCH may be configured by RRC message. The semi-persistent CSI (report) on PUCCH may be activated and/or deactivated by MAC CE (e.g., SP CSI reporting on PUCCH Activation/Deactivation MAC CE). The semi-persistent CSI (report) configured on PUSCH may be indicated by DCI.

An example of the invention based on [3] 3GPP TS 38.321 V17.0.0 is described below:
1> if DCP monitoring is configured for the active DL BWP as specified in TS 38.213, clause 10.3; and
1> if the current symbol n occurs within drx-onDurationTimer duration; and
1> if drx-onDurationTimer associated with the current DRX cycle is not started as specified in this clause:
   2> if the MAC entity would not be in Active Time considering grants/assignments/DRX Command MAC CE/Long DRX Command MAC CE/indication (mentioned in above) received and Scheduling Request sent until 4 ms prior to symbol n when evaluating all DRX Active Time conditions as specified in this clause:
      3> not transmit periodic SRS and semi-persistent SRS defined in TS 38.214;
      3> not report semi-persistent CSI configured on PUSCH;
         [ . . . ]
1> else:
   2> in current symbol n, if a DRX group would not be in Active Time considering grants/assignments scheduled on Serving Cell(s) in this DRX group and DRX Command MAC CE/Long DRX Command MAC CE/indication (mentioned in above) received and Scheduling Request sent until 4 ms prior to symbol n when evaluating all DRX Active Time conditions as specified in this clause; and
   2> if allowCSI-SRS-Tx-MulticastDRX-Active is not configured or, in current symbol n, if all multicast DRX would not be in Active Time considering multicast assignments and DRX Command MAC CE for MBS multicast received until 4 ms prior to symbol n when evaluating all DRX Active Time conditions as specified in Clause 5.7b:
      3> not transmit periodic SRS and semi-persistent SRS defined in TS 38.214 in this DRX group;
      3> not report CSI on PUCCH and semi-persistent CSI configured on PUSCH in this DRX group.
   2> if CSI masking (csi-Mask) is setup by upper layers:
      3> in current symbol n, if drx-onDurationTimer of a DRX group would not be running considering grants/assignments scheduled on Serving Cell(s) in this DRX group and DRX Command MAC CE/Long DRX Command MAC CE/indication (mentioned in above) received until 4 ms prior to symbol n when evaluating all DRX Active Time conditions as specified in this clause; and
         4> not report CSI on PUCCH in this DRX group.
      Another example of the invention based on [3] 3GPP TS 38.321 V17.0.0 is described below:
1> if the Short DRX cycle is used for a DRX group, and [(SFN×10)+subframe number] modulo (drx-ShortCycle)=(drx-StartOffset) modulo (drx-ShortCycle):
   2> start or restart drx-onDurationTimer for this DRX group after drx-SlotOffset from the beginning of the subframe.
1> if the Long DRX cycle is used for a DRX group, and [(SFN×10)+subframe number] modulo (drx-LongCycle)=drx-StartOffset:
   2> if DCP monitoring is configured for the active DL BWP as specified in TS 38.213, clause 10.3:
      3> if DCP indication associated with the current DRX cycle received from lower layer indicated to start drx-onDurationTimer, as specified in TS 38.213; or
      3> if all DCP occasion(s) in time domain, as specified in TS 38.213, associated with the current DRX cycle occurred in Active Time considering grants/assignments/DRX Command MAC CE/Long DRX Command MAC CE received and Scheduling Request sent until 4 ms prior to start of the last DCP occasion, or during a measurement gap, or when the MAC entity monitors for a PDCCH transmission on the search space indicated by recoverySearchSpaceId of the SpCell identified by the C-RNTI while the ra-Response Window is running (as specified in clause 5.1.4); or
      3> if ps-Wakeup is configured with value true and DCP indication associated with the current DRX cycle has not been received from lower layers:
         4> start drx-onDurationTimer after drx-SlotOffset from the beginning of the subframe.
   2> else:
      3> start or restart drx-onDurationTimer for this DRX group after drx-SlotOffset from the beginning of the subframe.

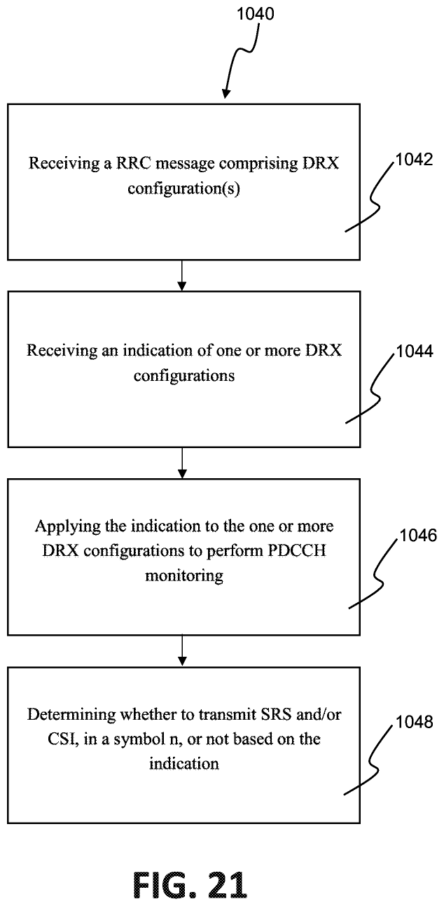

Referring to FIG. 21, with this and other concepts, systems, and methods of the present invention, a method 1040 for a UE in a wireless communication system comprises receiving a RRC message comprising DRX configuration(s) (step 1042), receiving an indication of one or more DRX configurations (step 1044), applying the indication to the one or more DRX configurations to perform PDCCH monitoring (step 1046), and determining whether to transmit SRS and/or CSI, in a symbol n, or not based on the indication (step 1048).

In various embodiments, the UE determines whether to transmit SRS and/or CSI or not based on the timing when the indication is received and/or applied.

In various embodiments, the UE does not transmit SRS and/or CSI if the indication is received and/or applied before a time duration prior to the symbol n.

In various embodiments, the UE transmits SRS and/or CSI if the indication is received and/or applied after a time duration prior to the symbol n.

In various embodiments, the time duration is 4 ms.

Referring back to FIGS. 3 and 4, in one or more embodiments from the perspective of a UE, the device 300 includes a program code 312 stored in memory 310 of the transmitter. The CPU 308 could execute program code 312 to: (i) receive a RRC message comprising DRX configuration(s); (ii) receive an indication of one or more DRX configurations; (iii) apply the indication to the one or more DRX configurations to perform PDCCH monitoring; and (iv) determine whether to transmit SRS and/or CSI, in a symbol n, or not based on the indication. Moreover, the CPU 308 can execute the program code 312 to perform all of the described actions, steps, and methods described above, below, or otherwise herein.

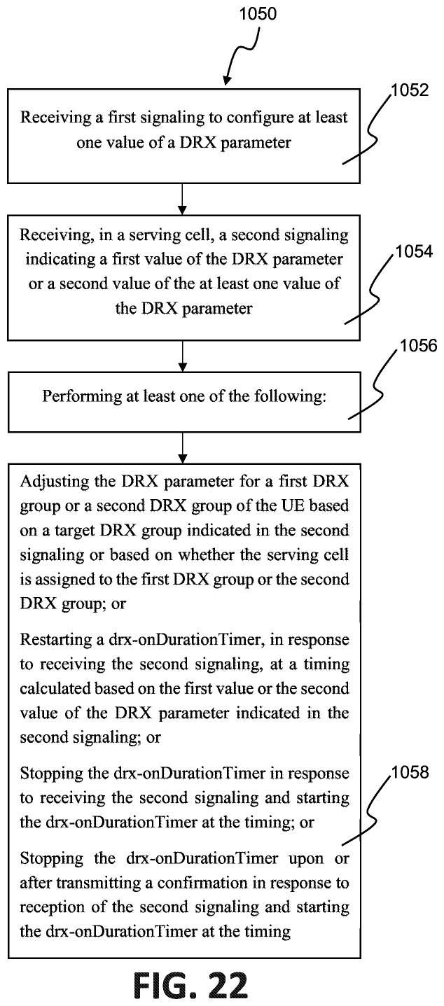

Referring to FIG. 22, with this and other concepts, systems, and methods of the present invention, a method 1050 for a UE in a wireless communication system comprises receiving a first signaling to configure at least one value of a DRX parameter (step 1052), receiving, in a serving cell, a second signaling indicating a first value of the DRX parameter or a second value of the at least one value of the DRX parameter (step 1054), and performing at least one of the following (step 1056): adjusting the DRX parameter for a first DRX group or a second DRX group of the UE based on a target DRX group indicated in the second signaling or based on whether the serving cell is assigned to the first DRX group or the second DRX group, restarting a drx-onDurationTimer, in response to receiving the second signaling, at a timing calculated based on the first value or the second value of the DRX parameter indicated in the second signaling, stopping the drx-onDurationTimer in response to receiving the second signaling and starting the drx-onDurationTimer at the timing, or stopping the drx-onDurationTimer upon or after transmitting a confirmation in response to reception of the second signaling and starting the drx-onDurationTimer at the timing (step 1058).

In various embodiments, the first signaling is a Radio Resource Control RRC message and/or the second signaling is a DCI or a MAC CE.

In various embodiments, the DRX parameter is drx-StartOffset or drx-SlotOffset.

In various embodiments, restarting the drx-onDurationTimer is performed after transmitting the confirmation.

In various embodiments, the method further comprises stopping a drx-InactivityTimer upon or after receiving the second signaling, or upon or after transmitting the confirmation.

In various embodiments, the method further comprises adjusting the DRX parameter by applying the first value or the second value to the DRX parameter and/or activating or deactivating the DRX parameter with the first value or the second value.

In various embodiments, adjusting the DRX parameter is performed upon or after at least one of the following: reception of the second signaling, transmission of the confirmation, a PDCCH occasion indicated in the second signaling, or a time delay indicated in the second signaling.

In various embodiments, the method further comprises adjusting the DRX parameter for the first DRX group if the target DRX group is the first DRX group, and/or adjusting the DRX parameter for the second DRX group if the target DRX group is the second DRX group.

In various embodiments, the method further comprises adjusting the DRX parameter for the first DRX group if the serving cell is assigned to the first DRX group, and/or adjusting the DRX parameter for the second DRX group if the serving cell is assigned to the second DRX group.

In various embodiments, whether the serving cell is assigned to the first DRX group or the second DRX group is indicated in the first signaling.

In various embodiments, the first DRX group and the second DRX group are associated with a same MAC entity.

Referring back to FIGS. 3 and 4, in one or more embodiments from the perspective of a UE, the device 300 includes a program code 312 stored in memory 310 of the transmitter. The CPU 308 could execute program code 312 to: (i) receive a first signaling to configure at least one value of a DRX parameter; (ii) receive, in a serving cell, a second signaling indicating a first value of the DRX parameter or a second value of the at least one value of the DRX parameter; and (iii) perform at least one of the following: (iv) adjusting the DRX parameter for a first DRX group or a second DRX group of the UE based on a target DRX group indicated in the second signaling or based on whether the serving cell is assigned to the first DRX group or the second DRX group; restarting a drx-onDurationTimer, in response to receiving the second signaling, at a timing calculated based on the first value or the second value of the DRX parameter indicated in the second signaling; stopping the drx-onDurationTimer in response to receiving the second signaling and starting the drx-onDurationTimer at the timing; or stopping the drx-onDurationTimer upon or after transmitting a confirmation in response to reception of the second signaling and starting the drx-onDurationTimer at the timing. Moreover, the CPU 308 can execute the program code 312 to perform all of the described actions, steps, and methods described above, below, or otherwise herein.

Any combination of the above concepts or teachings can be jointly combined or formed to a new embodiment. The disclosed details and embodiments can be used to solve at least (but not limited to) the issues mentioned above and herein.

It is noted that any of the methods, alternatives, steps, examples, and embodiments proposed herein may be applied independently, individually, and/or with multiple methods, alternatives, steps, examples, and embodiments combined together.

Various aspects of the disclosure have been described above. It should be apparent that the teachings herein may be embodied in a wide variety of forms and that any specific structure, function, or both being disclosed herein is merely representative. Based on the teachings herein one skilled in the art should appreciate that an aspect disclosed herein may be implemented independently of any other aspects and that two or more of these aspects may be combined in various ways. For example, an apparatus may be implemented or a method may be practiced using any number of the aspects set forth herein. In addition, such an apparatus may be implemented or such a method may be practiced using other structure, functionality, or structure and functionality in addition to or other than one or more of the aspects set forth herein. As an example of some of the above concepts, in some aspects, concurrent channels may be established based on pulse repetition frequencies. In some aspects, concurrent channels may be established based on pulse position or offsets. In some aspects, concurrent channels may be established based on time hopping sequences. In some aspects, concurrent channels may be established based on pulse repetition frequencies, pulse positions or offsets, and time hopping sequences.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill in the art would further appreciate that the various illustrative logical blocks, modules, processors, means, circuits, and algorithm steps described in connection with the aspects disclosed herein may be implemented as electronic hardware (e.g., a digital implementation, an analog implementation, or a combination of the two, which may be designed using source coding or some other technique), various forms of program or design code incorporating instructions (which may be referred to herein, for convenience, as “software” or a “software module”), or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

In addition, the various illustrative logical blocks, modules, and circuits described in connection with the aspects disclosed herein may be implemented within or performed by an integrated circuit (“IC”), an access terminal, or an access point. The IC may comprise a general purpose processor, a digital signal processor (DSP), an application specific integrated circuit (ASIC), a field programmable gate array (FPGA) or other programmable logic device, discrete gate or transistor logic, discrete hardware components, electrical components, optical components, mechanical components, or any combination thereof designed to perform the functions described herein, and may execute codes or instructions that reside within the IC, outside of the IC, or both. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

It is understood that any specific order or hierarchy of steps in any disclosed process is an example of a sample approach. Based upon design preferences, it is understood that the specific order or hierarchy of steps in the processes may be rearranged while remaining within the scope of the present disclosure. The accompanying method claims present elements of the various steps in a sample order, and are not meant to be limited to the specific order or hierarchy presented.

The steps of a method or algorithm described in connection with the aspects disclosed herein may be embodied directly in hardware, in a software module executed by a processor, or in a combination of the two. A software module (e.g., including executable instructions and related data) and other data may reside in a data memory such as RAM memory, flash memory, ROM memory, EPROM memory, EEPROM memory, registers, a hard disk, a removable disk, a CD-ROM, or any other form of computer-readable storage medium known in the art. A sample storage medium may be coupled to a machine such as, for example, a computer/processor (which may be referred to herein, for convenience, as a “processor”) such the processor can read information (e.g., code) from and write information to the storage medium. A sample storage medium may be integral to the processor. The processor and the storage medium may reside in an ASIC. The ASIC may reside in user equipment. In the alternative, the processor and the storage medium may reside as discrete components in user equipment. Moreover, in some aspects, any suitable computer-program product may comprise a computer-readable medium comprising codes relating to one or more of the aspects of the disclosure. In some aspects, a computer program product may comprise packaging materials.

While the invention has been described in connection with various aspects and examples, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

What is claimed is:

1. A method for a User Equipment (UE), comprising:
receiving a first signaling to configure at least one value of a Discontinuous Reception (DRX) parameter;
receiving, in a serving cell, a second signaling indicating a first value of the DRX parameter or a second value of the at least one value of the DRX parameter; and
performing at least one of:
adjusting the DRX parameter for a first DRX group or a second DRX group of the UE based on a target DRX group indicated in the second signaling or based on whether the serving cell is assigned to the first DRX group or the second DRX group;
restarting a drx-onDurationTimer, in response to receiving the second signaling, at a timing calculated based on the first value or the second value of the DRX parameter indicated in the second signaling;
stopping the drx-onDurationTimer in response to receiving the second signaling and starting the drx-onDurationTimer at the timing; or
stopping the drx-onDurationTimer upon or after transmitting a confirmation in response to reception of the second signaling and starting the drx-onDurationTimer at the timing.

2. The method of claim 1, wherein the first signaling is a Radio Resource Control (RRC) message and/or the second signaling is a Downlink Control Information (DCI) or a Medium Access Control (MAC) Control Element (CE).

3. The method of claim 1, wherein the DRX parameter is drx-Start Offset or drx-SlotOffset.

4. The method of claim 1, wherein restarting the drx-onDurationTimer is performed after transmitting the confirmation.

5. The method of claim 1, further comprising stopping a drx-InactivityTimer upon or after receiving the second signaling, or upon or after transmitting the confirmation.

6. The method of claim 1, further comprising adjusting the DRX parameter by applying the first value or the second value to the DRX parameter and/or activating or deactivating the DRX parameter with the first value or the second value.

7. The method of claim 1, wherein adjusting the DRX parameter is performed upon or after at least one of:
reception of the second signaling;
transmission of the confirmation;
a Physical Downlink Control Channel (PDCCH) occasion indicated in the second signaling; or
a time delay indicated in the second signaling.

8. The method of claim 1, further comprising adjusting the DRX parameter for the first DRX group if the target DRX group is the first DRX group, and/or adjusting the DRX parameter for the second DRX group if the target DRX group is the second DRX group.

9. The method of claim 1, further comprising adjusting the DRX parameter for the first DRX group if the serving cell is assigned to the first DRX group, and/or adjusting the DRX parameter for the second DRX group if the serving cell is assigned to the second DRX group.

10. The method of claim 1, wherein whether the serving cell is assigned to the first DRX group or the second DRX group is indicated in the first signaling.

11. The method of claim 1, wherein the first DRX group and the second DRX group are associated with a same MAC entity.

12. A User Equipment (UE), comprising:
a memory; and
a processor operatively coupled to the memory, wherein the processor is configured to execute program code to:
receive a first signaling to configure at least one value of a Discontinuous Reception (DRX) parameter;
receive, in a serving cell, a second signaling indicating a first value of the DRX parameter or a second value of the at least one value of the DRX parameter; and
perform at least one of:
adjusting the DRX parameter for a first DRX group or a second DRX group of the UE based on a target DRX group indicated in the second signaling or based on whether the serving cell is assigned to the first DRX group or the second DRX group;
restarting a drx-onDurationTimer, in response to receiving the second signaling, at a timing calculated based on the first value or the second value of the DRX parameter indicated in the second signaling;
stopping the drx-onDurationTimer in response to receiving the second signaling and starting the drx-onDurationTimer at the timing; or
stopping the drx-onDurationTimer upon or after transmitting a confirmation in response to reception of the second signaling and starting the drx-onDurationTimer at the timing.

13. The UE of claim 12, wherein the first signaling is a Radio Resource Control (RRC) message and/or the second signaling is a Downlink Control Information (DCI) or a Medium Access Control (MAC) Control Element (CE).

14. The UE of claim 12, wherein the DRX parameter is drx-Start Offset or drx-Slot Offset.

15. The UE of claim 12, wherein restarting the drx-onDurationTimer is performed after transmitting the confirmation.

16. The UE of claim 12, wherein the processor is further configured to execute program code to stop a drx-InactivityTimer upon or after receiving the second signaling, or upon or after transmitting the confirmation.

17. The UE of claim 12, wherein the processor is further configured to execute program code to adjust the DRX parameter by applying the first value or the second value to the DRX parameter and/or activating or deactivating the DRX parameter with the first value or the second value.

18. The UE of claim 12, wherein adjusting the DRX parameter is performed upon or after at least one of:
reception of the second signaling;
transmission of the confirmation;
a Physical Downlink Control Channel (PDCCH) occasion indicated in the second signaling; or
a time delay indicated in the second signaling.

19. The UE of claim 12, wherein the processor is further configured to execute program code to:
adjust the DRX parameter for the first DRX group if the target DRX group is the first DRX group; and/or
adjust the DRX parameter for the second DRX group if the target DRX group is the second DRX group; and/or
adjust the DRX parameter for the first DRX group if the serving cell is assigned to the first DRX group; and/or
adjust the DRX parameter for the second DRX group if the serving cell is assigned to the second DRX group.

20. The UE of claim 12, wherein whether the serving cell is assigned to the first DRX group or the second DRX group is indicated in the first signaling, and/or the first DRX group and the second DRX group are associated with a same MAC entity.
